(19) United States
(12) Patent Application Publication
(10) Pub. No.: US 2015/0232319 A1
(43) Pub. Date: Aug. 20, 2015

(54) SYSTEM AND APPARATUS FOR DISTRIBUTING FUEL, AND METHOD THEREFOR

(71) Applicant: FUEL TRANSFER TECHNOLOGIES INC., Moncton (CA)

(72) Inventors: James Wedderburn, Moncton (CA); Mark Bonner, Frenchtown, NJ (US)

(21) Appl. No.: 14/426,148

(22) PCT Filed: Sep. 4, 2013
(86) PCT No.: PCT/CA2013/050676

§ 371 Date: Mar. 4, 2015

Related U.S. Application Data
(60) Provisional application No. 61/696,463, filed on Sep. 4, 2012.
(60) Provisional application No. 61/822,790, filed on May 13, 2013.

(51) Int. Cl. B67D 7/04; F16L 9/19; B67D 7/36; B65D 61/00; B65D 85/84

(52) U.S. Cl. CPC B67D 7/04; B65D 61/00; B65D 85/84; B67D 7/36; F16L 9/19

(57) ABSTRACT

Apparatuses, systems and methods for providing a fluid in a container, and for distribution of the fluid.

### CROSS-REFERENCE TO RELATED APPLICATIONS

The present disclosure claims priority from U.S. provisional application No. 61/696,463, filed Sep. 4, 2012, and from U.S. provisional application No. 61/822,790, filed May 14, 2013 the entireties of which are hereby incorporated by reference.

### TECHNICAL FIELD

The present disclosure relates generally to systems, apparatuses and methods for distributing fuel (e.g., petroleum-based fuels) and other liquids. The present disclosure may be applicable to the supply, distribution, sale and/or purchase of petroleum-based fuels in portable containers to distributors, retailers and end users, and the infrastructure to do so.

### BACKGROUND

Currently, fuel (e.g., petroleum-based liquid fuel) is sold to the general public and small businesses at commercial gas stations. Typically, and almost exclusively, fuel is purchased by consumers at service stations wherein the fuel is pumped into either vehicles or government-approved portable containers. It is well known that a significant amount of pollution is caused when refueling portable fuel containers at these facilities. This may be because the refueling nozzle and the receiving container form an open system resulting in vapor loss, as well the act of filling a portable container may be subject to human error, such as dripping and spilling fuel, overflowing the container, knocking over the container, and so on. The total amount of pollution caused by the hundreds of millions of people engaging in this practice may be significant.

The use of conventional portable containers may also be a source of pollution, typically stemming from permeation, vapor loss and/or spillage which may occur while refueling these containers and also when dispensing fuel from such containers.

### SUMMARY

In some aspects, there is provided an assembly for dispensing a fluid, the assembly comprising: a fluid container comprising: an opening; and an openable cover over the opening; and an enclosure attachable to the container, the enclosure comprising: a body for at least partially enclosing at least a portion of the container; and a dispenser on the body, the dispenser being configured to cooperate with the cover of the container to open the cover and permit fluid to be dispensed from the container.

In some examples, opening of the cover is enabled only by cooperation with the dispenser.

In some examples, dispensing of fluid from the container is enabled by gravity.

In some examples, the cover comprises at least one valve for permitting or inhibiting delivery of fluid from the container, and the dispenser is configured to cooperate with the cover to open the at least one valve, to permit fluid to be dispensed.

In some examples, the cover comprises a first half of a dry-break connection, and the dispenser comprises a complementary second half of the dry-break connection.

In some aspects, there is provided an enclosure for cooperating with a fluid container for dispensing fluid from the container, the enclosure comprising: a body for at least partially enclosing at least a portion of the container; and a dispenser on the body, the dispenser being configured to cooperate with a cover of the container to open the cover and permit fluid to be dispensed from the container.

In some examples, the dispenser comprises a valve for permitting or inhibiting fluid flow through the dispenser.

In some examples, the enclosure further comprises a trigger provided on the body for controlling the valve.

In some examples, the dispenser comprises a first half of a dry-break connection, the dispenser being configured to cooperate with a second half of the dry-break connection provided by the cover.

In some aspects, there is provided a line of fluid containers to be used with any one of the enclosures described above.

In some aspects, there is provided a method of decreasing environmental impact (such as pollution) of refueling a portable fuel container, the method comprising: obtaining the container to be refilled, the container comprising an opening and an openable cover over the opening; mating the cover with a filling dispenser, the dispenser being configured to cooperate with the cover of the container to open the cover, and permit liquid fuel to be introduced into the container and vapor to be recovered from the container; filling the container with liquid fuel while concurrently recovering vapor from the container.

In some examples, filling the container is carried out only by trained or authorized personnel.

In some examples, the method is carried out only at an authorized location, such as a fuel refilling station.

In some examples, an end consumer is provided with the filled container.

In some examples, the cover of the container comprises at least one valve, and the dispenser is configured to cooperate with the cover of the container to open the valve.

In some examples, the cover comprises a first half of a dry-break connection, and the dispenser comprises a complementary second half of the dry-break connection.

In some examples, there is a plurality of containers to be refilled, and the dispenser is configured to cooperate with a plurality of respective covers of at least a portion of the plurality of containers for simultaneously refilling at least the portion of the plurality of containers.

In some examples, the refilling is automated, such as by suitable refilling machinery.

In some aspects, there is provided a method of distributing fuel to a consumer, the method comprising: filling a container with fuel at an authorized location, such as a filling station, using authorized equipment; and distributing the filled container of fuel to a pickup location for pickup by the consumer; wherein the filled container is refillable only at the authorized location using the authorized equipment.

In some examples, the pickup location is other than a gas station.

In some examples, the pickup location is a retail location, a franchise location, a kiosk or a vending machine.

In some examples, filling the container is carried out by automated authorized equipment at the authorized location.

In some examples, filling the container is carried out by authorized personnel at the authorized location using the authorized equipment.

In some examples, the consumer has made a request for the filled container of fuel to be picked up at the pickup location.

In some examples, the request was made using an online system.

In some examples, the pickup location is further enabled to receive used containers from the consumer.

In some aspects, there is provided a method of refilling a used fuel container, the method comprising: receiving the used container from a consumer at a designated return location; inspecting the used container to determine whether the used container meets one or more predetermined quality standards; cleaning the used container; refilling the used container to provide a filled container of fuel; filling a container with fuel at an authorized location, such as an authorized filling station, using authorized equipment; and providing the filled container of fuel to a pickup location for pickup by the same or different consumer.

In some examples, cleaning the used container comprises introducing an amount of fuel into the used container and rinsing out the used container.

In some examples, the method of further comprises testing the rinsed out amount of fuel for any contaminants.

In some examples, the used container is in an inverted position during cleaning, to enable removal of contents via gravity.

In some examples, the method is carried out at an automated kiosk or automated vending machine.

In some aspects, there is provided a method of providing road tax-exempt fuel to a consumer for off-road use.

In some aspects, there is provided a pouring container (e.g., a container for pouring liquid from which a consumer cannot pour liquid directly) including: at least one valve in the top, which is(are) non-operational (e.g., the structure of this valve may require the container to be inverted when liquid is to be dispensed through it). The structure of this may appear similar to a propane (acetylene) tank (among others). However, a propane tank is for dispensing a vapor and does not need to be inverted to do so and the structure of other such tanks allow for the liquid to be drawn off the top or up off the bottom and does not require the tank to be inverted for liquid to be dispensed.

In some aspects, there is provided a dispenser (e.g., a dispenser which may be added to the top of the pouring container to allow liquid to be dispensed. The container may include handles) configured to mate with and operate the valve(s) on the pouring container.

In some aspects, there is provided an enclosure comprising a dispenser configured to mate with and operate the valve(s) on the pouring container.

In some aspects, there is provided a container and enclosure assembly, the enclosure comprising a dispenser configured to mate with a cap on the container, wherein opening of the cap is enabled by cooperation with the dispenser.

In some aspects, there is provided a line of different containers to be used with the same enclosure.

In some aspects, there is provided a method of reducing pollution or a method of decreasing environmental impact of refueling portable containers.

In some examples, the method may be for controlling the filling process on portable containers. The method may provide an environmentally friendly interface and filling process between a filling station and a portable container. The method may reduce the number of consumers filling their own portable containers. The method may prevent consumers from filling their own portable containers. The method may provide consumers with portable containers which are full of gasoline or diesel.

In some examples, the method may include obtaining an empty fuel container with a valved opening; mating the container cap with a refueling dispenser to open the valved opening; and filling the container with fuel.

In some aspects, there is provided a method of refilling a plurality of fuel containers at a refilling station, including obtaining a plurality of empty fuel containers at the refilling station; the refilling station having equipment for automated filling of a large number of containers; and filling the containers.

In some aspects, there is provided a method of selling fuel at a retail or franchise location other than a gas station.

In some aspects, there is provided a method of supplying, selling and/or retailing tax-exempt fuel to the general public for off-road use.

In some aspects, there is provided a method of refilling and dispensing full fuel containers at a kiosk location, including depositing an empty or used container at a kiosk location; and purchasing a full container at the kiosk location.

In some examples, a container dispenser may be either stocked with full containers from an outside source. In some examples, an automated process at the kiosk may validate the integrity of the container, empty the container, clean the container, and test the rinse fuel for contaminants before filling containers from a reservoir of fuel on location. The container may be emptied and cleaned upside down and may be filled upside down or right side up.

In some aspects, there is provided an assembly for dispensing a fluid, where the assembly may include: a fluid container comprising: at least one opening; and where in the at least one opening is closed by an openable cover; and an enclosure attachable to the container, the enclosure comprising: a body for at least partially enclosing at least a portion of the container; and a dispenser on the body, the dispenser being configured to cooperate with the cover of the container to open the cover and permit fluid to be dispensed from the container.

In some examples, opening of the cover to dispense fluid is enabled only by cooperation with the dispenser.

In some examples, dispensing of fluid from the container may be enabled by gravity.

In some examples, the cover may include at least one valve for permitting or inhibiting delivery of fluid from the container, and the dispenser is configured to cooperate with the cover to open the at least one valve, to permit fluid to be dispensed.

In some examples, the cover may include a first half of a dry-break connection.

In some examples, the dispenser may include a complementary second half of the dry-break connection.

In some examples, the container may include a first set of at least two fluid conduits and the enclosure may include a second set of at least two fluid conduits, and wherein, when the enclosure is attached to the container, the first and the second sets of fluid conduits align with each other to enable vapor recovery when fluid is dispensed from the container.

In some examples, the assembly may be configured to dispense a fuel.

In some examples, the fuel may have a boiling point greater than 20° C.

In some examples, the fuel being dispensed may be a liquid.

In some examples, the container may include the cover.

In some examples, the container may be a manually portable container.

In some examples, the container may have a capacity in the range of 1 to 5 gallons.

In some aspects, there is provided an enclosure for cooperating with a fluid container for dispensing fluid from the container, where the enclosure may include: a body for at least partially enclosing at least a portion of the container; and a dispenser on the body, the dispenser being configured to cooperate with a cover of the container to open the cover and permit fluid to be dispensed from the container.

In some examples, the dispenser may include a cover-engaging feature for opening the cover to permit or inhibit fluid flow through the dispenser.

In some examples, a trigger may be provided on the body for controlling the cover-engaging feature of the dispenser.

In some examples, the cover-engaging feature may be configured to cooperate with a valve provided in the cover, wherein opening the cover comprises opening the valve, to permit fluid to be dispensed.

In some examples, the dispenser may include at least one valve to permit or inhibit fluid flow through the dispenser.

In some examples, there may be at least two fluid conduits, wherein at least one fluid conduit enables vapor recovery when fluid is dispensed from the container via at least one other fluid conduit.

In some examples, the enclosure may be configured to permit fuel to be dispensed from the container.

In some examples, the fuel may have a boiling point greater than 20° C.

In some examples, the fuel being dispensed may be a liquid.

In some examples, the enclosure may be configured for use with a manually portable container.

In some examples, the enclosure may be configured for use with the container having a capacity in the range of 1 to 5 gallons.

In some aspects, there is provided a fluid flow control mechanism for controlling the flow of fluid through an opening, where the fluid flow control mechanism may include: at least a first valve comprising a closed configuration for inhibiting the flow of fluid through the opening and an open configuration for permitting the flow of fluid through the opening, the first valve being biased to the closed configuration; and a locking mechanism with an engaged configuration wherein the valve is disabled from being moved to the open configuration and a disengaged configuration wherein the valve is enabled to be moved to the open configuration; wherein the locking mechanism is biased to the engaged configuration.

In some examples, the locking mechanism may be enabled to move to the disengaged configuration only by a fluid conveying attachment configured to cooperate with the fluid flow control mechanism.

In some examples, wherein cooperation of the fluid conveying attachment with the fluid flow control mechanism may enable movement of the valve to the open configuration.

In some examples, the opening may be defined in a fluid container.

In some examples, the opening may be defined in a hose.

In some examples, there may be a second valve comprising a closed configuration for inhibiting the flow of fluid through the opening and an open configuration for permitting the flow of fluid through the opening, the second valve being biased to the closed configuration.

In some examples, the second valve may be moved to the open configuration only upon movement of the first valve towards the open configuration.

In some examples, the first valve may control flow of liquid and the second valve controls flow of vapor.

In some examples, the locking mechanism may be manually moveable to the disengaged configuration.

In some aspects, there is provided a container that may include: at least one opening defined in a body of the container; and any one of the fluid flow control mechanisms described above.

In some examples, the container may be manually portable.

In some examples, the container may have a capacity in the range of 1 to 5 gallons.

In some aspects, there is provided a fluid conveying attachment connectible to a container having an opening closed by an openable seal, the conveying attachment enabling communication of fluid through the opening, where the conveying attachment may include: a connection end connectible to the container and a conveying end; a liquid conduit providing fluid communication between the connection end and the conveying end; a vapor conduit providing fluid communication between the connection end and the conveying end; at least one seal engaging member for opening the seal, the seal engaging member being provided by at least one of the liquid conduit and the vapor conduit, the seal engaging member being movable between a disengaged configuration wherein the seal is not opened and an engaged configuration wherein the seal is opened; wherein when the conveying attachment is connected to the container and the seal engaging member is in the disengaged configuration, the seal remains closed such that communication of fluid through the opening is inhibited; and wherein when the conveying attachment is connected to the container and the seal engaging member is in the engaged configuration, the seal is opened such that communication of fluid through the opening is enabled.

In some examples, when the fluid conveying attachment is connected to the container and the seal is opened, a closed system may be created between the fluid conveying attachment and the interior of the container.

In some examples, there may be an unlocking mechanism configured to disable a locking mechanism of the container, wherein the locking mechanism, when locked, inhibits the seal on the container from being opened, the unlocking mechanism engaging the locking mechanism when the conveying attachment is connected to the container.

In some examples, when the unlocking mechanism engages the locking mechanism, the locking mechanism may be unlocked.

In some examples, the locking mechanism may be unlocked when the conveying attachment is connected to the container and the seal engaging member is in the engaged configuration.

In some examples, the fluid conveying attachment may be configured to dispense fluid from the container.

In some examples, the fluid conveying attachment may be configured as a dispensing spout.

In some examples, the fluid conveying attachment may be configured to deliver fluid to the container.

In some examples, the seal engaging member may be configured to engage a seal formed by a valve.

In some aspects, there is provided a method of restricting filling of a reusable-dispensing container to only filling using authorized equipment, where the method may include: providing the reusable-dispensing container having at least one opening that is closed by an openable cover; providing the authorized equipment including a conveying attachment for delivering fluid into the reusable-dispensing container; wherein the conveying attachment is configured to attach to the container and cooperate with the cover of the container to open the cover and permit fluid to be delivered to the container; wherein delivery of fluid to the container is only enabled by cooperation with the conveying attachment; connecting the conveying attachment in fluid communication with the reusable-dispensing container; transferring fluid between the reusable-dispensing container and the conveying attachment.

In some examples, the authorized equipment may be configured to restrict access to the container during the transfer of fluid.

In some examples, the openable cover may be permanently attached to the container.

In some examples, delivery of fluid to the container may be done through the cover.

In some examples, opening of the cover to transfer fluid between the container and the conveying attachment may be enabled only by cooperation with the conveying attachment.

In some examples, the reusable-dispensing container may be configured to dispense liquids by pouring.

In some examples, transferring fluid may include delivering liquid from the conveying attachment to the container while recovering vapor from the container to the conveying attachment.

In some examples, the conveying attachment may be configured to be connectible to the reusable-dispensing container to create a closed system between the interior of the container and the conveying attachment during delivery of fluid to the container.

In some examples, filling of the container may be part of an automated process.

In some examples, the conveying attachment may be a refilling dispenser.

In some examples, the authorized equipment may be a vending machine.

In some examples, the vending machine may be accessible by an end consumer, and wherein the container is provided by the end consumer.

In some examples, the authorized equipment may be configured to restrict access to the container during the transfer of fluid.

In some examples, the method may include actuating the conveying attachment to open the openable cover.

In some examples, the authorized equipment may be only available at an authorized location.

In some examples, the fluid may be a fuel.

In some examples, the fuel may have a boiling point greater than 20° C.

In some examples, the fuel being dispensed may be a liquid.

In some examples, the fuel may be gasoline or diesel.

In some examples, the gasoline or diesel may be designated for off-road use and the cost or sale of the gasoline or diesel may be exempt from certain sales tax.

In some examples, the gasoline or diesel may be designated for off-road use and the formulation of the gasoline or diesel may be freed from formulation regulations applicable to automotive fuel.

In some examples, the authorized equipment may be available at a retail outlet other than a gas station.

In some examples, the fluid may be a hazardous chemical.

In some examples, the authorized equipment may be operable only by authorized personnel.

In some examples, filled containers may be provided to a retail outlet for sale to an end consumer.

In some examples, the container may be manually portable.

In some examples, the container may have a capacity of 1 to 5 gallons.

In some aspects, there is provided a method of reducing pollution associated with filling a reusable-dispensing container with hazardous fluid, the container having an opening covered by an openable cover, where the method may include: providing a fluid dispenser configured to cooperate with the cover of the reusable-dispensing container to open the cover and enable delivery of liquid to the container concurrent with recovery of vapor from the container; mating the refilling dispenser to the container; and filling the reusable-dispensing container with liquid while concurrently recovering vapor from the reusable-dispensing container.

In some examples, when the refilling dispenser is mated with the reusable-dispensing container and the cover is opened, a closed system may be created between the refilling dispenser and the interior of the reusable-dispensing container.

In some examples, filling the reusable-dispensing containers may be carried out only by authorized personnel.

In some examples, filling the reusable-dispensing containers may be carried out by an automated process.

In some examples, the method may be carried out only at an authorized location.

In some examples, the method may include providing the filled reusable-dispensing container to an end consumer.

In some examples, filling the reusable-dispensing container and recovering vapor may be done through the cover when the cover is in an opened configuration.

In some examples, the container may be manually portable.

In some examples, the container may have a capacity of 1 to 5 gallons.

In some aspects, there is provided a method of providing gasoline or diesel in a reusable-dispensing container to a consumer, where the method may include: providing at least one reusable-dispensing container, the reusable-dispensing container having a safety mechanism to restrict unauthorized filling of the reusable-dispensing container; filling the reusable-dispensing container with gasoline or diesel using authorized filling equipment, the authorized filling equipment being configured to cooperate with the reusable-dispensing container to open the safety mechanism; and providing the filled reusable-dispensing container at a pickup location for pickup by the consumer.

In some examples, operation of the authorized filling equipment may be restricted to authorized personnel.

In some examples, the pickup location may be other than a gas station.

In some examples, the pickup location may be a retail outlet, a franchise location, a kiosk or a vending machine.

In some examples, the authorized filling equipment may include automated equipment at an authorized location.

In some examples, the filled reusable-dispensing containers may be provided to be picked up at the pickup location in response to a request by the consumer.

In some examples, the pickup location may be specified by the consumer.

In some examples, the pickup location may be a customer-defined custom-location.

In some examples, the request may be made by the consumer using an online system.

In some examples, the method may include receiving a used reusable-dispensing container from the consumer at the pickup location.

In some examples, filling the container may include filling the same or different used container.

In some examples, the gasoline or diesel may be designated for off-road use and the sale or cost of the gasoline or diesel may be exempt from certain sales tax.

In some examples, the gasoline or diesel may be designated for off-road use and the formulation of the gasoline or diesel may be freed from formulation regulations applicable to automotive fuel.

In some examples, the method may include inspecting the container prior to filling the container, to determine whether the container meets one or more predetermined quality standards.

In some examples, inspecting the container may include checking for presence of contaminants in the container.

In some examples, inspecting the container may include checking the integrity of the container.

In some examples, the method may include cleaning the container prior to filling the container.

In some examples, cleaning the container may include introducing an amount of filling fluid into the container and rinsing out the container with the introduced fluid.

In some examples, the method may include analyzing the rinsed out fluid for presence of any contaminants.

In some examples, the container may be filled in an inverted position.

In some examples, the container may be manually portable.

In some examples, the container may have a capacity of 1 to 5 gallons.

In some aspects, there is provided a method of providing hazardous liquids for distribution, where the method may include: providing a reusable-dispensing container for storing and dispensing liquids; the reusable-dispensing container having at least one opening that is closed by an openable cover; the openable cover having an open configuration allowing fluid communication to and from the container and a closed configuration inhibiting fluid communication to and from the container, the openable cover configured to be biased to the closed configuration to inhibit unauthorized or unintentional communication of liquid to and from the container; the openable cover being openable only by authorized filling equipment, a closed system being created between the interior of the container and the authorized filling equipment when the cover is opened by the authorized filling equipment; delivering a liquid from the authorized filling equipment to the reusable-dispensing container while recovering displaced vapor from the container by the authorized filling equipment; and providing the filled reusable-dispensing container at a pickup location for pickup by an end consumer.

In some examples, the reusable-dispensing container may include a locking mechanism with an engaged configuration in which the cover is inhibited from being opened and a disengaged configuration in which the cover is enabled to be opened.

In some examples, the locking mechanism may be provided on the cover of the container.

In some examples, the authorized filling equipment may be configured to disable the locking mechanism, the authorized filling equipment being configured to engage the locking mechanism when the authorized filling equipment cooperates with the reusable-dispensing container to open the cover.

In some examples, operation of the authorized filling equipment may be restricted to authorized personnel.

In some examples, the pickup location may be a retail outlet, a franchise location, a kiosk or a vending machine.

In some examples, the authorized filling equipment may include automated equipment at an authorized location.

In some examples, the filled reusable-dispensing containers may be provided to be picked up at the pickup location in response to a request by the consumer.

In some examples, the pickup location may be specified by the consumer.

In some examples, the pickup location may be a customer-defined custom-location.

In some examples, the request may be made by the consumer using an online system.

In some examples, the method may include receiving a used reusable-dispensing container from the consumer at the pickup location.

In some examples, the hazardous liquid may be a solvent, a poison, a pesticide, an herbicide, or a fungicide.

In some examples, the hazardous liquid may be a fuel.

In some examples, the fuel may have a boiling point greater than 20° C.

In some examples, the fuel may be gasoline or diesel that is designated for off-road use and the sale or cost of the gasoline or diesel may be exempt from certain sales tax.

In some examples, the fuel may be gasoline or diesel that is designated for off-road use and the formulation of the gasoline or diesel may be freed from formulation regulations applicable to automotive fuel.

In some examples, the container may be manually portable.

In some examples, the container may have a capacity of 1 to 5 gallons.

In some aspects, there is provided a method of inhibiting the transfer of gasoline or diesel to a motor vehicle, where the method may include: providing a filling dispenser that is incompatible with and/or inaccessible to a fuel tank of the motor vehicles; wherein the filling dispenser is compatible and/or accessible with a reusable-dispensing container.

In some examples, the gasoline or diesel may be designated for off-road use.

In some examples, the filling dispenser may be provided at a gas station.

In some examples, sale or cost of the gasoline or diesel may be exempt from certain sales tax.

In some examples, a dispenser provided for use with the reusable-dispensing container may be incompatible with and/or inaccessible to the fuel tank of the motor vehicle.

In some examples, a dispenser provided for use with the reusable-dispensing container may be configured to inhibit the transfer of gasoline or diesel to the motor vehicle fuel tank.

In some examples, the dispenser may have a dispensing end having a diameter equal to or greater than 1 inch.

In some examples, the off-road use gasoline or diesel may be freed from formulation regulations applicable to automotive fuel.

In some examples, the motor vehicle may be a truck or automobile.

### BRIEF DESCRIPTION OF THE FIGURES

FIGS. 1A-1D show different example fluid containers;

FIGS. 2A-2I show example covers suitable for using with the containers of FIGS. 1A-1D;

3A-4D show example enclosures suitable for using with the containers of FIGS. 1A-1B;

FIG. 5 shows example dispensing attachments suitable for using with the containers of FIGS. 1A-1D;

FIG. 6 shows an example enclosure over an example container;

FIGS. 7A-10B show example dispensing attachments and their cooperation with the covers of FIGS. 2A-2I;

FIGS. 11-16 show example features of an example enclosure;

FIGS. 17A and 17B show example pumps in use with an example container;

FIGS. 18A-18C show example system for distributing fluid;

FIGS. 19A and 19B show example equipment for storing and providing containers;

FIG. 20 shows an example electronic tracking system suitable for use with the system of FIGS. 18A-18C;

FIG. 21 shows an example cover suitable for use with conventional fluid containers;

FIGS. 22A-22N show an example filling equipment and its operation;

FIGS. 23-23D show another example filling equipment and its operation; and

FIGS. 24A-24D show an example of a handheld dispenser.

### DETAILED DESCRIPTION

Conventional fluid containers may be used for storing and/or transporting fuels, such as gasoline (e.g., including different grades of fuel, such as regular, premium and supreme), diesel and kerosene, among others. However, such containers typically rely on the end consumer to fill (e.g., from a gas station). End consumers may be inexperienced in filling such containers and/or in handling fuels. Variations and errors in consumer handling may result in spilling and vapor loss when filling containers.

Further, it is typically up to the end consumer to add any necessary and/or desired additives (e.g., fuel stabilizers), and/or to mix fuels in the desired ratios (e.g., a two-stroke fuel should be mixed in 50:1 or 25:1 ratio). This is typically difficult and/or troublesome for the end consumer to do. The end consumer may also lack the knowledge and/or resources to use the proper additive and/or ratio in the fuel. Additionally, the end consumer may be obligated to store surplus amounts of additives, just to mix a small amount into a container of fuel. It may be costly and/or dangerous for the end consumer to store such surplus chemicals when not in use.

Fluid containers may also be used by the end consumer to store and/or transport other chemicals, such as household chemicals (e.g., herbicides, fertilizers, windshield washer fluid, antifreeze and motor oil, among others), industrial chemicals and other volatile or non-volatile chemicals. Fluid containers may also be used by the end consumer to store and/or transport other liquids, where the end consumer may not have sufficient care, training and/or knowledge to properly and/or safely fill the container with such liquids.

There is typically a cost and burden to the end consumer for disposing and/or cleaning such containers when the containers are empty. Additionally, since the containers are refilled by the end consumer, there is a risk of mislabeling of containers, as well as a risk of contamination.

There is also a cost to the user when filling up a fuel container at a gas station, as fuel from a gas station typically is subjected to road fuel tax. This cost is borne by the consumer even when the fuel is intended for off-road use.

At least some of the above problems may be addressed by the present disclosure.

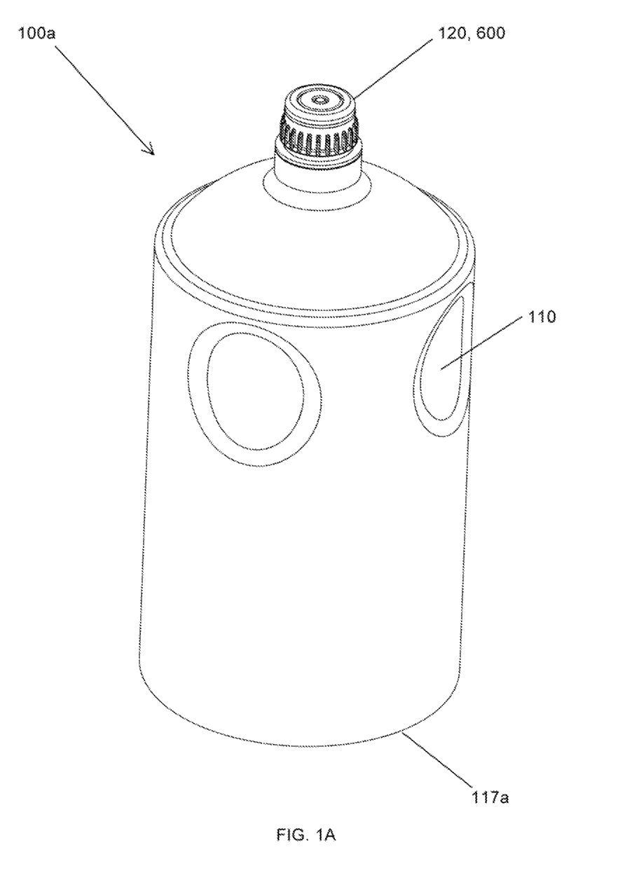

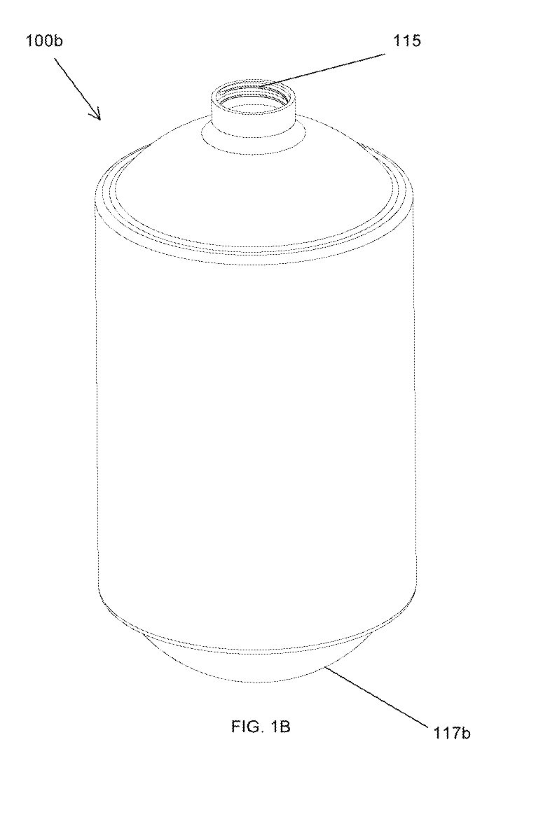

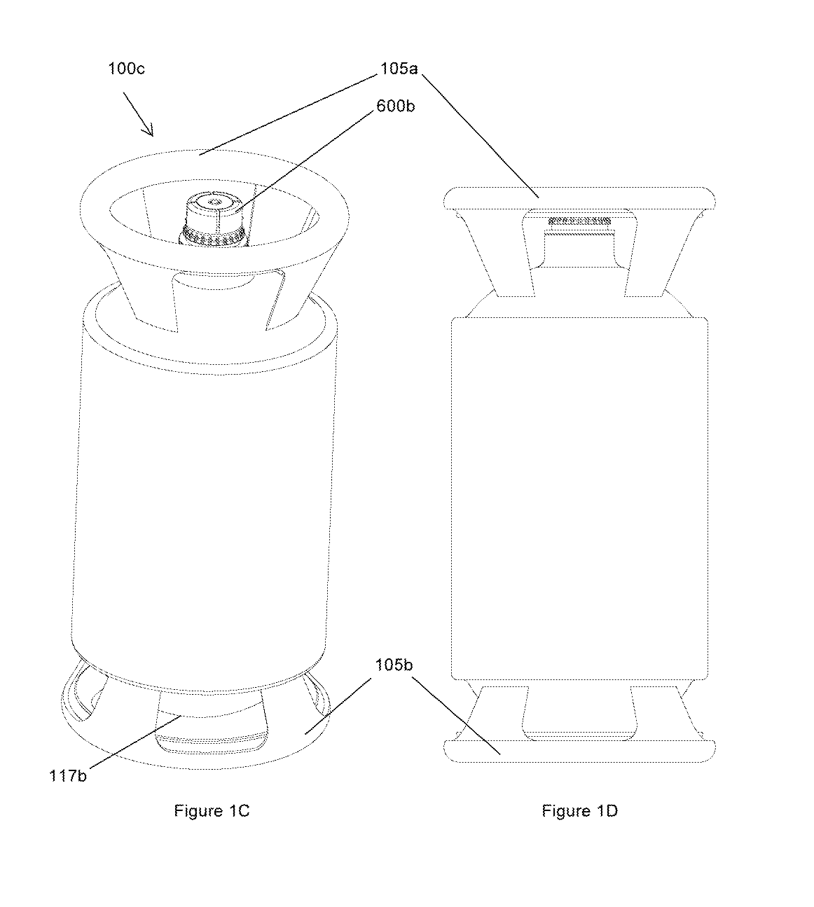

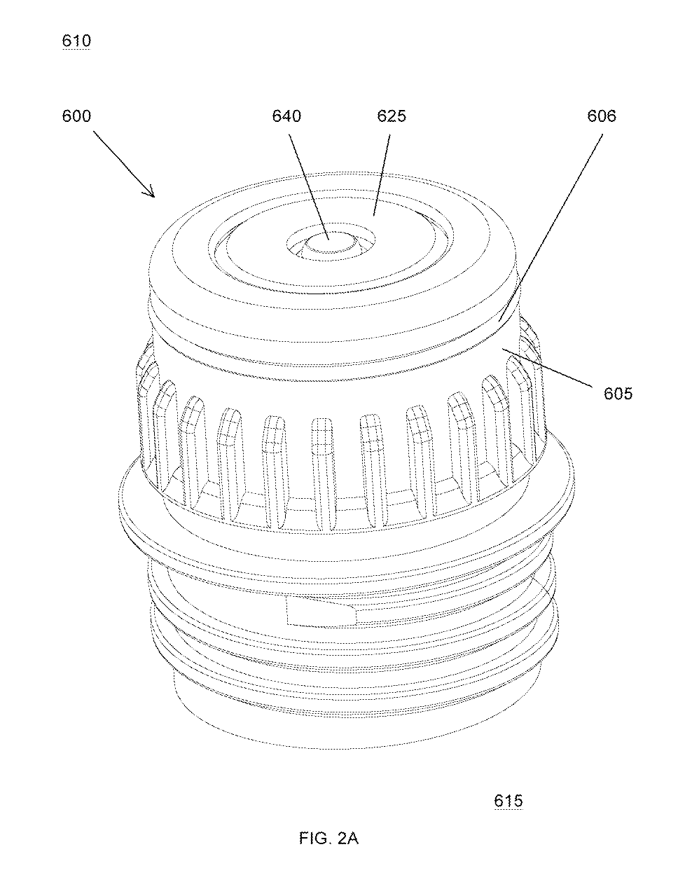

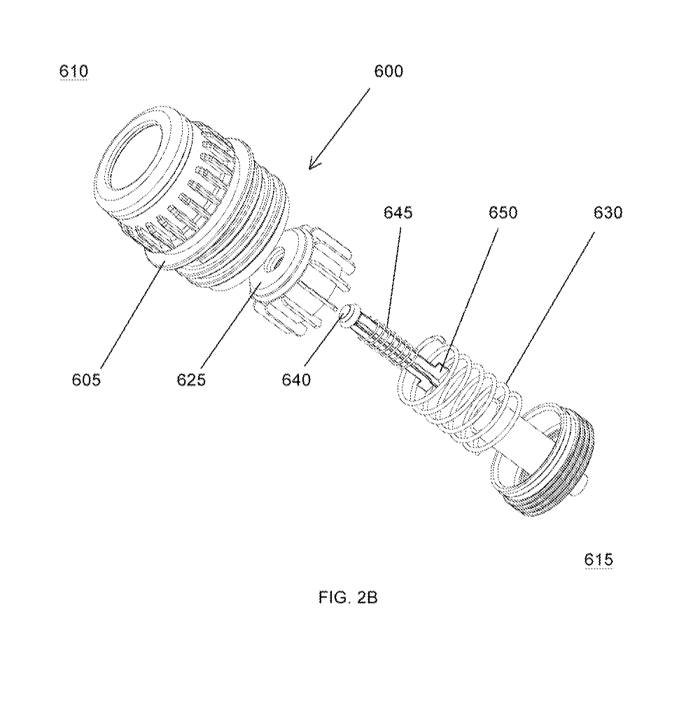

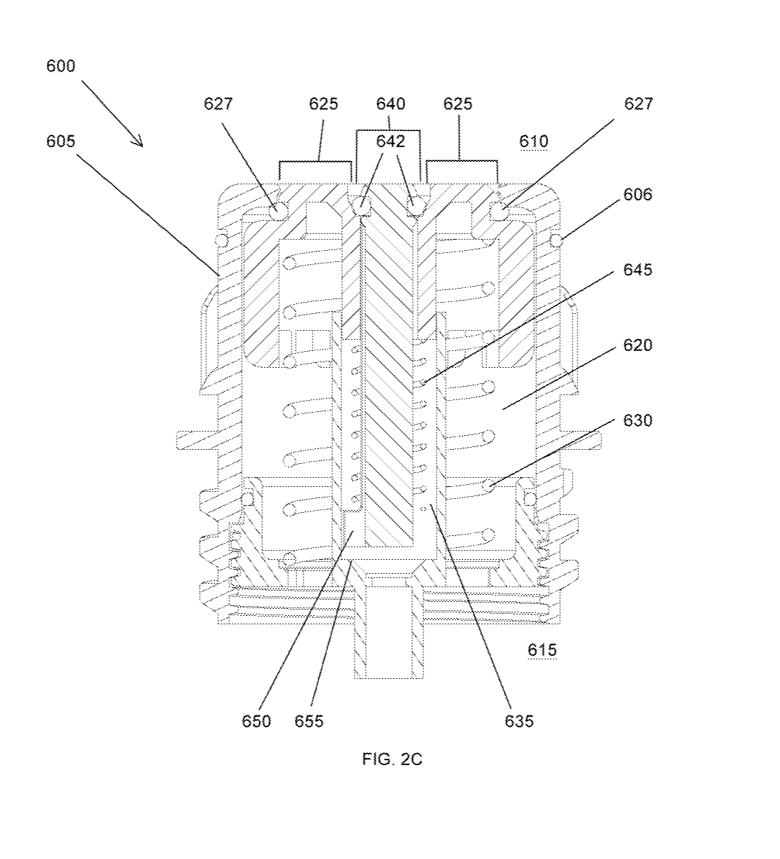

FIGS. 1A-1D show example fluid containers 100a, 100b, 100c. The container 100a, 100b, 100c may include one or more elements described in PCT Application No. PCT/CA2012/000237, filed Mar. 15, 2012, the entirety of which is hereby incorporated by reference.

The container 100a, 100b, 100c may include one or more openings 115 for receiving and dispensing fluid (e.g., a fuel). In some examples, such as in FIG. 1A, the container 100a may include one or more indentations 110 to enable gripping by a user. In other examples, such as in FIG. 1B, the container 100b may not include any indentations 110. The container 100a, 100b, 100c may be made of any suitable material, for example a moldable plastic or a metal, as described below.

The container 100a, 100b, 100c may be designed in a shape, such as a cylinder, to avoid or decrease deformation of the container body 100a, 100b, 100c as vapor pressure within the container 100a, 100b, 100c changes (e.g., increase or decrease of temperature may cause respective increase or decrease of vapor pressure, particularly where the fluid is a volatile fluid, such as a fuel). A relatively cylindrical shape may also enable the container to be maximized for volume while reducing overall size, and may also enable a less costly and/or simpler manufacturing process. In other examples, the container 100a, 100b, 100c may have other configurations (e.g., rectangular in shape), for example to facilitate stacking of containers 100a, 100b, 100c. The container 100a, 100b, 100c may have relatively thick walls (e.g., with ridges), such as where the container 100a, 100b, 100c is intended to hold pressurized contents.

In the example shown in FIG. 1A, the container 100a may have a substantially flat base 117a for resting on a surface. In the example shown in FIG. 1B, the container 100b may include a rounded base 117b. In some examples, the container 100a, 100b, 100c may include a concave or dished base, which may be convenient for a user's hand when tipping the container 100a, 100b, 100c, for dispensing fluid, for example. In some examples, the concave shape of the base may facilitate the stacking of containers 100a, 100b, 100c one on top of the other. For example, in two containers 100a, 100b, 100c stacked one on top and one on the bottom, the concave shape of the base of the container 100 on top may help to accommodate the top of the container 100a, 100b, 100c on the bottom.

FIGS. 1C and 1D show an example container 100c having one or more handles 105a, 105b. The example shown includes top handle 105a and base handle 105b, although more or less handles may be provided at different locations, as suitable. The handle(s) 105a, 105b may be permanently attached to the container 100c, for example by being integrally blow-molded onto the container (e.g., using over-molding) or by welding (e.g., on a metal container). The handle(s) 105a, 105b may help in transport and manipulation of the container 100c. The top handle 105a may also help to protect the cover and/or valve (in this example shown as cover 600b, discussed further below) and possibly reduce damage to the cover and/or valve during transport, for example.

In some examples, the container 100a, 100b, 100c may be configured with one or more flat surfaces (e.g., flat side(s) and/or flat base 117a) to facilitate stacking and/or to avoid rolling of the container 100a, 100b, 100c during storage and/or transport. For example, the container 100a, 100b, 100c may be configured to be substantially cylindrical in shape, but flattened on one side to enable the container 100a, 100b, 100c to be laid on its side without rolling.

The container 100a, 100b, 100c may be formed using, for example, molding processes such as blow-molding or rotational molding. The container 100a, 100b, 100c may be manufactured without handles, which may simplify the molding process and/or avoid wasted material during molding and/or reduce costs of manufacture compared to conventional containers. Any handles and/or grips for handling the container 100a, 100b, 100c may instead be provided by the enclosure or a frame (described below). This may be unconventional when it comes to larger conventional portable containers, which may be conventionally provided with handles either attached or molded right into the body of the container.

The container 100a, 100b, 100c may be manufactured without concern that the container 100a, 100b, 100c has to support itself in an upright position, since an enclosure (described further below) may serve to support the container 100a, 100b, 100c in an upright position. Thus, the shape of the container 100 (e.g., a cylindrical shape with a rounded base) may be designed to be relatively easy to manufacture using, for example, blow-molding techniques.

The container 100a, 100b, 100c may be relatively rigid, or may be flexible. Where the container 100a, 100b, 100c is relatively flexible, an enclosure for the container may provide rigidity and support.

The container 100a, 100b, 100c may include a cover 120 for covering the container opening 115. In general, a cover of the container 100a, 100b, 100c may be considered to be part of the container 100a, 100b, 100c. The cover 120 may be threadably mountable on the opening. The cover 120 may be removably attachable to the container 100a, 100b, 100c (e.g., the cover 120 may be a screw cap) or may be permanently attached to the container 100a, 100b, 100c (e.g., with one or more locking mechanisms). In the example of FIG. 1A, the cover 120 may comprise one half of a quick disconnect valve fitting or dry-break connection. The other half of the quick disconnect valve fitting or dry-break connection may be provided by an enclosure, a dispenser or other conveying attachment (described further below), for example. The cover 120 may include one or more valves (described further below), which may cooperate with the enclosure.

In some examples, the cover 120 may be puncturable so as to allow for fluid flow from the container 100a, 100b, 100c. Such a cover 120 may be designed for one-time use, and may be replaceable for subsequent uses. Such a cover 120 may be suitable where the container 100a, 100b, 100c is intended to be disposable, for example. A disposable container 100a, 100b, 100c may avoid the need for the consumer to return the container 100a, 100b, 100c for refilling, may reduce or prevent the possibility of contamination, may be less costly and/or quicker to manufacture, and/or may be made of a recyclable material. A one-time use cover 120 may be replaceable only by authorized and/or trained personnel, such that the consumer or other unauthorized person may be inhibited from refilling the container 100a, 100b, 100c. In general, any suitable cover for the container 100a, 100b, 100c may be openable by moving the cover itself to an opened configuration (e.g., opening a valve on the cover or puncturing the cover) or may be openable by removing the cover from the opening of the container 100a, 100b, 100c.

The cover 120 may be configured for communication of liquid and vapor. For example, the cover 120 may be configured with separate conduits for passage of liquid and vapor, such as in the form of a dual-passage dry-break connection.

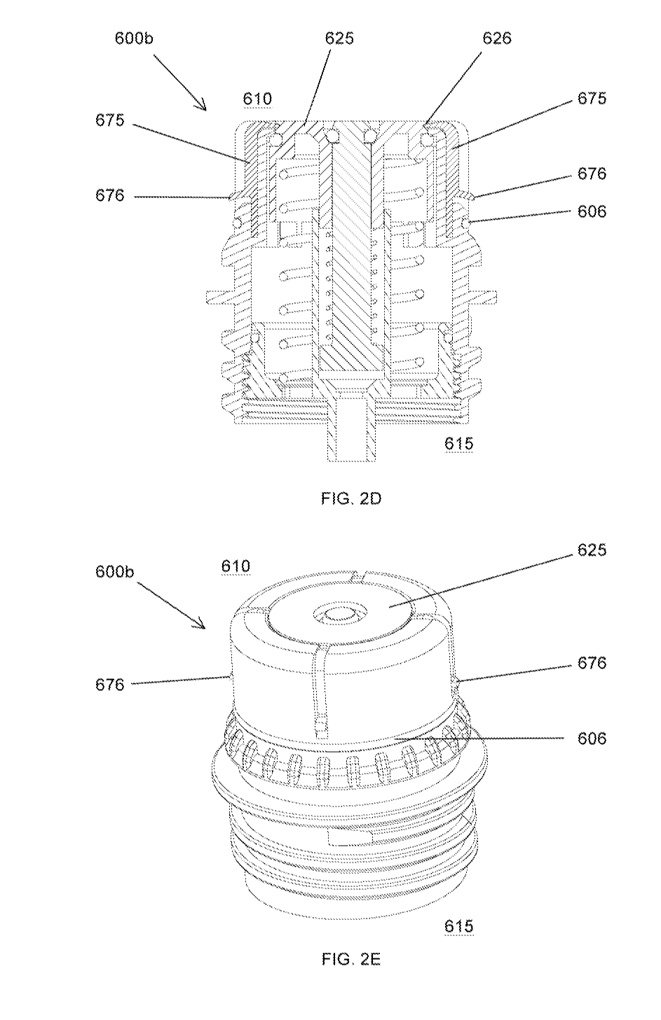

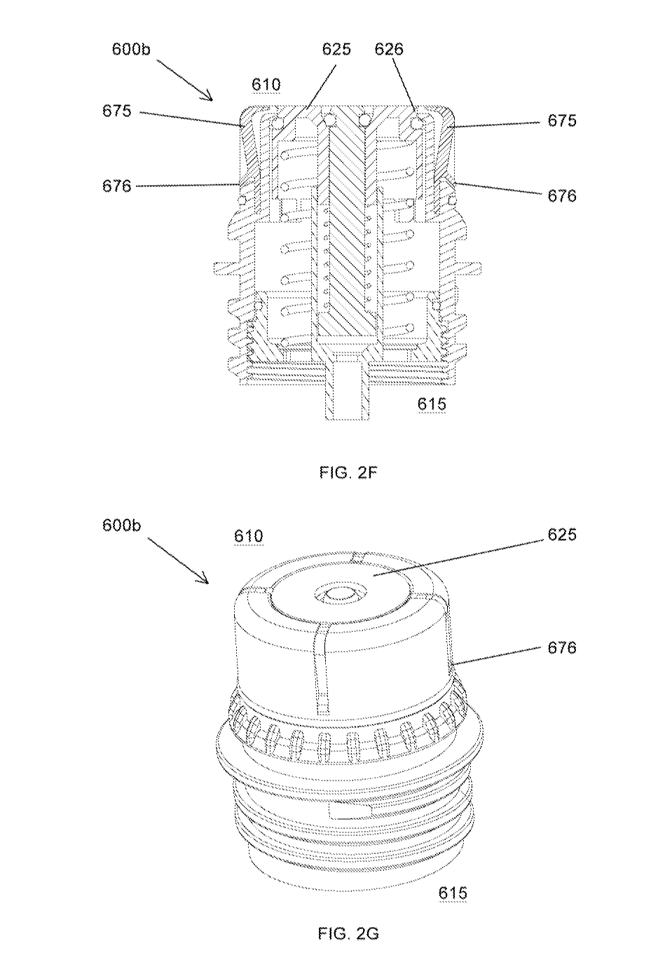

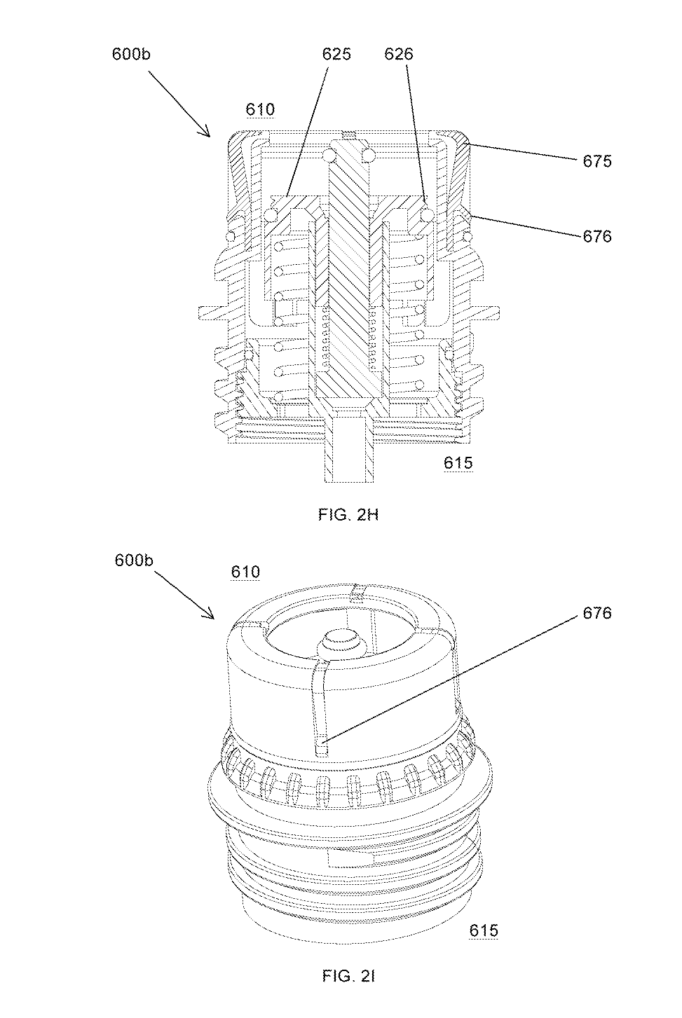

In the example of FIGS. 2A-2C, the cover 600 may serve as a fluid flow control mechanism and/or one half of a dual-passage quick disconnect valve fitting or dry-break connection. A dual-passage cover 600 may be suitable where the container 100a, 100b, 100c, is intended to be used with a dispensing system with liquid delivery and vapor recovery capabilities, in which liquid may be delivered from the container 100a, 100b, 100c through one passage and vapor may be separately recovered into the container 100a, 100b, 100c through another passage.

In the example shown, the cover 600 includes a body 605 defining a connection end 610 and an attachment end 615. The connector or cover 600 may be attachable to the container 100a, 100b, 100c at or near the attachment end 615, while the connection end 610 may receive another connector (e.g., provided by the enclosure, described further below) to form a dry-break connection. The connection end 610 may include one or more seals 606 such as an o-ring to provide an air tight leak-proof seal (e.g., closed system) between the connection end 610 and another connector (e.g., conveying attachment, dispensing device, described further below) that may be received. The attachment end 615 may include one or more features (e.g., grooves, threads, protrusions, barbed hose connection or snap-fittings) to enable attachment of the cover 600 to the container 100a, 100b, 100c or otherwise enable connection of the cover 600 to a container 100a, 100b, 100c (e.g., via a hose or hoses).

A first fluid passage 620 may be defined within the body 605 for permitting fluid flow through the body 605. The first fluid passage 620 may permit fluid to flow to the connection end 610, for example by enabling fluid communication at least between the attachment end 615 and the connection end 610. A first valve 625 may be provided (e.g., in the first fluid passage 620) for controlling or mediating flow of fluid through the first fluid passage 620. The first valve 625 may be sealed using, for example, an o-ring 627 or any other suitable sealing member. The first valve 625 may be biased towards the connection end 610 (e.g., by a biasing member, such as a compression spring 630) to define a closed position (or valve closed configuration) of the first valve 625 in which fluid flow through the first fluid passage 620 is inhibited.

A second fluid passage 635 may be defined within the body 605 permitting fluid flow through the body 605. The second fluid passage 635 may permit fluid to flow from the connection end 610, for example by enabling fluid communication at least between the connection end 610 and the attachment end 615. A second valve 640 may be provided (e.g., in the second fluid passage 635) for controlling flow of fluid through the second fluid passage 635. The second valve 640 may be sealed using, for example, an o-ring 642 or any other suitable sealing member. The second valve 640 may be biased towards the attachment end 615 (e.g., by another biasing member, such as another compression spring 645) to define a closed position (or valve closed configuration) of the second valve 640 in which fluid flow through the second fluid passage 635 is inhibited.

Although the fluid passages 620, 635 have been described as enabling fluid communication between the connection end 610 and the attachment end 615, it should be understood that in operation fluid may not necessarily travel the full distance between the connection end 610 and the attachment end 615.

The first and second valves 625, 640 may be independently biased towards their respective closed positions. Independent biasing of the valves 625, 640 may help to ensure that a fluid-tight seal is maintained by each valve 625, 640 in its respective closed position. For example, each valve 625, 640 may require a different biasing force to maintain a fluid-tight seal. This may be difficult to achieve if a single biasing force were used for both valves 625, 640. The use of independent biasing may also help to simplify manufacture of the cover 600 since it may be easier to adapt manufacturing tolerance levels where the valves 625, 640 are independently biased.

In the example shown, the first and second valves 625, 640 are positioned near the connection end 610 and may define the connection surface. This may allow the valves 625, 640 to form a substantially planar surface for the cover 600 when in their respective closed positions, to help reduce the amount of liquid that might remain when the dry-break connection is separated.

To open the cover 600 and permit fluid flow through the cover 600, the first valve 625 and the second valve 640 may be moved at least partially from their respective closed positions to respective opened positions (or valve opened configurations) by moving the first valve 625 towards the attachment end 615. The motion of the first valve 625 may cause the second valve 640 to become unseated.

The interconnected motion of the first and second valves 625, 640 may result from a single motion of the first valve 625 towards the attachment end 615. For example, motion of the first valve 625 toward the attachment end 615 simultaneously, nearly simultaneously or with some slight delay may also unseat the second valve 640 thereby moving the second valve 640 to its opened position (or valve opened configuration). This may be the case, for example, where the second valve 640 is seated against the first valve 625 when both valves 625, 640 are in their respective closed positions, as shown in FIG. 2C. In the example shown, the second valve 640 may not be immediately unseated when the first valve 625 starts its motion towards the attachment end 615. The second valve 640 may be carried along by the first valve 625 towards the attachment end 615 for a short period, until a post 650 of the second valve 640 contacts or abuts against a stop 655, at which point the second valve 640 is prevented from moving in the same direction as the first valve 625 and is unseated from the first valve 625.

FIGS. 2D-2I show an example cover 600b that is lockable. The cover 600b may be generally similar to the cover 600. In the example of FIGS. 2D-2I, the cover 600b may additionally include a locking mechanism 675 which may cooperate to be located and move within a complementary feature on the body 605 of the cover 600b, and may additionally cooperate with indent 626 or groove on the valve 625 to prevent the valve 625 from being unintentionally actuated. The locking mechanism 675 may be biased to an engaged configuration where it inhibits the valves 625, 640 from being opened and may be reconfigured to a disengaged configuration that releases the valve 625 so that the valves 625, 640 may be opened when an actuator 676 is properly actuated (e.g., by cooperation with an attachment, as described below). In some examples, the locking mechanism 675 may not be biased to the engaged configuration and may need to be manually moved back to the engaged configuration. The locking mechanism 675 may engage one or more valves 625, 640. As illustrated in FIGS. 2D-2I, where there is interconnected motion between the first valve 625 and the second valve 640, the locking mechanism 675 may only need to engage one of the valves 625, 640 (in the example shown, the first valve 625 is engaged by the locking mechanism 675) in order to prevent both valves 625, 640 from being opened. The locking mechanism 675 may be movable in a number of ways (e.g., hinged, translatable, and/or resiliently deformable such as in the case of a spring clip) such that the locking mechanism 675 may move from the engaged configuration that engages the valve 625 to inhibit the valves 625, 640 from being opened to the disengaged configuration that disengages the valve 625 to enable the valve 625, 640 to be opened.

In the example shown, the first fluid passage 620 and the second fluid passage 635 may be generally co-axial. In other examples, the first fluid passage 620 and the second fluid passage 635 may be in tandem, concentric, contained in each other but off-center, or separated from each other, among other configurations.

The example cover 600, 600b may be used for mediating two-phase fluid flow. For example, the first fluid passage 635 may be configured for liquid fluid flow and the second fluid passage 640 may be configured for vapor fluid flow, or vice versa. In some examples, the fluid may be a volatile fluid (e.g., a fluid fuel). Thus, the cover 600, 600b may provide a two-phase fluid connection, such as for fuel dispensing systems having vapor recovery capabilities.

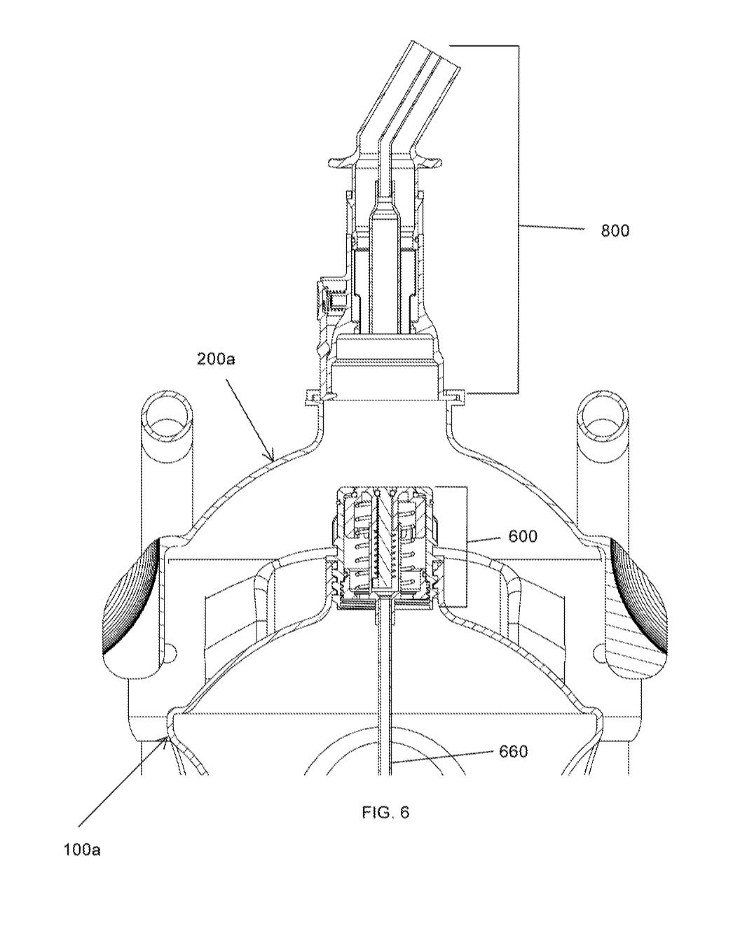

In some examples, there may be a conduit extension 660 (see FIG. 6) that may be in fluid communication with any of the fluid passages 620, 635 of the cover 600, 600b. The conduit extension 660 may be, for example, a hose to help direct fluid flow. In the example shown, the conduit extension 660 may be in fluid communication with the second fluid passage 635 of the cover 600, 600b for directing vapor received in the second fluid passage 635 towards the base 117a, 117b of the fluid container. This configuration may help to speed up fluid transfer when the fluid container is inverted by helping to equilibrate pressure inside the fluid container and pressure inside the fluid destination. Although not shown, it should be understood that the conduit extension 660 may also be provided in fluid communication with any of the fluid passages of any dispenser on the enclosure 200a, 200b.

When filling the container 100a, 100b, 100c with a liquid, it may be useful to fill the container 100a, 100b, 100c starting from lowest region of the container 100a, 100b, 100c which is dependent on the orientation of the container 100a, 100b, 100c (e.g., towards the base 117a, 117b when the container 100a, 100b, 100c is upright and towards the opening when the container 100a, 100b, 100c is inverted) so as to allow vapors to escape when filling the container 100a, 100b, 100c. When the container 100a, 100b, 100c is in the upright orientation, the conduit extension 660 may be used to fill the container 100a, 100b, 100c. It may be useful to fill the container 100a, 100b, 100c through fluid passage 635 and the conduit extension 660 and allow vapor to be recovered through the fluid passage 620 in the cover 600, 600b. When the container 100a, 100b, 100c is filled in the inverted orientation, it may be useful to fill the container 100a, 100b, 100c through the fluid passage 620 to allow the displaced vapor to be recovered through the fluid passage 635 and conduit extension 660.

The conduit extension 660 may additionally be effectively used in the cleaning process, when a used container 100a, 100b, 100c is cleaned to be refilled and reused. The cleaning process may be done when the container 100a, 100b, 100c is in an inverted orientation (see FIG. 19B, for example). As the cleaning liquid (e.g., a small quantity of a similar chemical or fuel) is introduced into the container 100a, 100b, 100c with some force, it would strike the interior near the base 117a, 117b of the container 100a, 100b, 100c where it would fan out and cascade evenly down the interior side of the container 100a, 100b, 100c to pool above the cover 120, 600, 600b. The introduced liquid may then be drained through the fluid passage 620 in the cover 120, 600, 600b. This recovered cleaning liquid from the rinsing process may be collected and tested for a variety of contaminants. If it is determined to be free of contamination, the cleaning liquid may be reintroduced into the container 100a, 100b, 100c for filling the container 100a, 100b, 100c, may be reused for cleaning other containers 100a, 100b, 100c and/or may be sold off (e.g., to recycling centers) for another end use, possibly along with any other contaminated liquid collected during the cleaning process.

In some examples, the container 100a, 100b, 100c may be configured to be tamper-proof. For example, the cover 120, 600, 600b may be configured to allow only dispensing of fluid by the end consumer, and may require specialized equipment to remove and/or enable refilling of the container 100a, 100b, 100c (e.g., at a refilling station and/or by trained personnel). In some examples, the cover 120, 600, 600b may be configured to be openable only in cooperation with the enclosure. The cover 120, 600, 600b may be configured to not be removable by the end consumer. For example, the cover 120, 600, 600b may be configured (e.g., with one-way locking tabs) such that once attached to the container 100a, 100b, 100c, the cover 120, 600, 600b cannot be removed. In some examples, the cover 120, 600, 600b may be configured to be removable only with specialized equipment (e.g., at a refilling station and/or by trained personnel).

In some examples, one or more valves may be directly formed on the container (e.g., integrally formed with the container 100a, 100b, 100c or otherwise permanently attached to the container 100a, 100b, 100c) at the container opening 115, such that a separate cover 120, 600, 600b containing the valve(s) (e.g., valves 625, 640) may not be necessary. In some examples, the cover 120, 600, 600b may be integrated or permanently attached to the container 100a, 100b, 100c, such that the valve(s) may be considered to be part of the body of the container 100a, 100b, 100c.

The container 100a, 100b, 100c may be configured to cooperate with specialized equipment (e.g., at a refilling station) to enable refilling of the container 100a, 100b, 100c by trained personnel. The configuration of the container 100a, 100b, 100c (e.g., having valves 625, 640 on the cover 600, 600b) may serve as a safety mechanism to restrict unauthorized filling of the container 100a, 100b, 100c, since conventional filling equipment (e.g., conventional gas station nozzles) may be incompatible with the container 100a, 100b, 100c and may be unable to open the valves 625, 640).

The container 100a, 100b, 100c (including the cover 120, 600, 600b) may be constructed of any suitable material including, for example, any suitable plastic, metal or compound material. The container 100a, 100b, 100c may include materials that are resistant to reaction with its contents. For example, an inner lining of the container 100a, 100b, 100c or the entire container 100a, 100b, 100c may be made of a material that is resistant to corrosion by fuel and/or other chemicals to be stored in the container 100a, 100b, 100c. Where the container 100a, 100b, 100c is constructed from plastic, the container 100a, 100b, 100c may be blow molded or injection molded (e.g., with the bottom welded on, glued on or integrally molded). Where the container 100a, 100b, 100c is constructed from metal, any suitable manufacturing techniques (e.g., stamped or spun techniques) may be used.

Because the container 100a, 100b, 100c is intended to be used with an enclosure, which may enclose all or a majority of the container 100a, 100b, 100c, the container 100a, 100b, 100c may be made of a less sturdy material and/or an uncolored material (e.g., in order to reduce manufacturing costs and manufacturing time for the container 100a, 100b, 100c) since the enclosure may provide any necessary rigidity and/or identification (such as color-coding). Because the container 100a, 100b, 100c is intended for used with an enclosure, the container 100a, 100b, 100c may be manufactured with relatively few additives (e.g., pigments and/or UV protectors, which may be necessary to comply with safety regulations, for example), with the enclosure instead providing any suitable color coding and/or UV protection, as appropriate, for example. In some examples, the container 100a, 100b, 100c may be manufactured to be relatively thin-walled and/or soft (e.g., in the form of a flexible bag).

In some examples, the container 100a, 100b, 100c may be designed to contain 1 to 5 gallons, such as 4 gallons (about 15.14 L) or 2 gallons (about 7.57 L), similar to conventional portable fuel containers.

The container 100a, 100b, 100c may be configured to enable flow of fluid from the container 100a, 100b, 100c via gravity. For example, the opening 115 may be configured such that when the container 100a, 100b, 100c is resting on its base, fluid, in particular a liquid, may not flow from the container 100a, 100b, 100c even when the cover 120, 600, 600b is open. The container 100a, 100b, 100c may need to be inverted in order for fluid to flow out.

FIGS. 3A-3C and 4A-4D show examples of enclosures 200a, 200b that may be assembled with the container 100a, 100b, 100c. The enclosure 200a, 200b assembled with the container 100a, 100b, 100c may be collectively referred to as an assembly. The enclosure 200a, 200b may include one or more elements described in PCT Application No. PCT/CA2012/000237, which has been previously incorporated by reference.

FIGS. 3A-3C show an example embodiment of the enclosure 200a. FIGS. 3B-3C illustrate how the enclosure 200a may be coupled to the container 100a, 100b, 100c.

The enclosure 200a may include one or more members that together at least partially surround the container 100a, 100b, 100c and that may form one or more handles 205 for manual manipulation of the enclosure 200a. The enclosure 200a may also include one or more grips 210 that may cooperate with one or more respective indentations 110 on the container 100a, 100b, 100c to allow a user's hand to grip the enclosure 200a, for example to enable transport or manipulation of the enclosure 200a (with or without the container 100a, 100b, 100c). The enclosure 200a may also interconnect with another enclosure 200a so as to be connected to each other via one or more mating members 215. The mating member(s) 215 of one enclosure 200a may include fingers, fins or protrusions designed to interlock or mate with complementary finger(s), fin(s) or protrusion(s), and/or complementary recess(es) of another enclosure 200a. The mating member(s) 215 need not exactly match or mate with a corresponding feature on the other enclosure 200a. For example, the mating member(s) 215 may loosely fit with a recess or complementary mating member(s) 215 of the other enclosure 200a. The mating member(s) 215 may join two or more enclosures 200a together loosely (e.g., enabling some sliding or shifting relative to each other), but not necessarily in fixed relation. The mating member(s) 215 may be provided on more than one side of the enclosure 200a to enable joining of enclosures 200a in multiple directions. Although the enclosure 200a has been described as being coupled to another enclosure 200a, the enclosure 200a may be coupled to other enclosures having different configurations, for example the enclosure 200a may be coupled to the enclosure 200b.

FIGS. 4A-4D show another example embodiment of the enclosure 200b. Although FIG. 4A shows the enclosure 200b without a dispenser 300 (described further below), the enclosure 200b may be typically provided with a dispenser 300. FIGS. 4C-4D illustrate how the enclosure 200b may be coupled to the container 100a, 100b, 100c. In this example, the enclosure 200b may be formed from panels 250. Although in FIGS. 4A-4D four panels 250 are shown, less or more panels 250 may be used. Although the panels 250 are shown as forming a quadrilateral shape surrounding the container 100a, 100b, 100c, the panels 250 may form any shape, regular or irregular, surrounding the container 100a, 100b, 100c. Although the panels 250 are shown as being substantially planar or slightly curved, the panels 250 need not be substantially planar or slightly curved. Although the panels 250 are shown as being separate, in some examples two or more panels 250 may be joined together, for example in a fixed arrangement or hingedly attached to each other. The panels 250 may be substantially similar to each other, as shown, or may be different from each other in shape and/or size, for example.

As in the example described above, the enclosure 200b may be provided with one or more handles 205 for carrying and manipulating the enclosure 200b (with or without the container 100a, 100b, 100c). The handle(s) 205 may be integral to the enclosure 200b or may be a separate component that is attachable to the enclosure 200b. In some examples, a window 255 may be defined in one or more panels 250 of the enclosure 200b. The window 255 may allow a portion of the container 100a, 100b, 100c inside the enclosure 200b to be viewable through the enclosure 200b, which may enable a user to view the fluid within the container 100a, 100b, 100c (e.g., where the container 100a, 100b, 100c is made of a transparent or translucent material), for example to determine the fluid level or the type of fluid within the container 100a, 100b, 100c. The window 255 may be an aperture defined in a panel 250, or may be a transparent or translucent portion of a panel 250. In some examples, one or more markings (e.g., volume markings) may be provided adjacent to the window 255 to assist in determining the volume of fluid in the container 100a, 100b, 100c.

The enclosure 200a, 200b may be made of any suitable material, for example a metal (e.g., aluminum) or plastic material. The enclosure 200a, 200b may be manufactured as a single piece (e.g., integrally formed) or may be assembled from multiple components. For example, the enclosure 200a, 200b may include one or more frames, struts or panels 250 that cooperate with one or more handles 205. The enclosure 200a, 200b may be assembled from such components at a manufacturer and may not be disassembled by a consumer, for example. In some examples, different frames, struts, panels 250 and handles 205 may be mixed and matched to suit different applications (e.g., different features, colors, materials, sizes, etc.).

The enclosure 200a, 200b may be designed to be fitted about the container 100a, 100b, 100c at a manufacturer, container distributor and/or refilling station, for example as described further below, and not to be removed by a consumer, for example to comply with safety regulations. In some examples, the enclosure 200a, 200b may be permanently attached to the container 100a, 100b, 100c, or may require specialized equipment to remove the enclosure 200a, 200b from the container 100a, 100b, 100c. For example, the enclosure 200a, 200b may be snap-fitted over the container 100a, 100b, 100c, or the enclosure 200a, 200b may be screwed or welded onto the container 100a, 100b, 100c, as appropriate. Where appropriate, the enclosure 200a, 200b may include one or more features to comply with safety regulations (e.g., warnings, manufacturer's information, color coding, etc.). For example, the container 100a, 100b, 100c may be manufactured without pigments (e.g., may be white) while the enclosure 200a, 200b may be entirely or partially colored according to safety regulations (e.g., red to indicate gasoline is contained, yellow to indicate a diesel fluid is contained, or blue to indicate a kerosene fluid is contained).

In some examples, same or different embodiments of the enclosure 200a, 200b may be joined together, for example using mating member(s) 215 and/or fastener(s) (e.g., a latch 225). This may simplify storage and/or transport of the enclosures 200a, 200b (and any containers 100a, 100b, 100c within the enclosures 200a, 200b).

The enclosure 200a, 200b may include one or more handles 205 at multiple locations, such as at the top, sides and/or base of the enclosure 200a, 200b. The handle(s) 205 may also facilitate securing of the enclosure 200a, 200b during transport (e.g., to enable other fasteners to be attached to the enclosure 200a, 200b).

The use of the enclosure 200a, 200b may also allow the container 100a, 100b, 100c to be relatively cylindrical or round, which may be useful to resist deformation from changes in inner vapor pressure, for example, while the enclosure 200a, 200b may provide a non-rolling shape (e.g., rectangular or with flat sides), which may enable stacking of enclosures 200a, 200b with containers 100a, 100b, 100c within. For example, the enclosure 200a, 200b may form a four-sided or three-sided shape, which shape may be relatively easily stacked side-by-side or on top of each other. In some examples, portions of the enclosure 200a, 200b may sufficiently extend beyond the sides of container 100a, 100b, 100c within, to enable such stacking.

Although not shown, in some examples the enclosure 200a, 200b may include one or more convenience features (e.g., hooks, recesses or openings), for example, which may serve as storage location(s) for storing any tools, adaptors or attachments (e.g., any tools, adaptors or attachments that may be commonly used with fuel dispensing, such as adaptors for a spout). Such convenience features may include, for example, hooks or clips for attaching a covering (e.g., a curtain, a tarp, a fabric, a radar-absorbing material or a camouflage material) to the enclosure 200a, 200b, which covering may be used to cover some or all of the enclosure 200a, 200b.

The assembly of the enclosure 200a, 200b and the container 100a, 100b, 100c may provide a modular system that may allow one or more additional components (e.g., spout and handles) to be altered. For example, the enclosure 200a, 200b may be updated independently of the container 100a, 100b, 100c, and vice versa. The same container 100a, 100b, 100c may be used with multiple different enclosures 200a, 200b, and vice versa.

The enclosure 200a, 200b may include a dispenser 300, which may be in the form of a spout, for dispensing fluid from the container 100a, 100b, 100c. The dispenser 300 may be integral with the enclosure 200a, 200b (e.g., welded, glued or integrally formed together) or may be a separate component attached to the enclosure 200a, 200b. The dispenser 300 may cooperate with the cover 120, 600, 600b (if present) and/or valve(s) of the container 100a, 100b, 100c to enable dispensing of fluid from the container 100a, 100b, 100c.

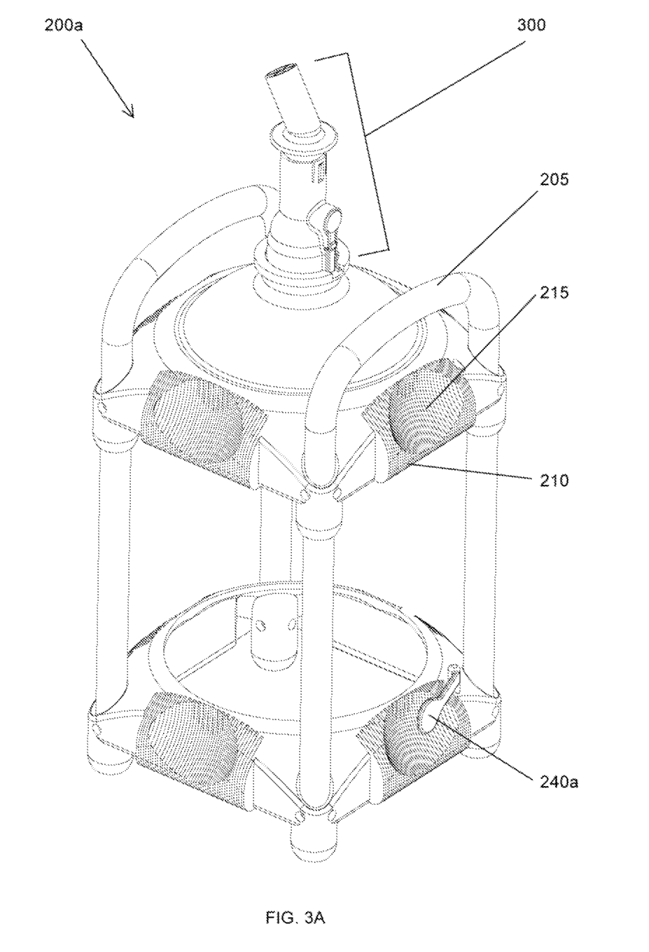

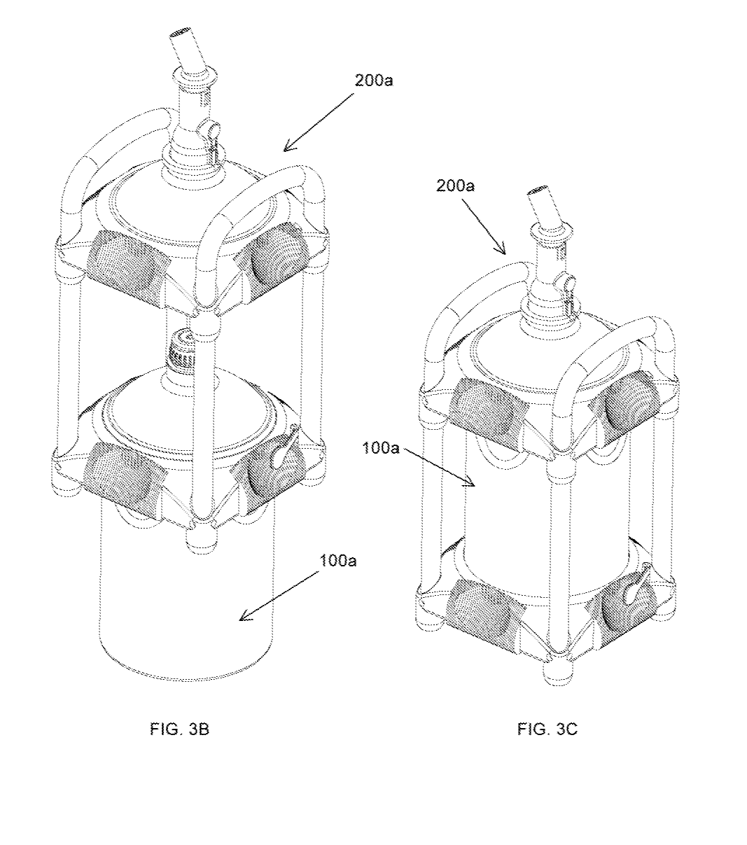

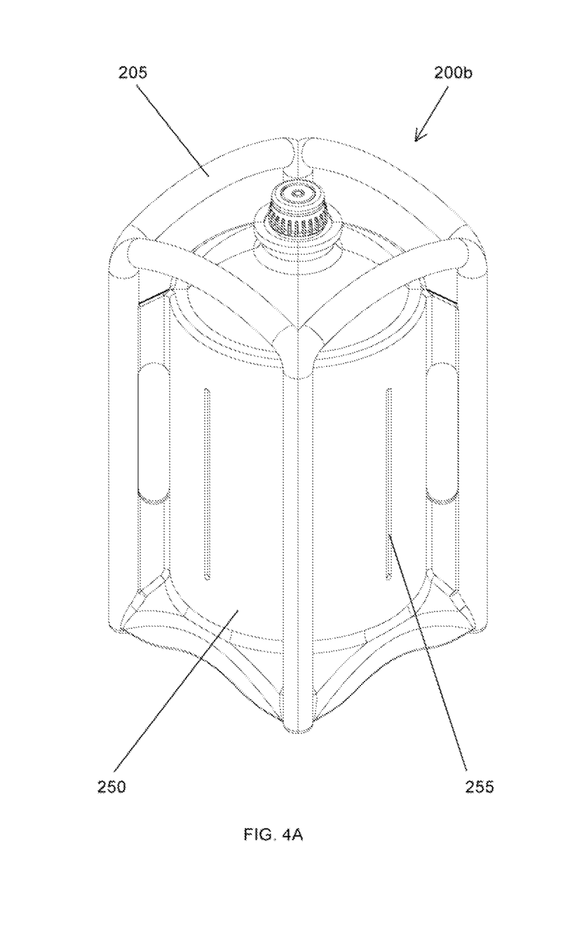

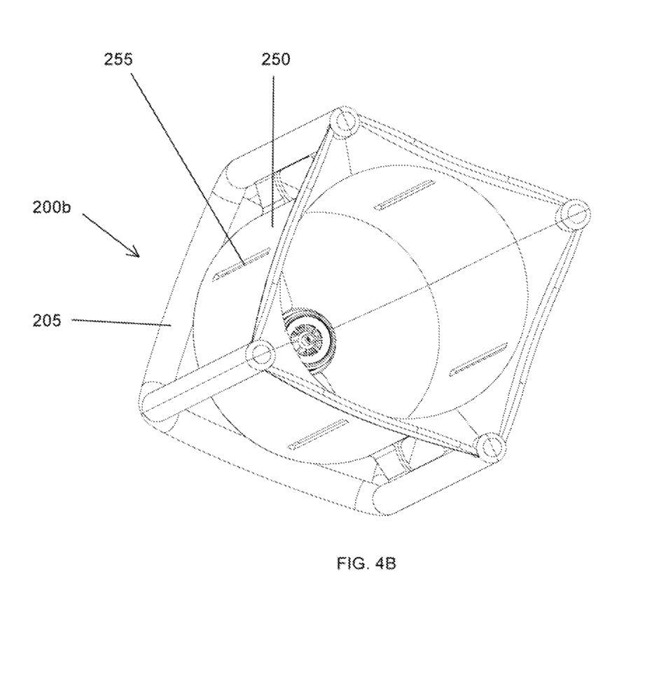

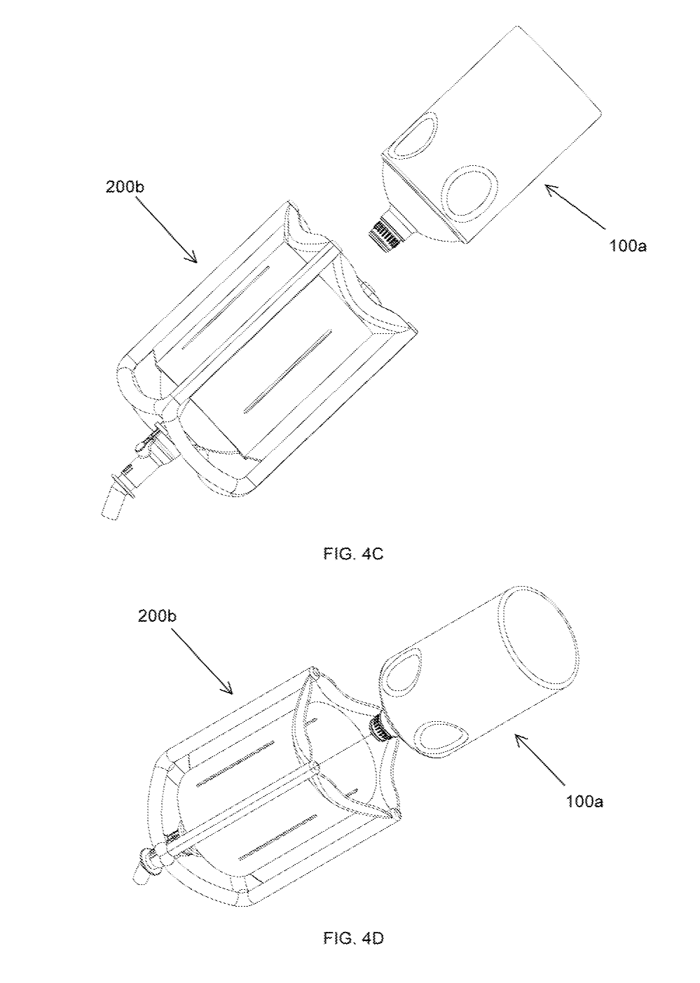

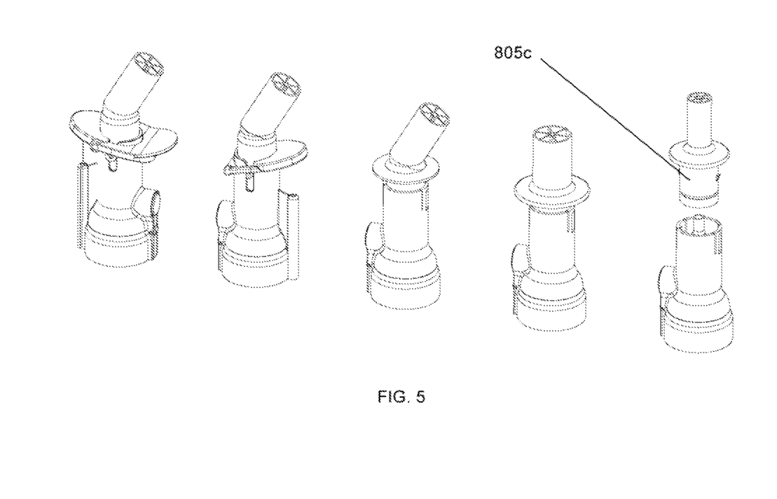

FIGS. 3A-3C and 4A-4D show the example dispenser 300 in the form of a spout. In some examples, the dispenser 300 may include a removable and/or interchangeable spout and/or spout tip for dispensing fluid from the container 100a, 100b, 100c. Some examples of spouts and/or spout tips are shown in FIG. 5. Different spouts and/or spout tips 805c may be used to suit various fluid dispensing purposes. For example, different spouts and/or spout tips 805c may be used to adapt the dispenser 300 for larger or smaller inlets, higher or lower flow rates, straight or angled dispensing tip or any other suitable adaptation. In some examples, the removable and/or interchangeable spout and/or spout tip 805c may form part of the dispenser 300, while in other examples the spout tip 805c may be removable and/or interchangeable where the spout tip 805c may be an added accessory to the dispenser 300.

In some examples, the dispenser 300 may be attachable to the cover 120, 600, 600b or opening of the container 100a, 100b, 100c, for example via a snap fit, a threaded fit, a tongue-and-groove fit or a tight fit. In other examples, the dispenser 300 may not itself attach to the cover 120, 600, 600b or container 100a, 100b, 100c, but positioning of the dispenser 300 over the container 100a, 100b, 100c may be facilitated by attaching the enclosure 200a, 200b to the container 100a, 100b, 100c.

In some examples, the dispenser 300 may include one or more projections that may pierce a pierceable cover 120 (e.g., where the cover 120 is intended for one-time use). Such an arrangement may be similar to that found on the cover on a container of window washer fluid.

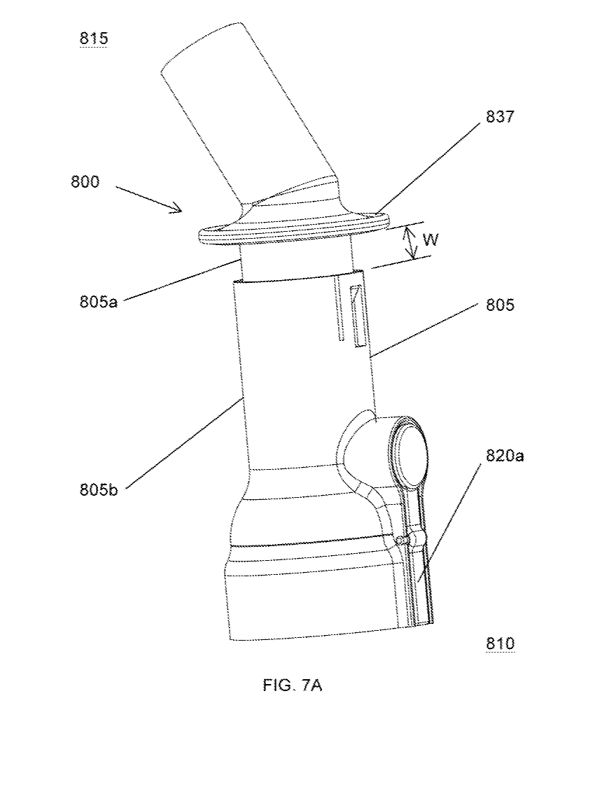

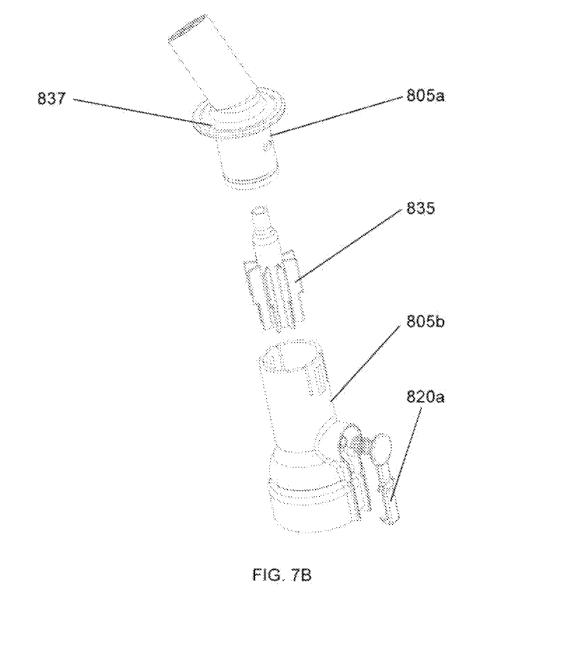

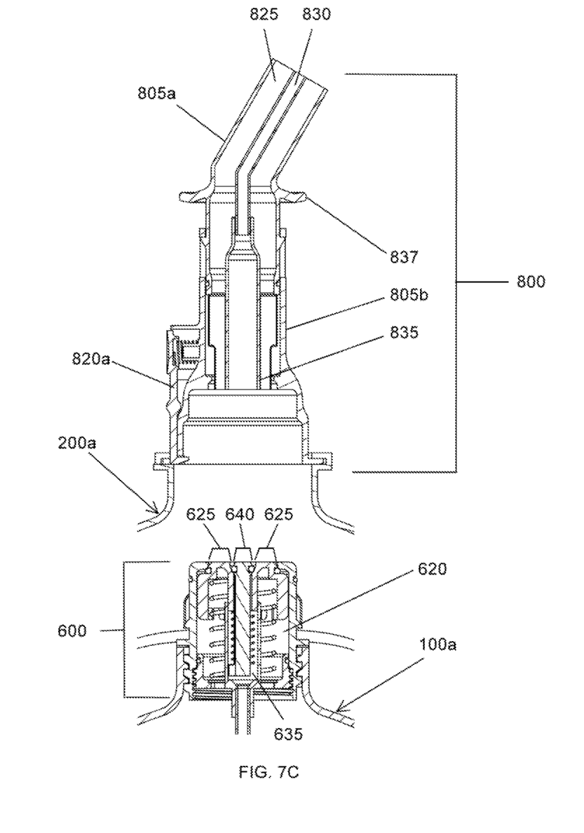

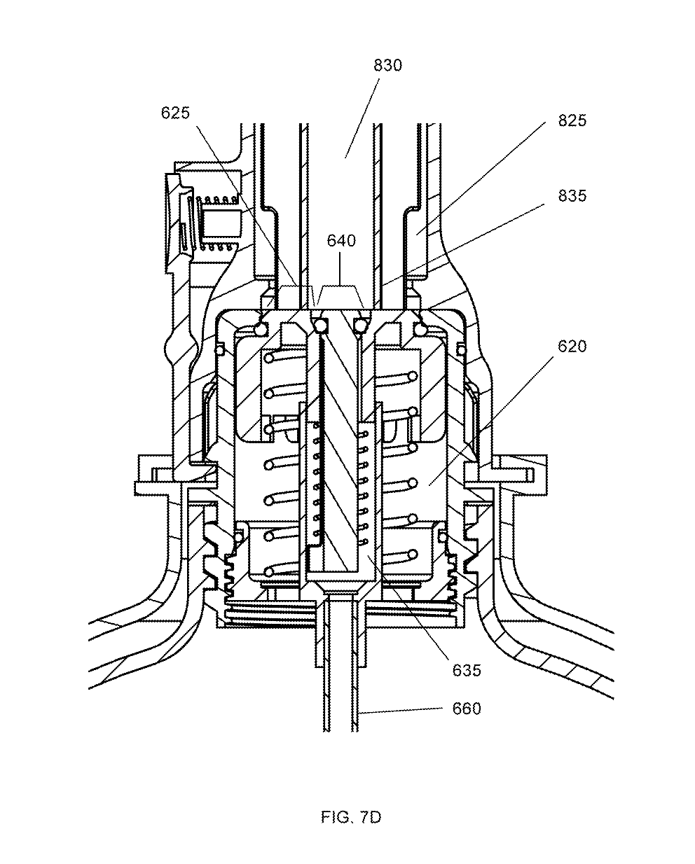

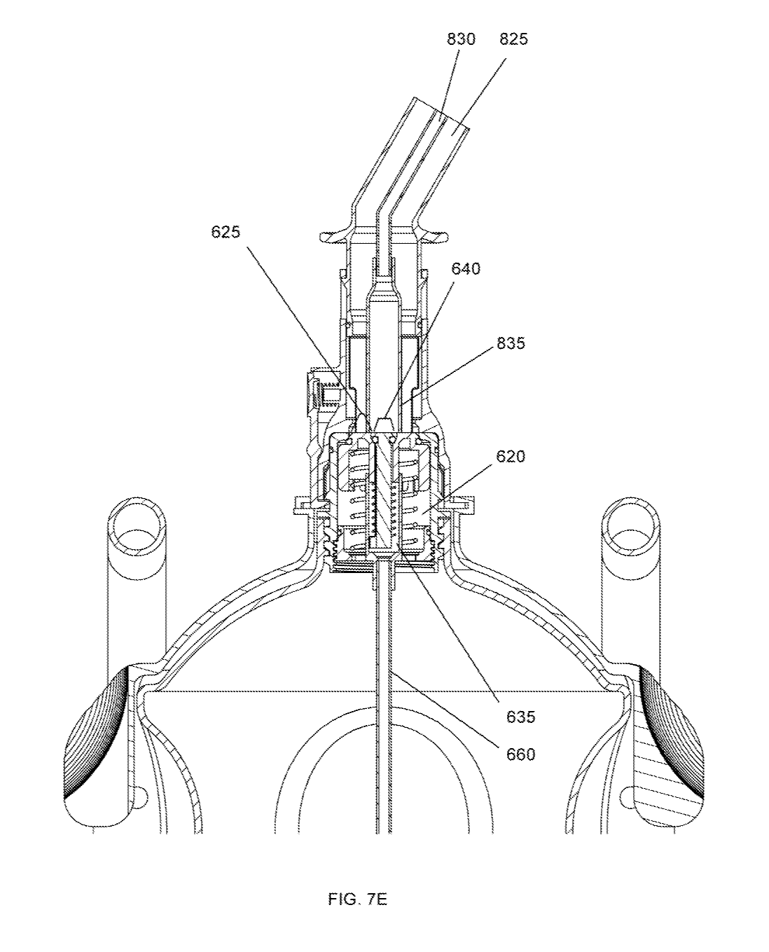

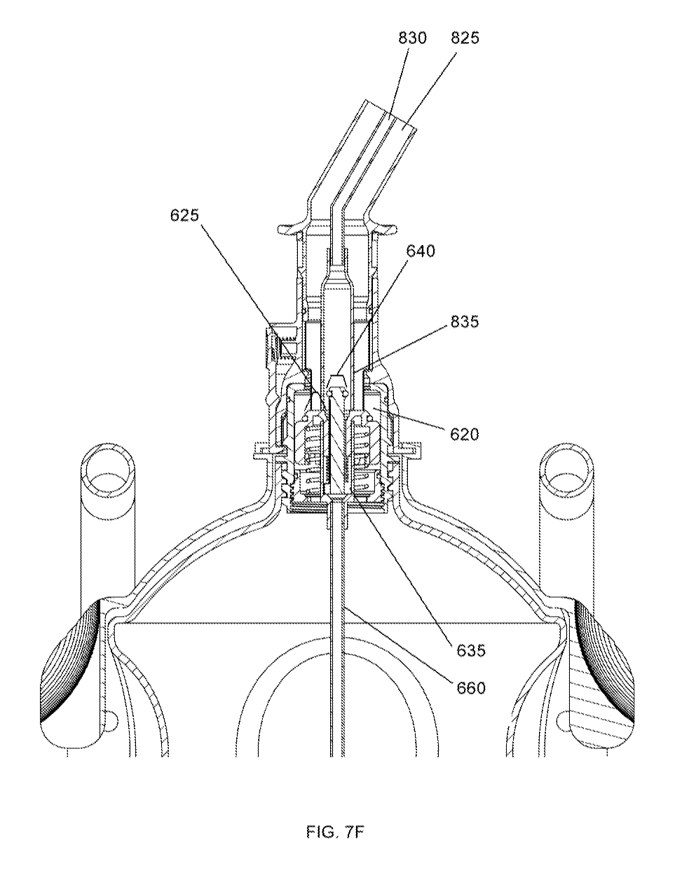

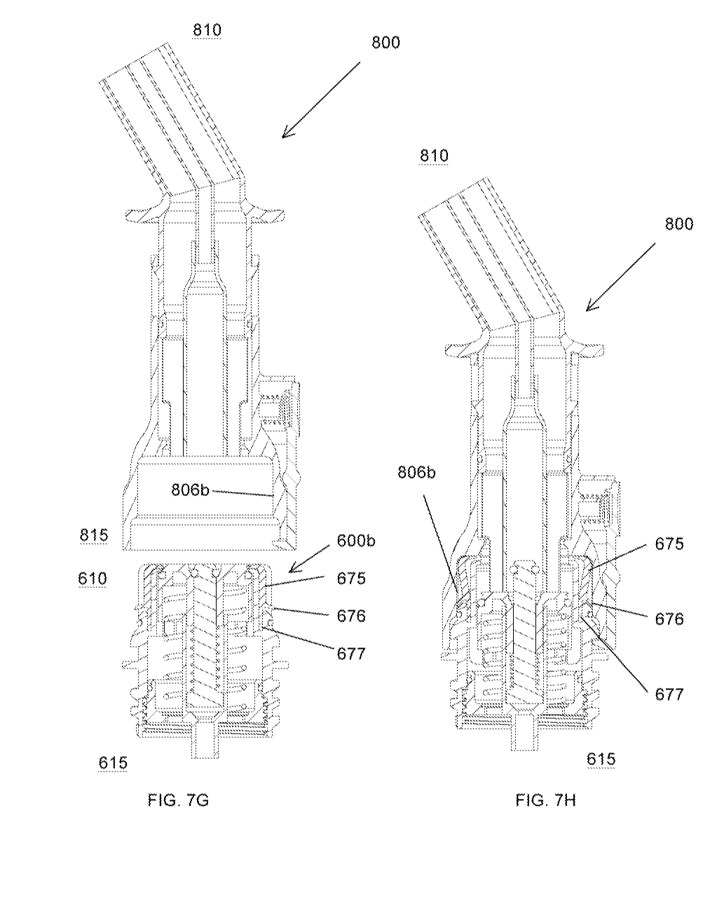

In some examples, the dispenser 300 may cooperate with a dual-passage dry-break connection of the cover 600, 600b on the container 100a, 100b, 100c. FIGS. 6 and 7A-7F show an example dispenser 800, which is an example of a conveying attachment or dispensing device, in the form of an unvalved dispensing spout, which may be provided on the enclosure 200a, 200b and may cooperate with a dual-passage dry-break connection of the cover 600, 600b, to enable opening of the valves 625, 640 of the cover 600, 600b.

The dispenser 800 may include a body 805 defining a receiving end 810 (which may additionally or alternatively be an attachment end) for receiving fluid from a fluid source and a dispensing end 815 (which may additionally or alternatively be a distal and/or conveying end) (e.g., in the form of a spout) for dispensing fluid from the dispenser 800 (and optionally recovering vapor into the dispenser 800). A connector 820a with one or more features (e.g., grooves, threads, protrusions, latch or snap-fittings) may be provided at or near the receiving end 810 for attaching the body 805 to the container 100a, 100b, 100c. In the example shown, the connector 820a may be in the form of a snap, push button latch or clip. The connector 820a may be released, for example by depressing or otherwise actuating a portion of the connector 820a to release the snap, latch or clip. For example, the dispenser 800 may be mounted at or near its receiving end 810 on the cover 600, 600b of the container 100a, 100b, 100c, in order to dispense fluid from the container 100a, 100b, 100c. The receiving end 810 may be configured to cooperate with the seal 606 of the connection end 610 of the cover 600, 600b. The receiving end 810 may include one or more annular flanges 806b configured to cooperate with o-ring 606 to provide an air tight leak-proof seal (e.g., closed system) between the connection end 610 and a dispenser (e.g., dispensing device, described further below).

In some examples, the body 805 may include at least two telescoping portions (in this example, two telescoping portions 805a, 805b) to enable telescoping motion W and X of the telescoping portions 805a, 805b relative to each other, for example to shorten the body 805.

FIGS. 7C-7F illustrate an example of how the dispenser 800 may mate with the cover 600, 600b, to enable opening of the cover 600, 600b.

A first fluid passage 825, which may have a fluid inlet and a fluid outlet, may be defined in the body 805 of the dispenser 800 permitting fluid flow through the body 805. The first fluid passage 825 may permit fluid to flow to the distal end 815, for example by enabling fluid communication between at least the receiving end 810 and the distal end 815. A second fluid passage 830, which may have a fluid inlet and a fluid outlet, may be defined in the body 805 permitting fluid flow through the body 805. The second fluid passage 830 may permit fluid to flow to the receiving end 810, for example by enabling fluid communication between at least the distal end 815 and the receiving end 810.

Although the fluid passages 825, 830 have been described as enabling fluid communication between the receiving end 810 and the distal end 815, it should be understood that in operation fluid may not necessarily flow the entire distance between the distal end 815 and the receiving end 810.

There may be at least one valve engaging portion 835 (e.g., one or more projections) housed in the body 805, for example in the first fluid passage 825. The valve engaging portion 835 may cooperate with a valve surface to cause opening of a valve. When mated with the cover 600, 600b, the valve engaging portion 835 may cooperate with one of the valves 625, 640 such that motion of the valve engaging portion 835 relative to the cover 600, 600b causes unseating of the valve 625, 640 and allows fluid to flow through the cover 600, 600b.

For example, the valve engaging portion 835 may contact or abut against the surface of the first valve 625 of the cover 600, 600b when the enclosure 200a, 200b is attached to the container 100a, 100b, 100c. A force applied on the valve engaging portion 835 may move the valve engaging portion 835 relative to the cover 600, 600b, pushing the first valve 625 towards the attachment end 615 of the cover 600, 600b, thereby opening the first valve 625 and the second valve 640.

In the example shown, shortening of the body 805 by motion of the telescoping portions 805a, 805b towards each other may bring the valve engaging portion 835 towards the receiving end 810. Since the valve engaging portion 835 may contact or abut the first valve 625, the first valve 625 may be thus moved to its opened position.

Although in the example shown the valve engaging portion 835 opens the first valve 625 by motion of the telescoping portions 805a, 805b that shortens the body 805, other types of motion may be used. For example, the body 805 and the connector 820a may have a telescoping motion relative to each other, such that the connector 820a is fixed relative to the cover 600, 600b and the body 805 slides relative to the cover 600, 600b to cause the valve engaging portion 835 to push against and open the first valve 625, as shown in FIG. 7F.

In the example shown, the first fluid passage 825 and the second fluid passage 830 may be generally co-axial. In other examples, the first fluid passage 825 and the second fluid passage 830 may be in tandem, concentric, contained in each other but off-center, or separated from each other, among other configurations. The first and second fluid passages 825, 830 may be configured to correspond to the configuration of fluid passages to which the dispenser 800 is being attached. For example, where the dispenser 800 is intended to mate with the cover 600, 600b, the first and second fluid passages 825, 830 of the dispenser 800 may be configured to match the configuration of the first and second fluid passages 620, 635 of the cover 600, 600b.

The dispenser 800 may be used for two-phase fluid flow, such as for dispensing liquid while recovering vapor (e.g., in fuel dispensing systems having vapor recovery capabilities). For example, the first fluid passage 825 may be configured for liquid fluid flow and the second fluid passage 830 may be configured for vapor fluid flow, or vice versa. In some examples, the fluid may be a volatile fluid (e.g., a liquid fuel).

In some examples, the dispenser 800 may be used to operate valves, as described above, but may itself be free of valves. The absence of valves from the dispenser 800 may simplify manufacturing of the dispenser 800 and may help to reduce the costs and time associated with manufacturing of the dispenser 800.

In some examples, the distal end 815 of the dispenser 800 may include a protrusion, such as an extended surface 837, such that the distal end 815 may complement or mate with the inlet of the fluid destination, in order to help provide a more effective recovery of vapor during the delivery of fluid.

The extended surface 837 may also be used to effect the relative motion of the telescoping portions 805a, 805b. For example, the extended surface 837 may be provided on one telescoping portion 805a closer to the distal end 815 such that, when the distal end 815 is inserted into the inlet of the fluid destination, the extended surface 837 may not fit into the inlet. Pushing the dispenser 800 against the inlet may then cause the other telescoping portion 805b to move relative to the first telescoping portion 805a, thereby causing opening of a valve (e.g., the first and second valves 625, 640 of the cover 600, 600b) and permitting fluid to flow into the fluid destination. This may be useful to ensure that the distal end 815 is inserted into the inlet of the fluid destination before fluid flow occurs, to avoid unintentional spillage, for example. The fluid flow rate through the dispenser 800 may also be controlled by controlling the degree to which the telescoping portions 805a, 805b are moved relative to each other (and in turn the degree to which the valve is opened) by controlling how far the distal end 815 is inserted into the inlet of the fluid destination. This may also avoid the need for the user to directly manipulate the dispenser 800, thereby avoiding or reducing the possibility of contamination of the user's hand and/or the distal end 815.

FIGS. 7G-7H illustrate an example of how the dispenser 800 may mate with the cover 600b, to disable a locking mechanism 675 on the cover 600b. The receiving end 810 may be configured to cooperate with the locking mechanism 675 on the cover 600b. One or more annular flanges 806b may be provided at or near the receiving end 810 on the dispenser 800, (and 800b, 800c, 800d, 800e, 800f, 800g, 800h, 800i, 800j discussed below) and may be configured to cooperate with the actuator 676 of the cover 600b to move the locking mechanism 675 between the engaging and disengaging configurations. FIGS. 7G and 7H show that as the dispenser 800 and the cover 600b come together (e.g., during connection of the dispenser 800 to the cover 600b), the flange 806b (which may have an annular configuration engaging the circumference of the cover 600b or may engage only a portion of the circumference of the cover 600b) comes in contact with and engages (e.g., pushes against) the actuator 676. The locking mechanism 675 may be reconfigured to the disengaged configuration, thus releasing the valve 625 when the flange 806b of the dispenser 800 engages the actuator 676. The locking mechanism 675 may be reconfigured to the engaged configuration (e.g., where the locking mechanism 675 is biased towards the engaged configuration) to re-engage the groove 626 on the valve 625 when the flange 806b of the dispenser 800 disengages the actuator 676 (e.g., when the dispenser 800 is removed from the cover 600b).

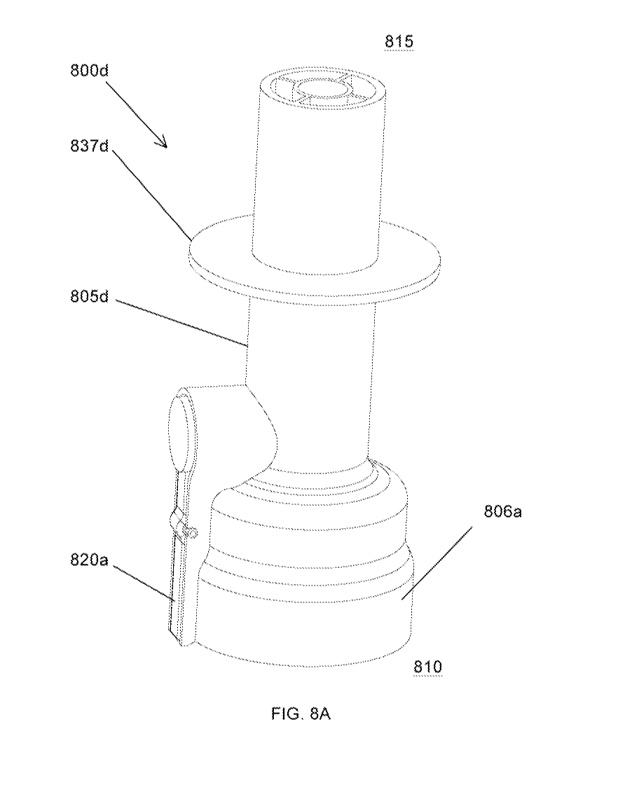

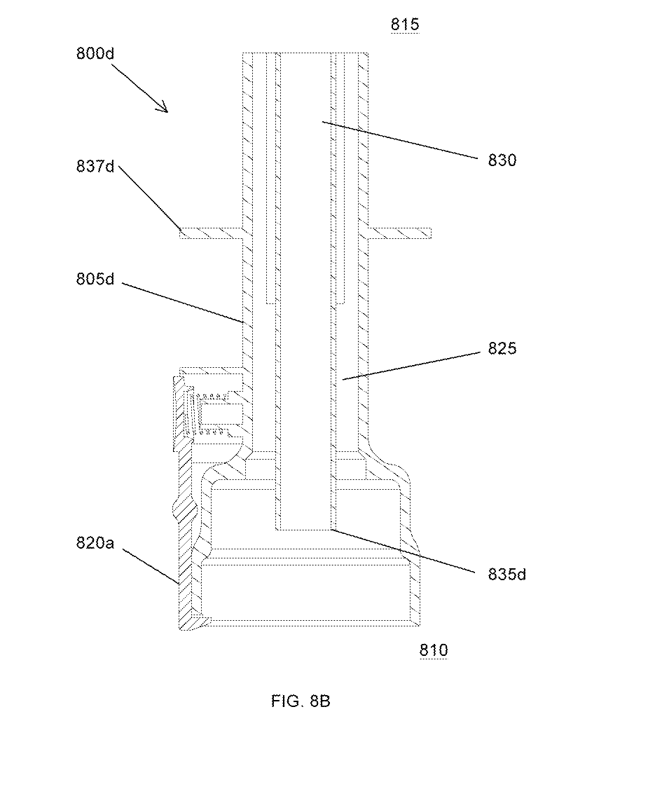

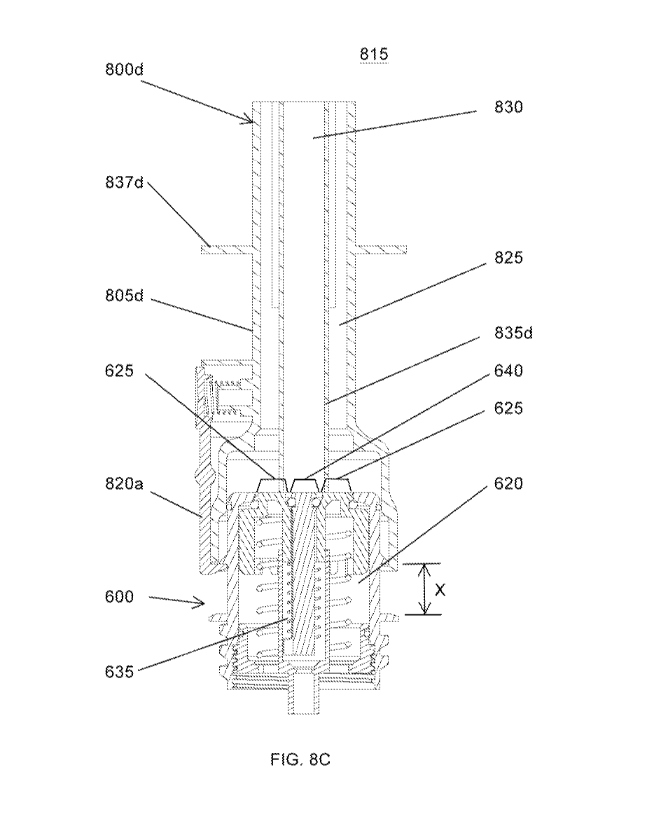

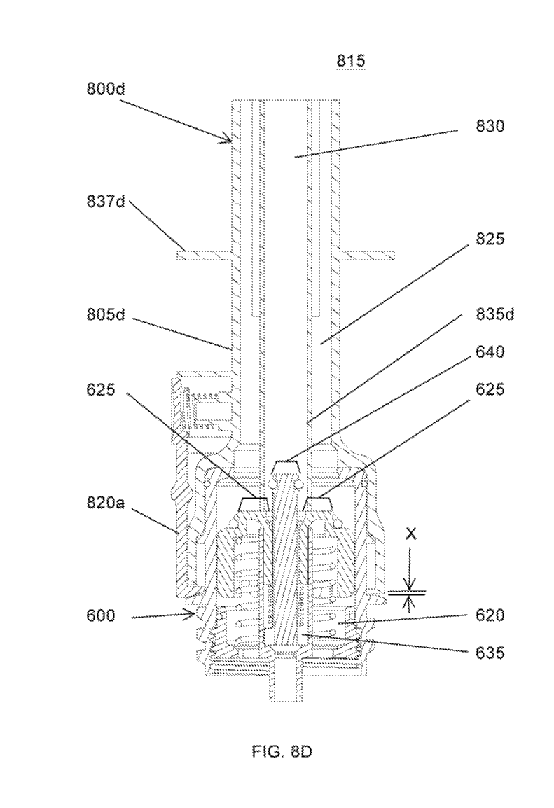

FIGS. 8A-8D show another example dispenser 800d in the form of an unvalved spout, which may be provided on the enclosure 200a, 200b and may cooperate with the cover 120, 600, 600b to enable dispensing of fluid from the container 100a, 100b, 100c. The dispenser 800d may be attachable to the container 100a, 100b, 100c in such a way as to allow the dispenser 800d to swivel and/or slide relative to the container 100a, 100b, 100c. For example, the dispenser 800d may include a connector 820a that may allow the dispenser 800d to swivel and/or slide relative to the cover 120, 600, 600b, and the dispenser 800d may be rotatable on the enclosure 200a, 200b

In this example, the entire dispenser 800d may be slid towards the container 100a, 100b, 100c to open the cover 120, 600, 600b. For example, where the cover 600, 600b is used on the container 100a, 100b, 100c, the dispenser 800d, when the enclosure 200a, 200b is attached to the container 100a, 100b, 100c, may be used to push against and open the valves 625, 640 of the cover 600, 600b. Where the cover 120 is pierceable, frangible or otherwise breakable, the dispenser 800d may push down and pierce or break the cover 120.

In the example shown, the dispenser 800d include elements similar to the dispenser 800 described above. However, the dispenser 800d may not include telescoping portions, but rather have a body 805d that is substantially a single piece. This may allow for easier and/or less expensive manufacturing of the dispenser 800d. The body 805d may define a receiving end 810 for receiving fluid from the container 100a, 100b, 100c and a distal end 815 for dispensing fluid from the dispenser 800d (and optionally recovering vapor into the dispenser 800d).

The dispenser 800d may include first and second fluid passages 825, 830, similar to that described above. The dispenser 800d may also include an extended surface 837d that may facilitate vapor recovery and/or control the depth to which the distal end 815 may be inserted into an inlet of a fluid destination, as described above. The valve engaging portion 835d (which may also be referred to more generally as a cover engaging feature) may be the wall of the second fluid passage 830, a surface within the receiving end 810 or a projection from the wall of the second fluid passage 830, for example, to simplify manufacturing of the dispenser 800d. Where the cover 120 is a pierceable, frangible or otherwise breakable cover that does not include valves, the valve engaging portion 835d may instead be used to pierce or break the cover 120.

As shown in FIGS. 8A-8D, the dispenser 800d may connect to a container 100a, 100b, 100c by a snap or clip connector 820a. Although the connector 820a in this example may be separately molded from the body 805d, in other examples the connector 820a may be integrally molded with the body 805d. The container 100a, 100b, 100c may include a protrusion for snapping on the connector 820a. When attached to the container 100a, 100b, 100c, the valve engaging portion 835d may contact or abut or may be brought to contact or abut the cover 120, 600, 600b. The dispenser 800d may slide along the longitudinal axis of the cover 120, 600, 600b (e.g., when the distal end 815 of the dispenser 800d is inserted into an inlet of a fluid destination and the extended surface 837d is pressed against the outer surface of the fluid destination), thereby opening the cover 120, 600, 600b. For example, in cooperation with the cover 600, 600b, the valve engaging portion 835d may push against the first valve 625, thereby opening the valves 625, 640 of the cover 600, 600b. Thus, rather than telescoping motion between two telescoping portions 805a, 805b, as described above for the dispenser 800, the dispenser 800d may be used to open the valves 625, 640 of the cover 600, 600b by telescoping motion between the dispenser 800d and the cover 600, 600b.

When the distal end 815 of the dispenser 800d is no longer pressed into the inlet of the fluid destination, the release of force may allow the valves 625, 640 to be biased back towards their closed positions, stopping fluid flow and pushing the dispenser 800d away from the cover 600, 600b.

Although the valve engaging portion 835d is shown as being a portion of the wall of the second fluid passage 830, the valve engaging portion 835d may be any suitable configuration including, for example, extensions from the wall of the first fluid passage 825 or flanges extending from the wall of the second fluid passage 830, among others.

Although the dispenser 800d is shown as having the valve engaging portion 835d contacting or abutting the closed first valve 625 when the dispenser 800d is mated with the cover 600, 600b, in some examples the valve engaging portion 835d may be configured such that when the dispenser 800d is mated with the cover 600, 600b, the valve engaging portion 835d already pushes against and opens the first valve 625, without having to further slide the dispenser 800d towards the cover 600, 600b. In such a configuration, the valves 625, 640 of the cover 600, 600b may be opened whenever the dispenser 800d is mated to the cover 600, 600b (e.g., whenever the enclosure 200a, 200b is attached to the container 100a, 100b, 100c) and the valves 625, 640 may be closed when the dispenser 800d is removed from the cover 600, 600b (e.g., when the container 100a, 100b, 100c is removed from the enclosure 200a, 200b). In such a configuration, the dispenser 800d may include one or more valves for controlling fluid flow, for example as described elsewhere in the present disclosure.

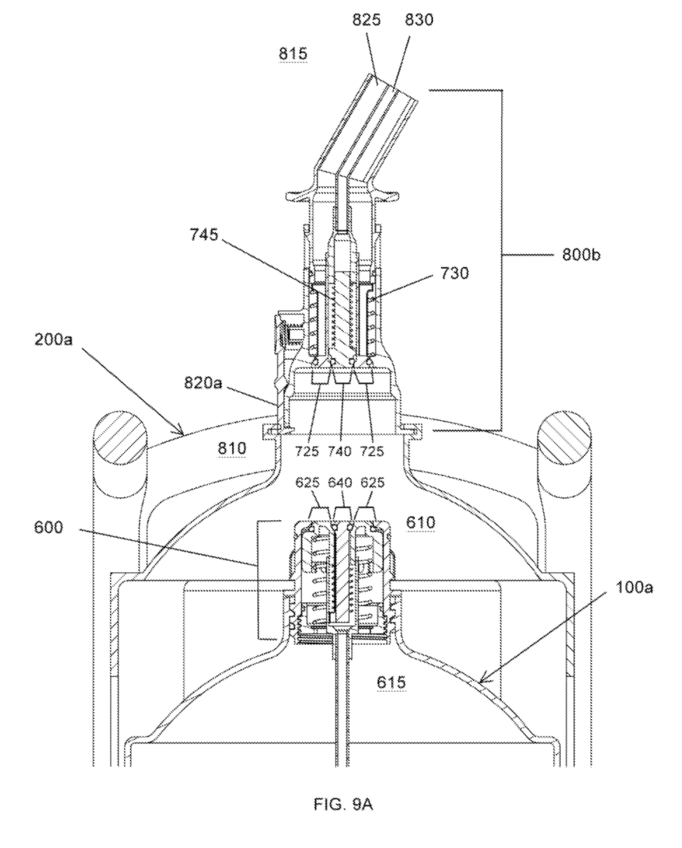

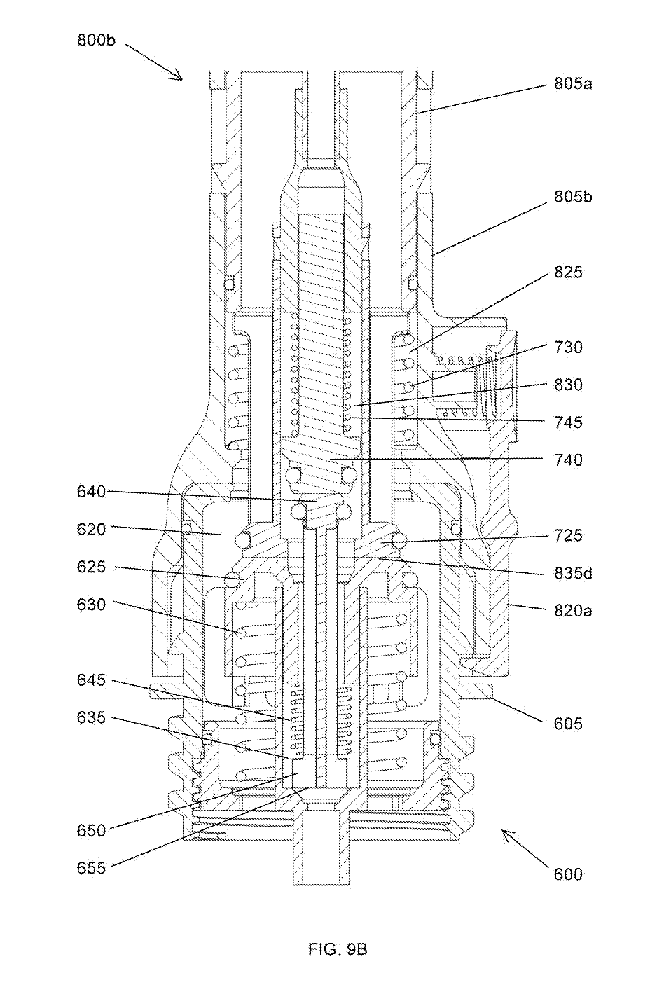

FIGS. 9A-9B show an example of a dispenser 800b having a valve positioned near the connection end 810 of the dispenser 800b. The valve may prevent and/or reduce spillage and/or dripping when removing the dispenser 800b from the container 100a, 100b, 100c (e.g., when removing the container 100a, 100b, 100c out from the enclosure 200a, 200b).

The dispenser 800b may include features similar to dispenser 800. The dispenser 800b may additionally include first and second valves 725, 740 in the first and second fluid passages 825, 830, respectively, for permitting or inhibiting fluid flow through the first and second fluid passages 825, 830.

A first fluid passage 825 may be defined within the dispenser 800b for permitting fluid flow through the dispenser 800b. The first fluid passage 825 may permit fluid to flow from the connection end 810, for example by enabling fluid communication at least between the connection end 810 and the dispensing end 815. A first valve 725 may be provided (e.g., in the first fluid passage 825) for controlling or mediating flow of fluid through the first fluid passage 825. The first valve 725 may be sealed with a sealing member, such as an o-ring or any other suitable sealing member. The first valve 725 may be biased (e.g., by a biasing member, such as a coil spring 730) towards the dispensing end 815 to define a closed position (or valve closed configuration) for the first valve 725 in which fluid flow through the first fluid passage 825 is inhibited.

A second fluid passage 830 may be defined within the dispenser 800b for permitting fluid flow through the dispenser 800b. The second fluid passage 830 may permit fluid to flow to the connection end 810, for example by enabling fluid communication at least between the dispensing end 815 and the connection end 810. A second valve 740 may be provided (e.g., in the second fluid passage 830) for controlling or mediating flow of fluid through the second fluid passage 830. The second valve 740 may be sealed with a sealing member, such as an o-ring or any other suitable sealing member. The second valve 740 may be biased (e.g., by another biasing member, such as another coil spring 745) towards the connection end 810 to define a closed position (or valve closed configuration) of the second valve 740 in which fluid flow through the second fluid passage 830 is inhibited.

Although the fluid passages 825, 830 have been described as enabling fluid communication between the connection end 810 and the dispensing end 815, it should be understood that in operation fluid may not necessarily travel the full distance between the connection end 810 and the dispensing end 815.

The first and second valves 725, 740 may be independently biased towards their respective closed positions, similarly to the first and second valves 625, 640 of the cover 600, 600b, with similar advantages.

In the example shown, the first and second valves 725, 740 are positioned near the connection end 810. This may allow the valves 725, 740 to form a substantially planar surface for the dispenser 800b when in their respective closed positions, to help reduce the amount of liquid that might remain when the dry-break connection is separated.

To permit fluid flow through the dispenser 800b, the first valve 725 and the second valve 740 may be moved at least partially from their respective closed positions to respective opened positions (or valve opened configurations) by moving the first valve 725 towards the connection end 810. The motion of the first valve 725 may cause the second valve 740 to become unseated.

In the example described herein, the second valve 740 may be carried along with the first valve 725 but the second valve 740 may not open unless the second valve 740 is coupled with a complementary configuration in the cover 600, 600b. When thus coupled, the second valve 740 of the dispenser 800b may be carried along by motion of the first valve 725 towards the connection end 810 before the second valve 740 contacts the second valve 640 of the cover 600, 600b and is prevented from moving with the first valve 725, thereby moving the second valve 740 to its opened position (or valve opened configuration).

The interconnected motion of the first and second valves 725, 740 may result from a single motion of the first valve 725 towards the connection end 810. For example, motion of the first valve 725 toward the connection end 810 may simultaneously, nearly simultaneously or with some slight delay may also unseat the second valve 740 thereby moving the second valve 740 to its opened position (e.g., in cooperation with the cover 600, 600b). This may be the case, for example, where the second valve 740 is seated against the first valve 725 when both valves 725, 740 are in their respective closed positions, as shown in FIG. 9A. In the example shown, the second valve 740 may not be immediately unseated when the first valve 725 starts its motion towards the connection end 810. The second valve 740 may be carried along by the first valve 725 towards the connection end 810 for a short period, until the second valve 740 contacts or abuts against the other half of the dry-break disconnect (e.g., the connection surface of the cover 600, 600b) and is unseated from the first valve 725.

In some examples, the dispenser 800b may include at least two telescoping portions 805a, 805b. Relative motion of the telescoping portions 805a, 805b (e.g., to thereby shorten the body of the dispenser 800b) may move the first valve 725 towards the connection end 810 to open the first valve 725. In some examples, the second valve 740 may be moveable towards the dispensing end 815, independently of any motion of the first valve 725, to open the second valve 740.

In the example shown, the first fluid passage 825 and the second fluid passage 830 may be generally co-axial. In other examples, the first fluid passage 825 and the second fluid passage 830 may be in tandem, concentric, contained in each other but off-center, or separated from each other, among other configurations. The first and second fluid passages 825, 830 may be configured to correspond to the configuration of fluid passages in the cover 600, 600b to which the dispenser 800b is being connected. For example, where the dispenser 800b is intended to mate with the cover 600, 600b, the first and second fluid passages 825, 830 of the dispenser 800b may be configured to match the configuration of the first and second fluid passages 620, 635 of the cover 600, 600b.

The disclosed dispenser 800b may be used for mediating two-phase fluid flow. For example, the first fluid passage 825 may be configured for liquid fluid flow and the second fluid passage 830 may be configured for vapor fluid flow, or vice versa. In some examples, the fluid may be a volatile fluid (e.g., a fluid fuel). Thus, the dispenser 800b may provide a two-phase fluid connection, such as for fuel dispensing systems having vapor recovery capabilities.

The cover 600, 600b and the dispenser 800b may be configured to mate with each other at their respective connection ends 610, 810 to form a dry-break connection.

When the cover 600, 600b and the dispenser 800b are connected in this manner, the first valve 625 of the cover 600, 600b may contact or abut the first valve 725 of the dispenser 800b and the second valve 640 of the cover 600, 600b may contact or abut the second valve 740 of the dispenser 800b. The contacting surfaces of the valves 625, 640, 725, 740 may complement each other (e.g., the contacting surfaces may all be substantially planar).

By moving the first valve 725 of the dispenser 800b towards the connection end 810 of the dispenser 800b (e.g., by bringing the telescoping portions 805a, 805b of the dispenser 800b towards each other), the first valve 625 of the cover 600, 600b may be moved towards the attachment end 615 of the cover 600, 600b, thereby opening the respective first and second valves 625, 640, 725, 740 of the cover 600, 600b and the dispenser 800b and permitting fluid flow between the cover 600, 600b and the dispenser 800b. In this instance the substantially planar surface of first valve 725 shown in FIG. 9B of the dispenser 800b may function as the valve engaging portion 835d described above.

When the telescoping portions 805a, 805b are moved relative to each other (e.g., towards each other), the first valve 725 of the dispenser 800b may be brought towards the connection end 810 of the dispenser 800b. Because the first valve 725 of the dispenser 800b may contact or abut against the first valve 625 of the cover 600, 600b, this motion also may cause the first valve 625 of the cover 600, 600b to move towards the attachment end 615 of the cover 600, 600b. This may cause the second valve 640 of the cover 600, 600b to become unseated when the post 650 of the second valve 640 is stopped by the stop 655. Because the second valve 640 of the cover 600, 600b may contact or abut the second valve 740 of the dispenser 800b, the second valve 740 of the dispenser 800b may also be unseated.

The first and second fluid passages 620, 635 of the cover 600, 600b may be configured to match the position of the respective first and second fluid passages 825, 830 of the dispenser 800b when the cover 600, 600b and the dispenser 800b are mated. Thus, fluid may flow between the first fluid passages 620, 825 of the cover 600, 600b and the dispenser 800b and also between the second fluid passages 635, 830 of the cover 600, 600b and the dispenser 800b.

FIGS. 10A and 10B show an example of a dispenser 800c having one or more valves positioned near the dispensing end 815 as well as near the connection end 810 of the dispenser 800c. Such a configuration may offer additional control and/or safety features. For example, the valve(s) may prevent and/or reduce dripping and/or draining from the tip of the dispenser 800c at the end of dispensing of fluid to a fluid destination and/or when moving between consecutive filling operations.

In the example shown, the dispenser 800c may include a safety mechanism, such as a catch, safety hook or a safety trigger 325a, to avoid and/or reduce unintentional dispensing of fluid from the assembly. For example, a valve 335 in the first fluid passage 825 and/or a valve 340 in the second fluid passage 830 of the dispenser 800c may be opened only when the safety trigger 325a is engaged, such as by engaging the safety trigger 325a with an inlet of a receiving container when the dispenser 800c is inserted into the inlet of the receiving container. In some examples, engaging the safety trigger 325a may open one or both of the valves 335, 340. In some examples, engaging the safety trigger 325a may enable one or both of the valves 335, 340 to be opened by a further trigger, for example a remote trigger (described further below).

The safety trigger 325a may be biased towards the dispensing end 815, of the dispenser 800c in its unactuated position and may be actuated away from the dispensing end 815 (e.g., when the dispenser 800c is inserted into the inlet of the fluid destination, the safety trigger 325a may be actuated by pressing against the outer surface of the fluid destination).

The safety trigger 325a in FIGS. 10A and 10B is shown in the unactuated position, biased towards the dispensing end 815 of the dispenser 800c (e.g., by a biasing member, such as a compression spring 330). The safety trigger 325a may be coupled to one or more valves 335, 340 of the dispenser 800c that may be moveable to facilitate or inhibit flow of fluid through the dispenser 800c. In the example shown, there are two valves 335, 340 each mediating fluid flow through a respective fluid conduit of the dispenser 800c, for example to mediate liquid delivery and vapor recovery through the dispenser 800c. When the safety trigger 325a is in its unactuated position, the valve(s) 335, 340 may be closed, to inhibit fluid flow through the dispenser 800c. When the safety trigger 325a is in its actuated position, the valve(s) 335, 340 may be opened, to allow fluid flow through the dispenser 800c.

The safety trigger 325a may also provide a depth-inhibiting feature. For example, the safety trigger 325a may be moved a fixed amount between its unactuated position to its actuated position, thereby limiting the depth to which the dispenser 800c may be inserted into the inlet of the fluid destination.

FIG. 11 illustrates an example trigger 240a that may be provided on the enclosure 200a, 200b. The trigger 240a may be used to control dispensing of fluid from the container and enclosure assembly. For example, the trigger 240a may be operated to open one or more valves 725, 740, 335, 340 of the dispenser 800b, 800c to enable dispensing of fluid from the dispenser 800b, 800c.

The trigger 240a may enable the valve(s) of the dispenser 800b, 800c to be remotely controllable (e.g., controlled by operation of a mechanism located remotely from the dispenser 800b, 800c, for example near the base of the enclosure 200a, 200b). This may prevent unintentional fluid flow through the dispenser 800b, 800c, for example when the trigger 240a is actuated and the dispenser 800b, 800c is not properly inserted into the inlet of the fluid destination. Similarly, the safety trigger 325a may cause fluid flow to be stopped when the dispenser 800c is removed from the inlet of the fluid destination, even if the trigger 240a remains actuated, to avoid fluid loss.

The trigger 240a may control a valve in the dispenser 800b, 800c via, for example, a cable 845 that may run up the side of the enclosure 200a, 200b (e.g., via a cable guide) from the trigger 240a to an openable and closable valve of the dispenser 800b, 800c via a channel, or any other suitable mechanism. In some examples, the trigger 240a may be located near a base of the enclosure 200a, 200b, for example adjacent the bottom end or at the base portion of the enclosure 200a, 200b. Such a location may be easily accessible by a user's hand when a user upturns the container and enclosure assembly to dispenser fluid from the container 100a, 100b, 100c. The use of the remotely located trigger 240a may simplify the control of fluid flow (e.g., start of fluid flow, stop of fluid flow and/or flow rate) when dispensing fluid from the assembly, and may prevent unintentional spilling of fluid when dispensing fluid from the assembly. The trigger 240a may alternatively be located at any other suitable location on the enclosure 200a, 200b (e.g., top, side or bottom). In some examples, there may be more than one trigger 240a provided, which may be useful in providing control of fluid flow from more than one hand position. For example, there may be one trigger 240a located near the base of the enclosure 200a, 200b (e.g., adjacent the bottom end) and a second trigger 240a located near the top of the enclosure 200a, 200b.

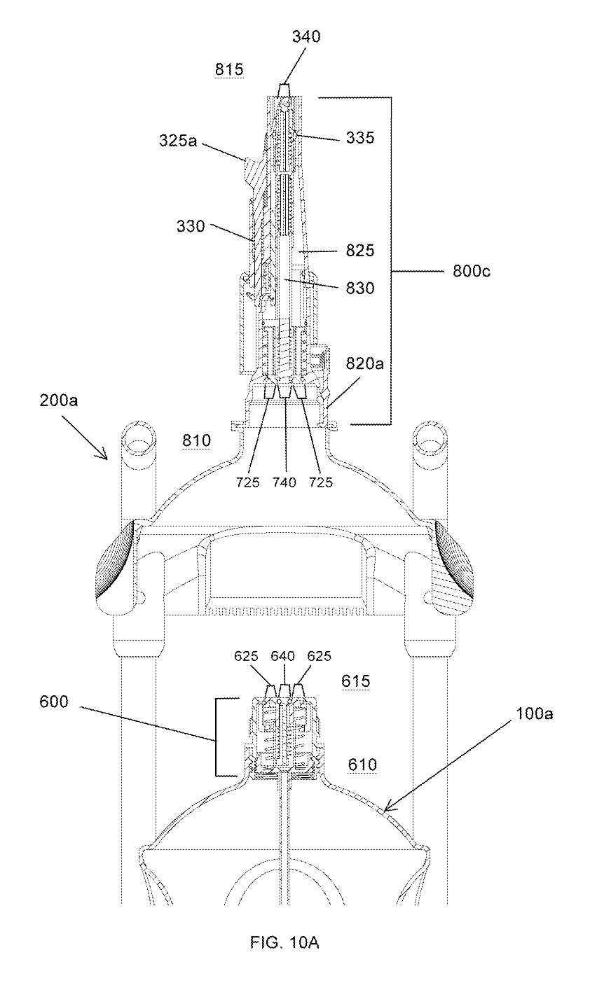

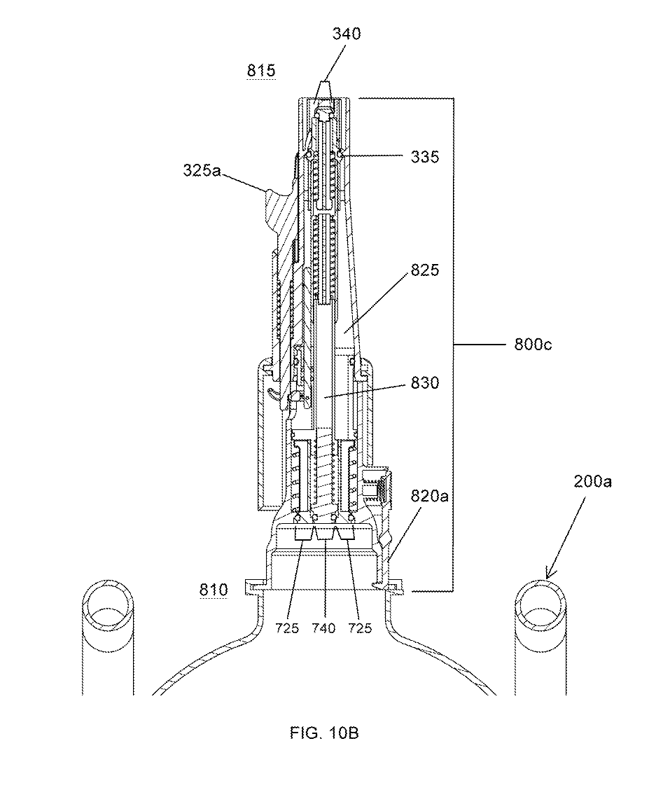

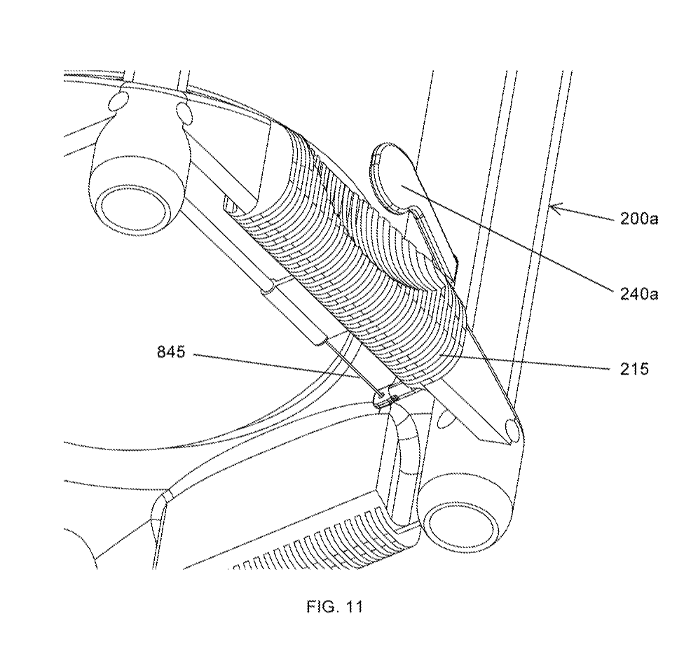

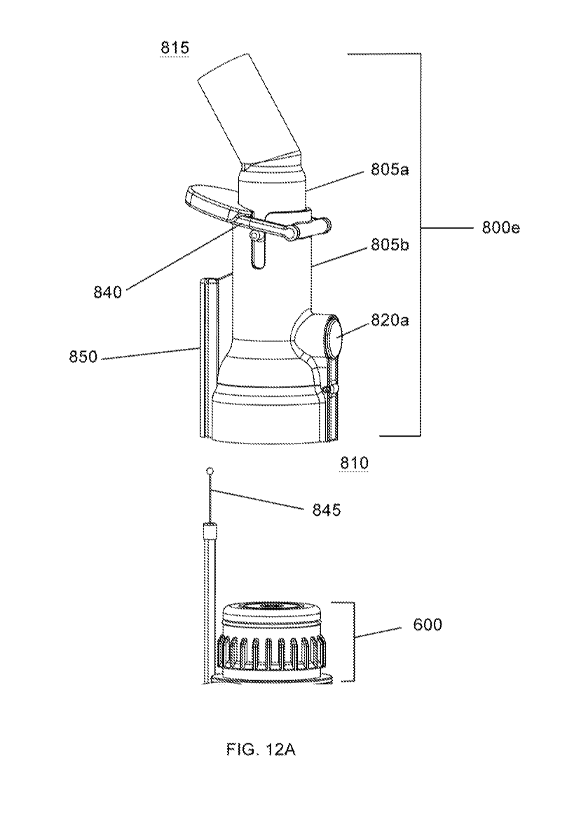

FIGS. 12A-12C illustrate another example dispenser 800e. The dispenser 800e may include features similar to the dispenser 800, 800b, 800c, 800d described above. The one or more valves (not shown) of the dispenser 800e may be controllable using the trigger 240a, to permit or inhibit fluid flow through the dispenser 800e. The dispenser 800b may include telescoping portions 805a, 805b relative to each other. The dispenser 800e may include a lever mechanism 840 for moving the telescoping portion 805a relative to the telescoping portion 805b. The lever mechanism 840 may be connected by a cable 845 that may run through a channel 850 defined in the body 805. The cable 845 may couple the lever mechanism 840 to the remote trigger 240a such that actuation of the remote trigger 240a causes the cable 845 to pull the lever mechanism 840, which in turn moves the telescoping portion 805a relative to the telescoping portion 805b, as shown in FIGS. 12B and 12C. Similarly to the dispenser 800 described above, this motion of the telescoping portions 805a, 805b relative to each other may cause the dispenser 800e to open a valve and allow fluid flow through the dispenser 800e.

The telescoping portions 805a, 805b may be biased away from each other (e.g., by a biasing member, such as a compression spring), such that when the cable 845 is released (e.g., by releasing the remote trigger 240a) and the lever mechanism 840 is released and the telescoping portions 805a, 805b are allowed to move away from each other, thereby stopping closing the valve and stopping fluid flow.

Thus, the dispenser 800e may allow actuation of a remote trigger 240a located remotely from the dispenser 800e to cause the dispenser 800e to open a valve and enable fluid flow, as described above. This remote actuation of the dispenser 800e may allow for control of fluid flow through the dispenser 800e in a manner that is not dependent on direct manipulation of the dispenser 800e by a user. This may avoid or reduce the possibility of contamination of the user's hand and/or the distal end 815, and may also allow for more ergonomic control of fluid flow. This may also allow for stopping fluid flow through the dispenser 800e without having to remove the distal end 815 from the inlet of the fluid destination. The fluid flow rate may also be controlled by controlling the degree to which the telescoping portions 805a, 805b are moved relative to each other (and in turn the degree to which the valve is opened) by controlling the degree of actuation of the cable 840 (e.g., using the remote trigger 240a).

FIGS. 13A-13C illustrate an example dispenser 800f having a safety feature for remote actuation. Similarly to the dispenser 800e described above, the telescoping portions 805a, 805b may be moved relative to each other remotely through actuation by the cable 845. The dispenser 800f may further include features to prevent movement of the telescoping portions 805a, 805b using the cable 845 when the distal end 815 of the dispenser 800f is not fully inserted into an inlet of a fluid destination. This may help prevent unintentional fluid flow through the dispenser 800f.

The dispenser 800f may include a protrusion 837f, such as an extended surface, extending from at least a portion of the outer surface of the body 805 near the distal end 815. The protrusion 837f may be configured to contact or abut the outer surface of the fluid destination when the distal end 815 is fully inserted into an inlet of the fluid destination.

The protrusion 837f may have a disabling position, as shown in FIG. 13B, and an enabling position, as shown in FIG. 13C. In the enabling position, the lever mechanism 840 may push against the protrusion 837f to cause the telescoping portion 805a to move relative to the telescoping 805b. However, the protrusion 837f is free to move between the enabling position and disabling position. This means that unless the protrusion 837f is held in place (e.g., by contacting or abutting the protrusion 837f against the outer surface of the fluid destination), when the lever mechanism 840 is actuated by the cable 845, the protrusion 837f is moved into the disabling position. In the disabling position, the lever mechanism 840 is unable to push against the protrusion 837f to move the telescoping portion 805a.

For example, the dispenser 800f may cooperate with the cover 600, 600b on the container 100a, 100b, 100c. When the protrusion 837f does not contact or abut the fluid destination, fluid may be inhibited from flowing through the dispenser 800f When the cable 845 actuates the lever mechanism 840, the protrusion 837f is moved into the disabling position and the telescoping portions 805a, 805b are not moved relative to each other. There is no fluid flow as a result, since the valves 625, 640 of the cover 600, 600b are not opened.

When the protrusion 837f contacts or abuts the fluid destination, the protrusion 837c becomes held in the enabling position. when the cable 845 is actuated (e.g., by actuation of the remote trigger 240a), the lever mechanism 840 is able to push against the protrusion 837f (which is held in the enabling position) and cause the telescoping portions 805a, 805b to move relative to each other (e.g., towards each other thereby shortening the body 805). This motion opens the valves 625, 640 of the cover 600, 600b, as described above, permitting fluid to flow between the fluid container and the fluid destination. When the cable 845 is released (e.g., by releasing the remote trigger 240a), the telescoping portions 805a, 805b may be allowed to return to their biased apart positions, as described above for the dispenser 800e, thereby stopping fluid flow. Additionally, removing the distal end 815 from the inlet may free the protrusion 837f to move into the disabling position, such that the lever mechanism 840 is unable to push against the protrusion 837f, thereby freeing the telescoping portions 805a, 805b to return to their biased apart positions and resulting in the stop of fluid flow. This may provide a safety feature in which, even if the cable remains actuated, fluid flow is prevented when the distal end 815 is removed from the inlet of the fluid destination.

Any of the dispensers described above may additionally or alternatively be used to effect opening of valves and covers other than the examples described above, including valves of other dry-break connectors, or any other suitable valve configurations, including other quick-disconnect connectors, dry-break connectors, single-valves, dual-valves and valves that are integral to a fluid source/destination, among others.

Although the dispensers have been described as having first and second fluid passages, in other examples the dispensers may have more or less fluid passages. For example, where the dispensers are intended for attaching to a container having a single fluid passage (e.g., a liquid-only container or a container without vapor-recovery features), the dispensers may include only one fluid passage.

In some examples, such as where a trigger is used to control fluid flow through the dispenser, the dispenser may provide an unconventional safety feature. Conventionally, fluid may be made to flow from dispenser spouts simply by inserting the spout into the inlet of a fluid destination, and optionally by applying a force on the spout against an inlet to open a valve in the spout. Dispensing fluid using a conventional non-valved spout may require the single step of inserting the open spout into a fluid destination to being the dispensing of fuel. Although this process may be simple, this may lead to unintentional fluid flow and/or spillage, such as when the container is accidentally tilted or is mishandled when being maneuvered into a filling position (e.g., when the container is full the container may be awkward to handle and such mishandling may occur). Dispensing of fluid using a conventional valved spout which is already in place in the inlet of the fluid destination and ready to use may involve the single step of tilting the container and in the same movement applying a force on the spout to open a valve in the spout. However, this single step process may also lead to unintentional fluid flow, such as where the container is accidentally tilted and/or pushed against some other surface. In some examples, the present disclosure provides a safety feature by involving a two step process for dispensing liquid. In some examples of the disclosed dispenser in addition to tipping the container and inserting the distal end into the inlet of the fluid destination, the trigger may be required to be actuated before fluid flow occurs. Thus, an additional safety step may be required to enable fluid flow. This additional step may help to avoid unintentional fluid flow and may additionally act as a child safety feature.

One or more features described in one embodiment of the dispenser may be combined with one or more features described in another embodiment. The valves described for the container/cover and the dispenser may be a single-valve mechanism (e.g., for fluid-only dispensing) or may be a dual-valve mechanism (e.g., for fluid dispensing and vapor recovery).

The enclosure 200a, 200b may include one or more features (e.g., interlocking fingers 215 and/or latch 225) for coupling two or more enclosures 200a, 200b together. The enclosure 200a, 200b may include other features, such as a towing handle or attachable wheels, to facilitate transport of one or more enclosures 200a, 200b (with or without enclosed containers 100a, 100b, 100c).

FIG. 14 illustrates an example of how two or more enclosures 200a, 200b may be fastened together. Two or more enclosures 200a, 200b may be brought together (e.g., side-by-side) by matching up respective mating member(s) 215. In this example, when brought together, the mating member(s) 215 include fingers that interleave with each other, preventing the enclosures 200a, 200b from sliding sideways relative to each other. In some configurations, the mating member(s) 215 may also include features (e.g., a stop bar) that may prevent the enclosures 200a, 200b from sliding vertically relative to each other.

As illustrated in FIGS. 15A-15B, a fastener 225 (e.g., a latch, a hook, a buckle, a snap, clamp or any other suitable fastener) may be provided on at least one of the enclosures 200a, 200b. The fastener 225 may enable the enclosures 200a, 200b to be held together, for example by fastening the respective handles 205 together. The fastener 225, together with the mating member(s) 215, may thus prevent relative motion between the enclosures 200a, 200b, and may enable the enclosures 200a, 200b to be transported as one unit. Any other suitable means of interconnecting two or more enclosures 200a, 200b to each other may be provided.

In some examples, the design of the mating member(s) 215 may be such that most or all of the weight of the enclosures 200a, 200b (with or without enclosed containers 100a, 100b, 100c) is supported by the mating member(s) 215 and the frames 220, such that the fastener 225 may not be required to withstand much force. Such a design may be useful to avoid unintentional unfastening of the fastener 225. In some examples, more than one fastener 225 may be used to help improve joining of the enclosures 200a, 200b.

An enclosure 200a, 200b may be also fitted with an extendable handle (e.g., a telescoping handle) or a longer handle to facilitate towing by a user. As shown in FIG. 16, wheels 230 may be fitted on an enclosure 200a, 200b (e.g., using a connector 235) to facilitate towing of the enclosure 200a, 200b. For example, a frame of the enclosure 200a, 200b may include one or more recesses or holes for fitting wheels 230 (e.g., using a connector 235 that may be locked in place by, for example pressing a button 235b). Such wheels 230 may be relatively easily added or removed, such as by an end consumer. Two or more enclosures 200a, 200b may be fastened together, which may enable two or more enclosures 200a, 200b to be relatively easily transported together in the manner illustrated.

The enclosure and container assembly described above may be used to dispense fluid directly from the container 100a, 100b, 100c into a receiving container. The enclosure and container assembly may also be used with a dispensing system, which may include a pump for pumping fluid from the container. The dispensing system may enable pumping of fluid from the container without requiring fluid to be transferred (e.g., poured) from the container into a pump by the consumer; the pump may instead be in direct fluid communication with the container 100a, 100b, 100c, thus allowing fluid to be transferred into the pump without the risk of contamination and/or spillage.

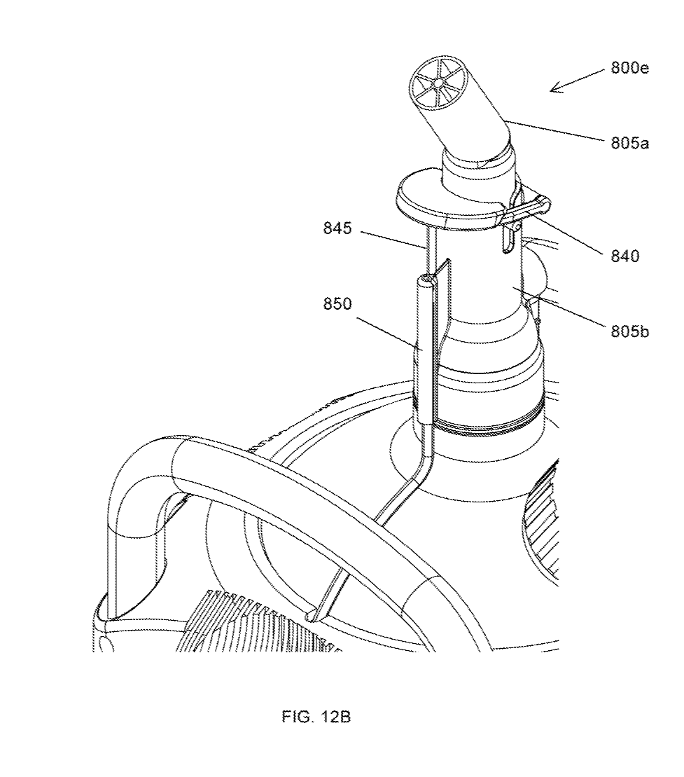

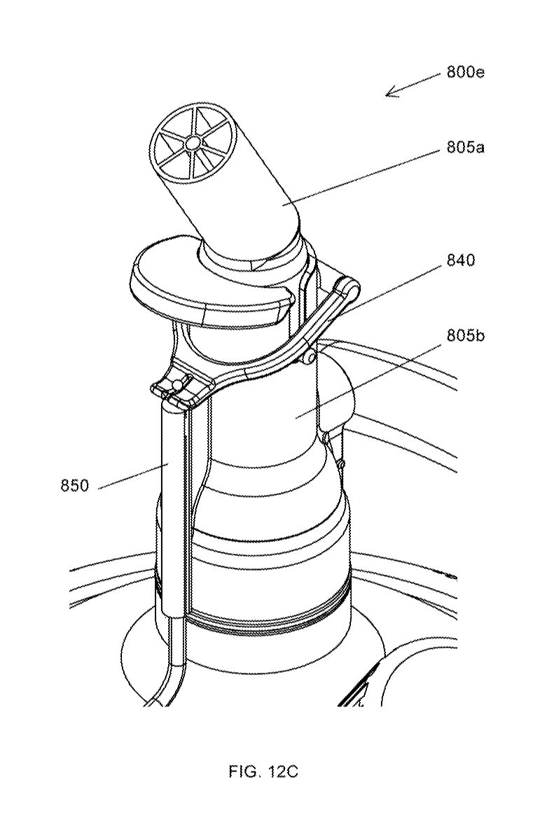

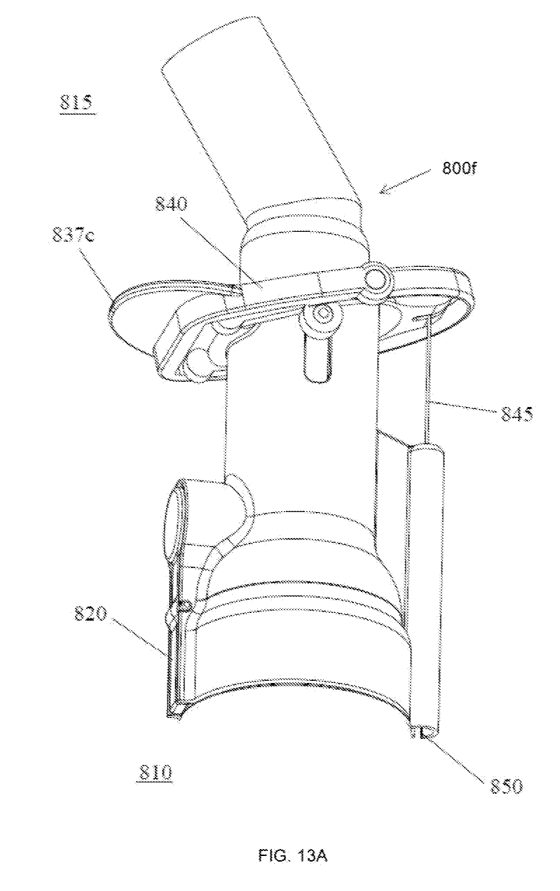

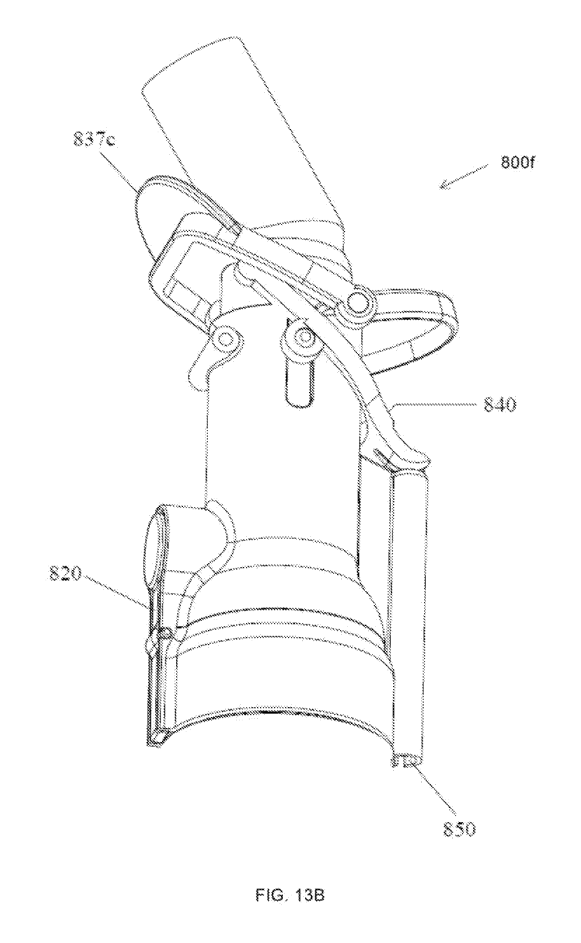

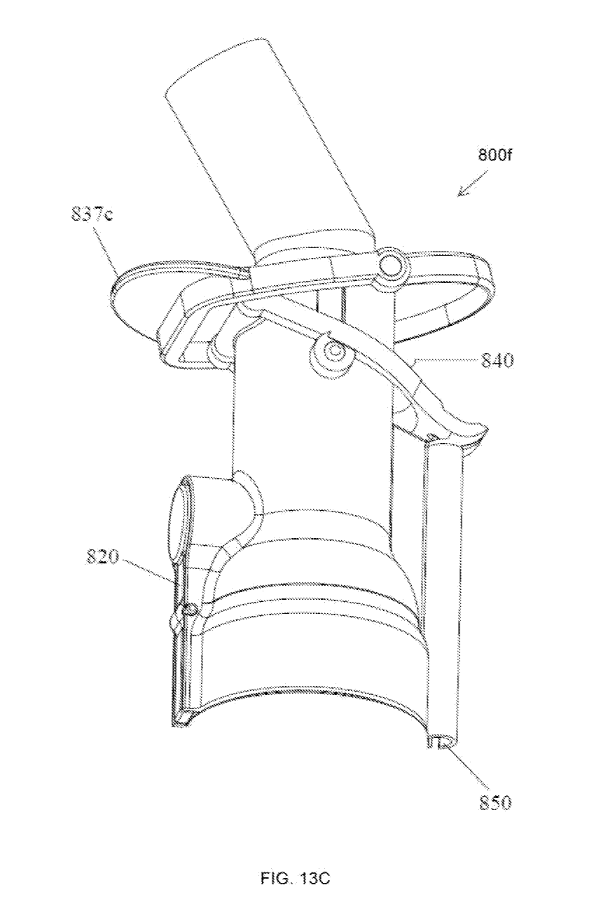

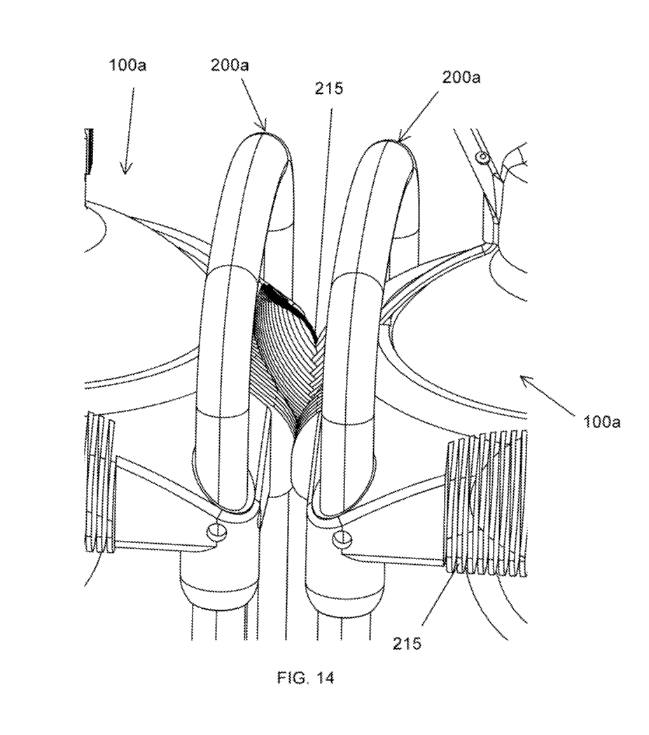

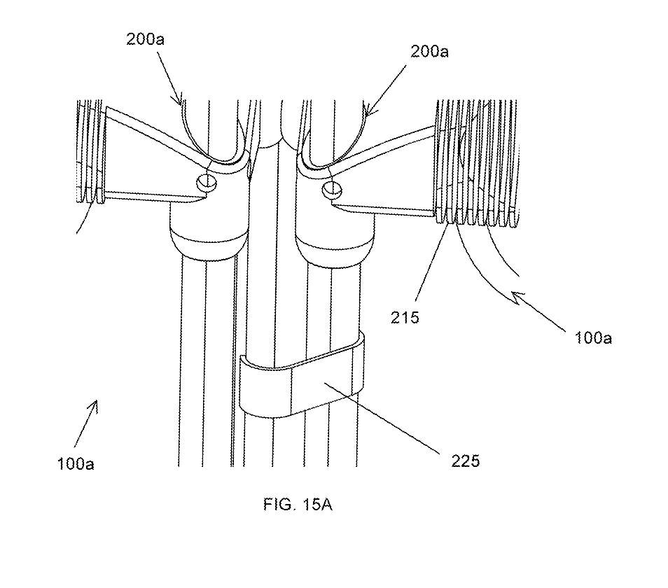

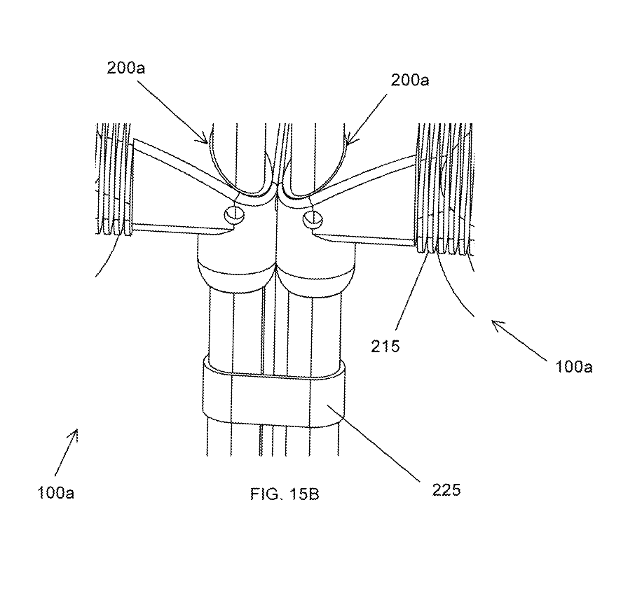

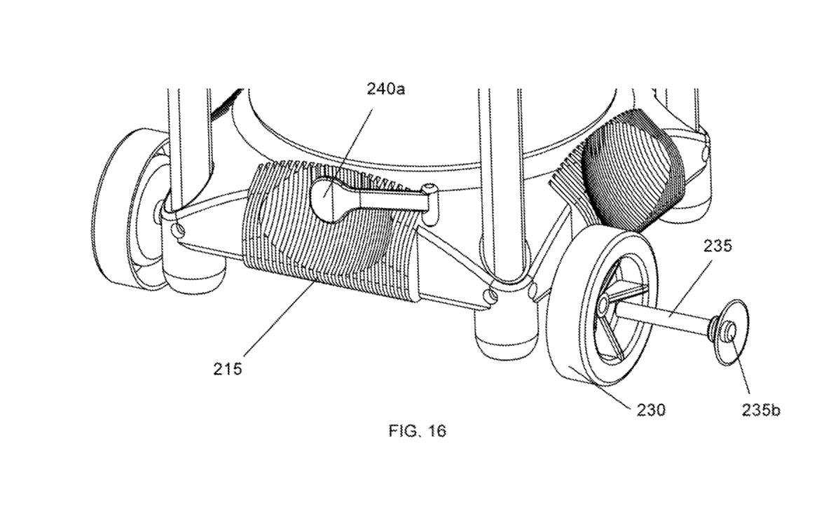

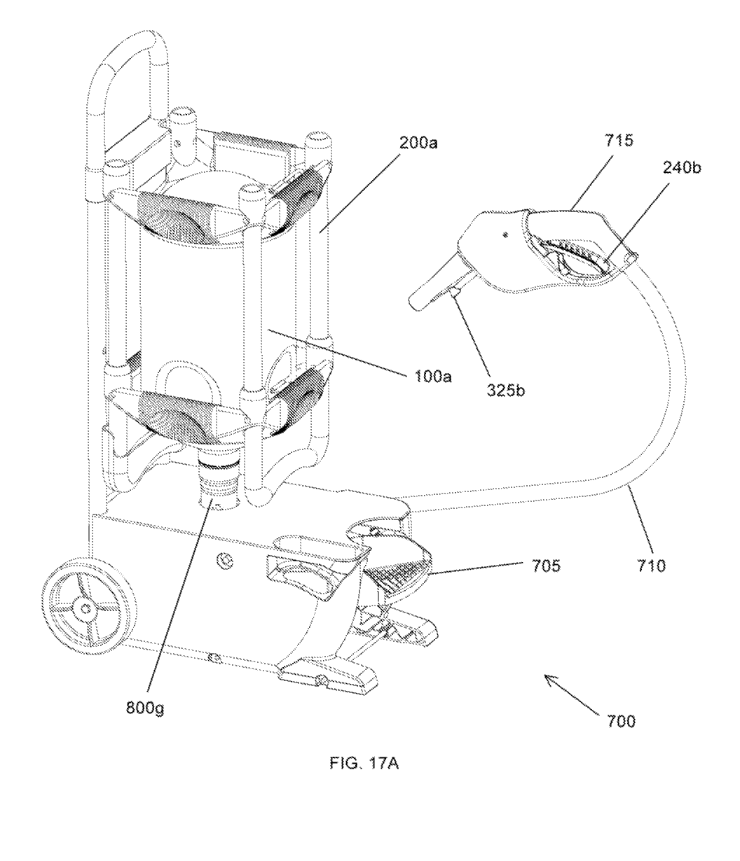

FIG. 17A shows an example dispensing system 700 that may be used with the enclosure and container assembly. In the example shown, the container 100a, 100b, 100c may be inverted when used with the dispensing system 700. The dispensing system 700 may include a fluid inlet, in this example shown in the form of a conveying attachment 800g configured to cooperate with the cover 120, 600, 600b of the container 100a, 100b, 100c (e.g., in a manner similar to that described above with respect to the spout) in order to open the cover 120, 600, 600b and permit fluid to flow from the container 100a, 100b, 100c. Fluid may flow from the container 100a, 100b, 100c, via gravity, into the pump chamber of the pump.

FIG. 17B shows an example dispensing system 700 that may be used with an enclosure and container assembly. In the example shown, the container 100a, 100b, 100c may be oriented upright when used with the dispensing system 700. The dispensing system 700 may include a conveying attachment 800h configured to connect to a fluid hose 710b, which may be a dual line configured to convey both liquid and vapor. The conveying attachment 800h may additionally be configured and cooperate with the cover 120, 600, 600b of the container 100a, 100b, 100c (e.g., in a manner similar to that described above with respect to the spout) in order to open the cover 120, 600, 600b and permit fluid to flow from the container 100a, 100b, 100c. Fluid may flow and or be drawn from the container 100a, 100b, 100c into the pump chamber of the pump.

The dispensing system 700 may also include a fluid conduit 710 and a fluid dispenser 715, such as a hose and nozzle system. The conduit 710 and dispenser 715 may be single-line (e.g., where the dispensing system 700 is for dispensing liquid) or may be dual-line (e.g., where the dispensing system 700 is for dispensing liquid as well as for recovering vapor). The conduit 710 and dispenser 715 may have any suitable configuration, including configurations described in PCT Application Nos. PCT/CA2005/001367 entitled “PUMP AND NOZZLE LIQUID FLOW CONTROL SYSTEM”, PCT/CA2007/000025 entitled “LIQUID DELIVERY SYSTEM FOR SUPPLYING LIQUID FROM A PORTABLE CONTAINER TO AT LEAST ONE SELECTED REMOTE DESTINATION AND REMOVING VAPOUR FROM THE AT LEAST ONE SELECTED REMOTE DESTINATION”, PCT/CA2007/002081 entitled “VAPOR-RECOVERY-ACTIVATED AUTO-SHUTOFF NOZZLE, MECHANISM AND SYSTEM”, PCT/CA2010/000116 entitled “A NOZZLE FOR USE IN A NON-OVERFLOW LIQUID DELIVERY SYSTEM”, PCT/CA2010/000115 entitled “AUTOMATIC SHUT-OFF NOZZLE FOR USE IN A NON-OVERFLOW LIQUID DELIVERY SYSTEM”, PCT/CA2012/000261 entitled “FLUID RECOVERY DISPENSER HAVING INDEPENDENTLY BIASED VALVES”, and PCT/CA2012/000986 entitled “CONTAINER FOR PUMPING FLUID”, for example, the entireties of which are hereby incorporated by reference.

In the example shown, the dispenser 715 may include a safety trigger 325b that may operate similar to the safety trigger 325a described above. The dispenser 715 may also include a manually-operated actuator 240b that may be operated (e.g., squeezed) in order to dispense fluid from the dispenser 715.

The pump may be any suitable pump for pumping fluid. For example, the pump may be manually operable (e.g., hand- or foot-operated, such as using a handle or a pedal 705) or electric. The pump may be any suitable configuration including, for example, a rotary pump, a reciprocal pump or a diaphragm pump, among others. The handle or pedal 705 may operate a manual pump or may be connected to a switch to activate an electric motor that drives the pump. Requiring the pump to be activated by a manual mechanism such as a pedal 705 in combination with a dispenser 715 that comprises an actuator 240b and safety trigger 325b may result in added safety in that three separate actions may need to take place in order to be able to dispense liquid (e.g., hazardous liquids such as fuel or other volatile and/or hazardous chemical, such as solvents, poisons, pesticides, herbicides or fungicides) from the pump.

When dispensing liquid from the container 100a, 100b, 100c, it may be useful to dispense the liquid from the lowest region on the container 100a, 100b, 100c which is dependent on the orientation of the container 100a, 100b, 100c (e.g., towards the base 117a, 117b when the container 100a, 100b, 100c is upright and towards the opening when the container 100a, 100b, 100c is inverted) so as to allow vapors to be recovered into the container 100, 100b, 100c. When the container 100a, 100b, 100c is in an inverted orientation and connected to a pump (e.g., as shown in FIG. 17A), it may be useful for liquid to be dispensed from the container 100a, 100b, 100c through the fluid passage way 620 in the cover 600, 600b, and for vapor to be recovered to the container 100a, 100b, 100c through the fluid passage 635 and conduit extension 660. In instances where the container 100a, 100b, 100c is in an upright orientation (e.g., as shown in FIGS. 1A-1E) and connected to a pump, it may be useful for liquid to be dispensed from the container 100a, 100b, 100c through the fluid passage 635 and conduit extension 660 which extends down towards the base 117a, 117b of the container 100a, 100b, 100c and for vapor to be recovered to the container 100a, 100b, 100c through the fluid passage way 620 in the cover 600, 600b.

The dispensing system 700 may be made of any suitable material including, for example, plastics, metals or compound materials. The dispensing system 700 may be modified as suitable, for example the dispensing system 700 may have simpler configurations or custom configurations. Different configurations of the dispensing 700 system may be licensed for use by designated entities (e.g., NASCAR), for example. The dispensing system may include any other suitable components and variations, for example as described in PCT Applications Nos. PCT/CA2005/001367 entitled “PUMP AND NOZZLE LIQUID FLOW CONTROL SYSTEM”, PCT/CA2007/000025 entitled “LIQUID DELIVERY SYSTEM FOR SUPPLYING LIQUID FROM A PORTABLE CONTAINER TO AT LEAST ONE SELECTED REMOTE DESTINATION AND REMOVING VAPOUR FROM THE AT LEAST ONE SELECTED REMOTE DESTINATION”, PCT/CA/2007/001274, entitled “PORTABLE PUMPING APPARATUS FOR CONCURRENTLY PUMPING LIQUID FROM A SOURCE CONTAINER TO A DESTINATION CONTAINER AND PUMPING VAPOR FROM THE DESTINATION CONTAINER TO THE SOURCE CONTAINER”, PCT/CA/2007/001291 entitled “PORTABLE FLUID EXCHANGE SYSTEM FOR CONCURRENTLY PUMPING LIQUID FROM A SOURCE CONTAINER TO A DESTINATION CONTAINER AND PUMPING VAPOR FROM THE DESTINATION CONTAINER TO THE SOURCE CONTAINER”, and PCT/CA2010/000112 entitled “A NON-OVERFLOW LIQUID DELIVERY SYSTEM”, for example, the entireties of which are hereby incorporated by reference.

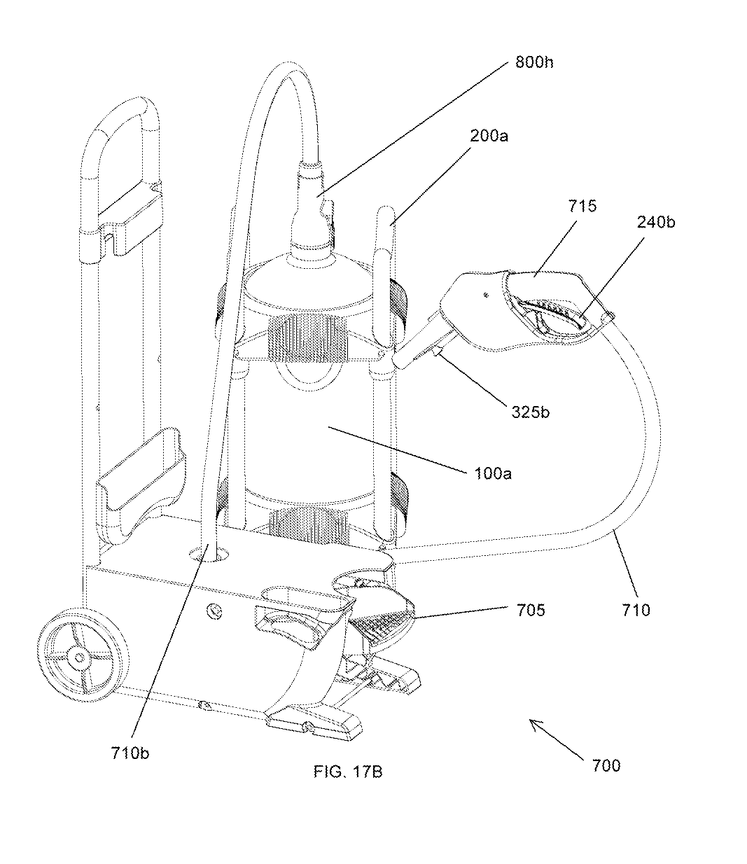

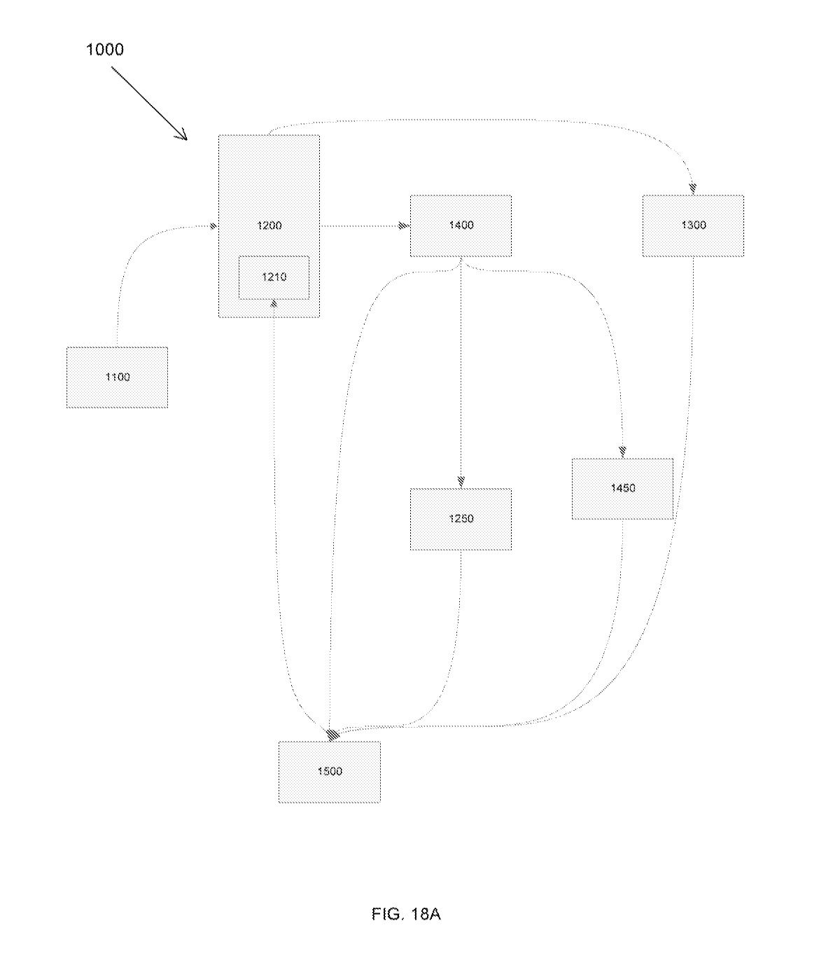

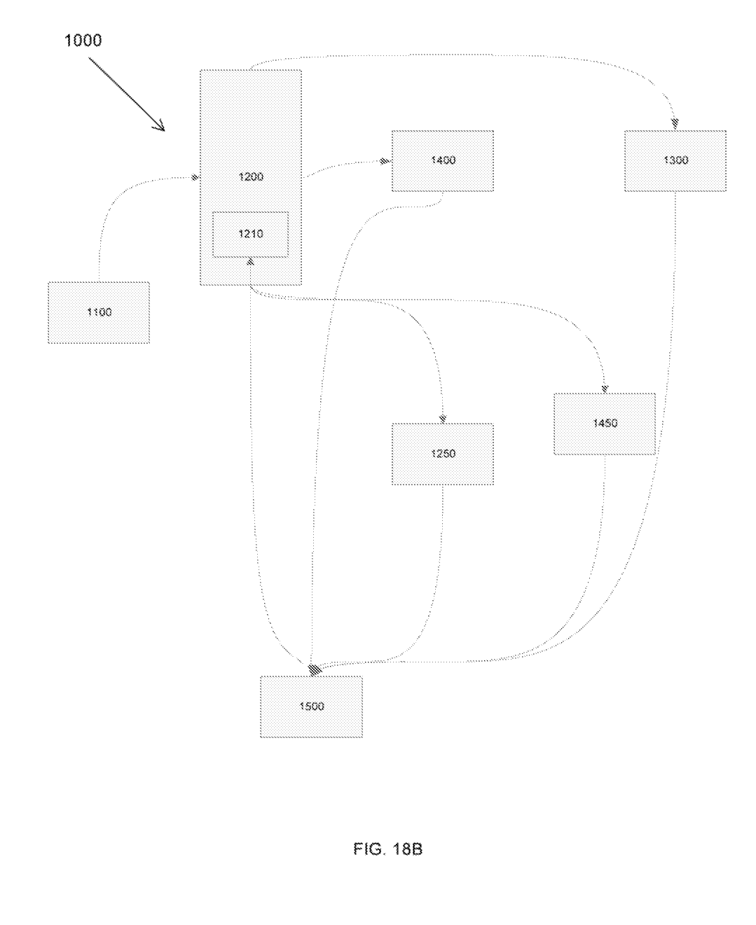

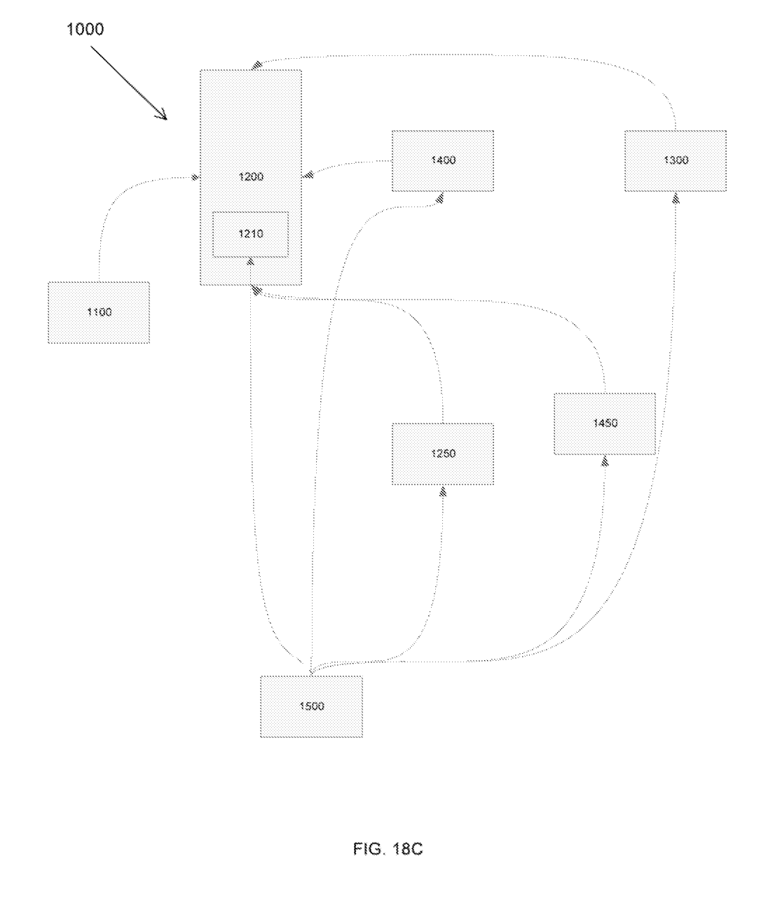

A system 1000 for distribution of fluid is now described. FIGS. 18A-18C show an example of a system 1000 for fluid distribution. Although the system 1000 is described with reference to fuel distribution, as an example, the system 1000 may be suitable for distribution of other fluids, including hazardous fluids or other fluids where it may be desirable to control distribution of and/or restrict consumer contact with the fluid, for example where the fluid is a hazardous chemical. The example system 1000 may include one or more fuel sources 1100 (e.g., a refinery), one or more container distributors 1200, one or more fuel distributor fuelling stations 1300, one or more retail stores 1400 (e.g., Home Depot, Wal-mart or other retail outlet) and one or more consumers 1500. A container distributor 1200 may control and/or own one or more refilling stations 1210 and/or one or more kiosks 1250. In some examples, a refilling station 1210 or a kiosk 1250 may be independent from the container distributor 1200. A retail store 1400 may own one or more container dispensers 1450. In some examples, a container dispenser 1450 may be owned by a container distributor 1200 and leased to a retail store 1400. The system 1000 may additionally include a tracking system, described further below.

Implementation of the system 1000 may be facilitated by the use of the containers 100a, 100b, 100c and enclosures 200a, 200b described above. For example, the containers 100a, 100b, 100c may be designed to be refillable only by authorized and/or trained personnel (e.g., at a container distributor 1200) and not by the consumer(s) 1500. Filling of the containers 100a, 100b, 100c may only be carried out using authorized equipment, which may be exclusively compatible with the containers 100a, 100b, 100c. Thus, the consumer(s) 1500 may be prevented from filling a container 100a, 100b, 100c with fuel themselves and the risks of mishandling by the consumer(s) 1500 (e.g., contamination, spilling of fuel, unintentional release of fuel vapors, incorrect mixing of fuel and other errors) may be reduced. This may allow fuel-filled containers 100a, 100b, 100c to be sold from non-traditional sources (e.g., other than at a gas station) while reducing the risk of mishandling by the consumer(s) 1500. The consumer(s) 1500 may thus purchase pre-packaged fuel (e.g., fuel-filled containers 100a, 100b, 100c) rather than having to package purchased fuel in the consumer(s)'s own containers.

Containers and associated equipment (e.g., enclosures 200a, 200b, containers 100a, 100b, 100c and dispensing systems 700, as described above) may be standardized in the system 1000, which may help to enhance safety, reduce pollution and/or simplify storage, inventory and/or transportation. Standardization of equipment may also avoid or reduce problems associated with uncertified or unsafe containers, and mislabeled or unlabeled containers. Standardization of equipment may also allow a variety of container sizes and/or types to be used with the same equipment (e.g., standardized dispensing systems and/or standardized refilling systems), which may help to reduce consumer confusion as well as reduce inventory costs.

The system 1000 may include a single point of container inspection (e.g., at the container distributor(s) 1200) to avoid inconsistencies and/or for quality assurance.

The consumer(s) 1500 may purchase a full container at retail location 1400 and similarly return an empty container at the retail location 1400. Thus, the consumer(s) 1500 need not be concerned with the intricacies of the fluid distribution system 1000. For example, the consumer(s) 1500 need not interact with multiple entities within the system 1000. In some examples, the containers may be owned by the container distributor(s) 1200 and rented out by the consumer(s) 1500, with only the enclosure, dispenser or spout (as appropriate) being purchased by the consumer(s) 1500. This may allow the container distributor(s) 1200 better control of the containers used in the system 1000. For example, since the containers are returned by the consumer(s) 1500 to the container distributor(s) 1200 when the containers are empty, the container distributor(s) 1200 may more easily implement quality control and/or upgrades on the containers. Where a consumer 1500 is a big-batch consumer needing a large amount of fluid, (e.g., a lawn care or maintenance crew) the big-batch consumer may purchase or rent many containers at once, such as through a single container dispenser (described below).

FIGS. 19A and 19B illustrate example container dispensers 1450 for dispensing filled containers to the consumer(s) 1500. For example, the container dispensers 1450 may include a cage 1450a or other secure housing (e.g., monitored and openable by authorized personnel), as shown in FIG. 19A and/or an automated dispenser 1450b (e.g., an unmanned dispenser with a container return slot 1450x and a container dispensing slot 1450y, similar to soft drink vending machines), as shown in FIG. 19B. The container dispenser(s) 1450 may be located at any suitable location including, for example a retail location 1400 (e.g., Home Depot or garden center), a kiosk 1250 (e.g., at parking lot) or a gas station 1300. The container dispenser(s) 1450 may provide a point of purchase for the fluid (e.g., providing filled containers 100a, 100b, 100c) as well as for the enclosures 200a, 200b. The container dispenser(s) 1450 may also provide a point of rental for the containers 100a, 100b, 100c. In some examples, the consumer(s) 1500 may purchase the fluid and/or enclosures 200a, 200b at a separate location (e.g., online purchase or inside a retail store 1400) and pick up the purchased fluid and/or enclosure 200a, 200b at the container dispenser(s) 1450, by providing proof of payment (e.g., a passcode or a barcode).

The container dispenser 1450 may be owned by the container distributor(s) 1200 and/or may be serviced by personnel from the container distributor(s) 1200. Although referred to as a container dispenser 1450, the container dispenser 1450 may dispense fluid-filled containers 100a, 100b, 100c as well as empty containers 100a, 100b, 100c. Thus, the container dispenser 1450 may be a point of purchase for fluid or point of pickup for purchased fluid. The container dispenser 1450 may also receive containers 100a, 100b, 100c.

Used (e.g., empty) containers may be returned by the consumer(s) 1500 at the retail location 1400. For example, used containers 100a, 100b, 100c may be returned to the return slot 1450x of an automated dispenser 1450b. A returned used container 100a, 100b, 100c may be refilled with fluid at the automated dispenser 1450b and re-dispensed to the same or different consumer 1500. A returned used container 100a, 100b, 100c may alternatively be transported to a refilling station 1210 where the container 100a, 100b, 100c is inspected and suitably cleaned if appropriate (e.g., to avoid contamination) and refilled. Where a container 100a, 100b, 100c is refilled automatically at the automated dispenser 1450b, the dispenser 1450b may determine what fluid to be filled into the container 100a, 100b, 100c (e.g., where the dispenser 1450b is capable of dispensing two or more different fluids), for example by scanning a barcode on the container 100a, 100b, 100c.

The automated dispenser 1450b may include or have access to a fluid reservoir (which may be contracted to be replenished by a supplier 1100, such as an oil company or other third party supplier) for refilling empty containers 100a, 100b, 100c.

The shape of the container dispenser 1450 and/or the containers 100a, 100b, 100c may be designed to maximize the number of containers 100a, 100b, 100c (and therefore the volume of fluid) that may be housed in a single container dispenser 1450.

Refilling of used containers 100a, 100b, 100c may take place at a centralized location, such as a refilling depot 1210 or at the container distributor(s) 1200. A fuel distributor 1100, such as an oil company or other third party, may be contracted to refill used containers 100a, 100b, 100c at such locations. Any necessary premixing of fuel and/or addition of additives may also take place at the time of refilling.

A refilling system designed to cooperate with the containers 100a, 100b, 100c may be used to refill the used containers 100a, 100b, 100c, for example by cooperating with the quick disconnect type dry-break connection of the cover 600, 600b. The refilling system may be designed for quick mass-refilling, for example through the use of quick-mating connections and/or multi-container connections.

In some examples, refilling of used containers 100a, 100b, 100c may include disposal of residual and/or leftover fluids in the containers 100a, 100b, 100c. For example, a returned container 100a, 100b, 100c may include old fuel, which may be disposed rather than reused (e.g., to avoid contamination). To dispose of such residuals, before refilling the container 100a, 100b, 100c, the refilling process may include introducing a small amount of new fuel into the container 100a, 100b, 100c to rinse out any residuals. The rinsed out fluid may be disposed of appropriately and/or may be tested for the presence of any contaminants. Where appropriate (e.g., if the rinsed out fluid is found to be free of contaminants), the rinsed out fluid may be collected for further use (e.g., re-introduced into the refilling reservoir, or sold off to recycling centers for another use).

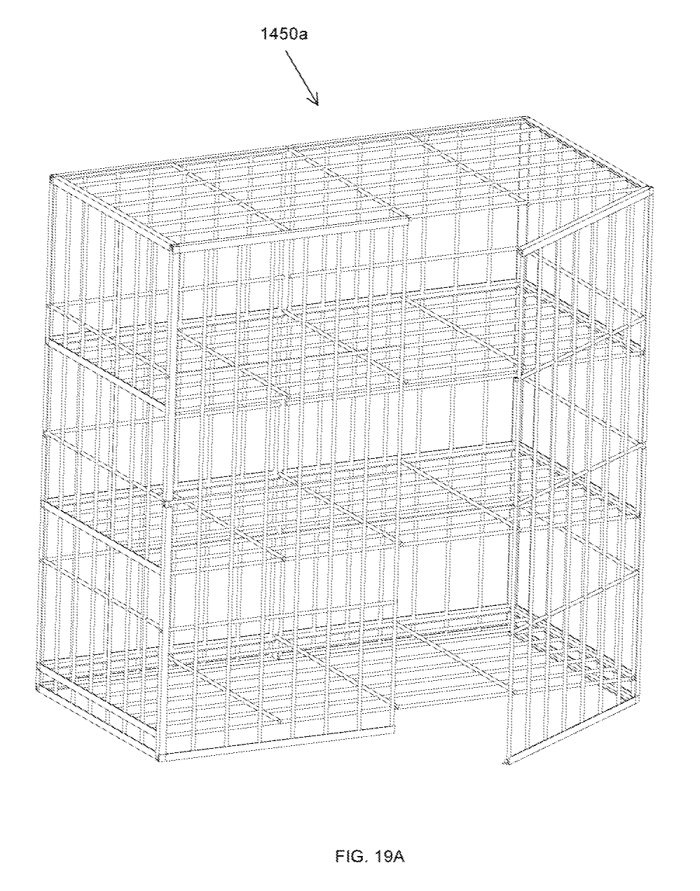

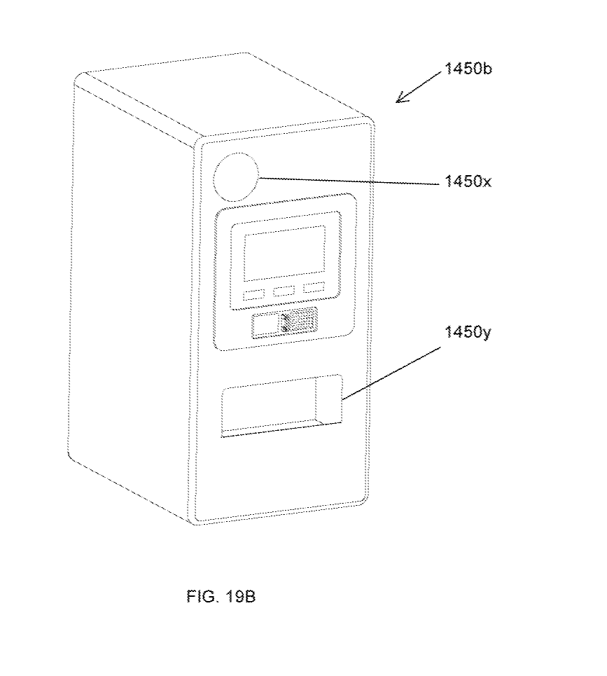

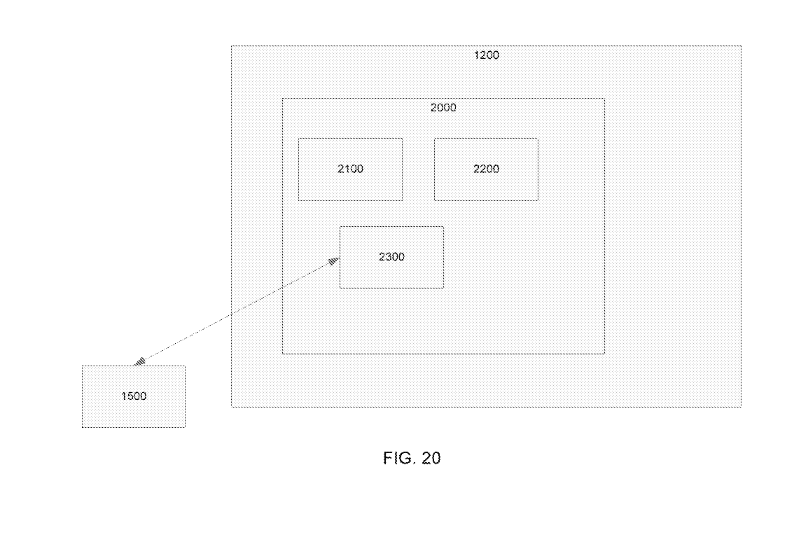

The system 1000 may include an electronic tracking system 2000, for example as shown in FIG. 20, to track the consumer(s) 1500 and/or containers 100a, 100b, 100c. The tracking system 2000 may be part of, owned by and/or operated by the container distributor 1200 or other entity/company. In some examples, the tracking system 2000 may be embodied as one or more servers, which may communicate with one or more computing systems accessible by one or more entities in the system 1000 wirelessly (e.g., via the Internet, a local network or other wireless networks) and/or through wired connections (e.g., via a wired connection with one or more computing devices). For example, a consumer 1500, a retail store 1400, a gas station 1300 and/or a container distributor 1200 may access at least part of the tracking system 2000 wirelessly through a computing device (e.g., a desktop computer, a handheld device, a smartphone, a telephone or other communication device). The tracking system 2000 may enable a consumer 1500 to purchase fuel, order fuel, track an order and carry out various other interactions with the system 1000. Similarly, the retail store 1400, fuelling station 1300 and/or container distributor 1200 may access at least part of the tracking system 2000 in order to track consumer history, consumer orders, container history, and carry out various other interactions with the system 1000.

In some examples, each container 100a, 100b, 100c may include unique identification (e.g., a barcode) that may be stored in a container database 2100 to track information associated with that container 100a, 100b, 100c (e.g., date of manufacture, associated consumer information, time of rental and/or return by each consumer, location, contents, service history or any other suitable information). Each container 100a, 100b, 100c may be tracked (e.g., by the automated dispenser(s) 1450b or retail worker scanning a barcode on the container 100a, 100b, 100c) when dispensed to a consumer 1500 and/or when recollected from the consumer 1500. Other equipment (e.g., enclosures 200a, 200 band dispensing systems) may be similarly tracked. Such tracking may help ensure the quality and safety of containers 100a, 100b, 100c and/or equipment, for example by retiring a container 100a, 100b, 100c once it has reached a certain age. Tracking of such information may also allow for accountability in the distribution system 1000 (e.g., may allow for tracking of consumers 1500 with a history of damaged containers 100a, 100b, 100c and/or contaminated containers 100a, 100b, 100c).

Consumer history may be tracked through consumer identification information (e.g., credit card number, customer identification number or loyalty card number) provided by the consumer 1500 at purchase, rental and/or return of a container. Such consumer information may be stored in a consumer database 2200. Consumer information may be collected by the retailer 1400 and/or container distributor 1200. Such information may be used to provide incentives (e.g., loyalty benefits, special discounts or introductory offers) to promote consumer loyalty to and participation in the distribution system 1000.

The distribution system 1000 may also include an online or telephone information system 2300 for interacting with the consumer(s) 1500. For example, the consumer(s) 1500 may access the information system 2300 (e.g., using a personal identification number (PIN) or other secure methods) using a user device (e.g., a telephone, a smartphone, a computer or other user device) to update a user profile, purchase equipment and/or fluid, track purchase history, access safety and/or instructional information (e.g., about different fuels, use of different equipment or current promotions), predict future needs and/or other such activities. The information system 2300 may be accessible by at any suitable access point (e.g., using a computer, smartphone, or telephone, among others) at the consumer's convenience. The information system 2300 may provide a convenient, secure and readily accessible way for the consumer 1500 to interact with the distribution system 1000.

Each of the consumer 1500, the container distributor 1200, the fuelling station 1300 and the retail store 1400 may access different portions of the tracking system 2000. For example, the consumer 1500 may access only the information system 2300, which may provide a consumer-friendly user interface and may provide information limited to the consumer's own purchasing needs. The container distributor 1200 may access all portions of the tracking system 2000, including access to the consumer database 2100, the container database 2200 and the information system 2300. The container distributor 1200 may additionally be able to modify or update some or all of the tracking system 2000, for example to add, update or remove consumer information from the consumer database 2100; or to add, update or remove features of the tracking system 2000 (e.g., security features or advertising). The retail store 1400 or the fuelling station 1300 may access portions of the tracking system 2000, for example access to the consumer information in the consumer database 2100 relating to consumers registered with the retail store 1400 or the fuelling station 1300.

The distribution system 1000 may enable various forms of advertising and/or branding not available in conventional fluid distribution. For example, fluids, such as fuel, may be sold through branded containers 100a, 100b, 100c, such that a contracted oil company 1100 or the container distributor(s) 1200 may associate its brand with the fuel.

The distribution system 1000, may (e.g., through the tracking system 2300) facilitate more targeted advertising, such as time-limited promotions or events, geographically targeted advertising, retailer-specific advertising, and other such targeted advertising.

Advertising may also be provided at various points in the system 1000 including, for example, on the containers 100a, 100b, 100c, on an online site, on a container dispenser 1450 and at a dispensing kiosk 1250, among others.

The distribution system 1000 may enable one or more methods of fuel distribution not available using conventional fuel distribution.

For example, the disclosed distribution system 1000 may enable distribution of fuels at locations other than at a gas station 1300 (such as retail outlets 1400 or marinas).

The consumer 1500 may need to purchase only the enclosures 200a, 200b, with the containers 100a, 100b, 100c being rented and owned by the retailer 1400 and/or container distributor 1200. The consumer 1500 may only be required to put down a deposit for rental of the container 100a, 100b, 100c and may only need to purchase the enclosure 200a, 200b. In some examples, both the enclosure 200a, 200b and container 100a, 100b, 100c may be rented, such as where the enclosure 200a, 200b and container 100a, 100b, 100c is dispensed to the consumer 1500 as an assembly and returned by the consumer 1500 as an assembly.

In some examples, the consumer 1500 may own the container 100a, 100b, 100c. The consumer 1500 may provide the consumer-owned container 100a, 100b, 100c to a retail location 1400, gas station 1300, refill station 1210 and/or container dispenser 1450 to have the consumer-owned container 100a, 100b, 100c filled (and optionally inspected) by authorized personnel and/or by an automated dispenser 1450b.

The container distributor 1200 may manufacture or sub-contract the manufacture of containers 100a, 100b, 100c, enclosures 200a, 200b and/or container dispensers 1450. The container distributor 1200 may distribute or provide the means to distribute containers 100a, 100b, 100c, enclosures 200a, 200b, filled containers 100a, 100b, 100c (e.g., via retail outlets 1400) and/or container dispensers 1450. The container distributor 1200 may additionally own and operate one or more other entities in the system including, for example, the fluid supplier 1100 (e.g., oil refinery), the tracking system 2000 the information system 2300, the retail location 1400 and/or the container dispenser 1450. Container dispensers 1450 and kiosks 1250 may be serviced by personnel from the retailer 1400 and/or container distributor 1200.

Examples of how a consumer 1500 may obtain a filled container 100a, 100b, 100c are described with reference to FIGS. 18A and 18B.

At 1105, fuel may be provided by the fuel source 1100 to the container distributor 1200. The container distributor 1200 may fill the containers 100a, 100b, 100c with the fuel (e.g., at the refilling station 1210) and may seal the filled containers 100a, 100b, 100c. The filled containers 100a, 100b, 100c may be distributed to the fuelling station 1300 at 1205; distributed to the retail store 1400 at 1210; stocked at the kiosk 1250 at 1215; and/or stocked at the container dispenser 1450 at 1220. The kiosk 1250 and/or the container dispenser 1450 may additionally or alternatively be stocked by the retail store 1400 at 1405 and 1410 (e.g., where the retail store 1400 owns and/or operates the kiosk 1250 and/or the container dispenser 1450).

In some examples, the consumer 1500 may obtain filled containers 100a, 100b, 100c at a retail location 1400 at 1415, a container dispenser 1450 at 1455, a kiosk at 1255 a gas station 1300 at 1305 or at any other suitable point in the system 1000. The consumer 1500 may purchase the fuel at the point where the filled container 100a, 100b, 100c is obtained (e.g., an in-store purchase at a retail location 1400). The consumer 1500 may also purchase the fuel at a different location (e.g., an online purchase using the information system 2300, a pre-paid purchase at the retail location 1400 or the fuelling station 1300) and pick up the filled container 100a, 100b, 100c with the purchased fuel at any designated pick up location (e.g., at the kiosk 1250, the container dispenser 1450 the retail location 1400 and/or the fuelling station 1300). The consumer 1500 may then couple the enclosure 200a, 200b to container 100a, 100b, 100c to dispense fluid.

In some examples, a reservoir of fluid (which may be maintained and/or replenished by the fuel source 1100) may be kept where the filled containers 100a, 100b, 100c are picked up (e.g., a retail location 1400, a container dispenser 1450, a kiosk 1250, a fuelling station 1300 or any other suitable point in the system 1000). Thus, instead of filled containers 100a, 100b, 100c, at 1205, 1210, 1215 and/or 1220 the container distributor 1200 may provide empty containers 100a, 100b, 100c to the fuelling station 1300, the retail location 1400, the container dispenser 1450 and/or the kiosk 1250. The empty containers 100a, 100b, 100c may be filled at the pick up location (e.g., at the time of pick up, or earlier). The consumer 1500 may obtain the filled container 100a, 100b, 100c as described above and the consumer 1500 may then couple the enclosure 200a, 200b to container 100a, 100b, 100c to dispense fluid.

In some examples, the consumer 1500 may obtain the container 100a, 100b, 100c and enclosure 200a, 200b assembled together, such that the consumer 1500 does not need to couple the enclosure 200a, 200b to the container 100a, 100b, 100c and does not need to own the enclosure 200a, 200b.

Identifying information may be provided on the container 100a, 100b, 100c, such as when the consumer 1500 purchases the container 100a, 100b, 100c without the enclosure 200a, 200b. There may additionally be identifying information provided on the enclosure 200a, 200b. Where the consumer 1500 purchases the assembled enclosure 200a, 200b and container. Where the consumer 1500 purchases the container 100a, 100b, 100c without the enclosure 200a, 200b, identifying information may be provided only on the enclosure 200a, 200b.

In some examples, the filled container 100a, 100b, 100c and/or container and enclosure assembly may be delivered to a consumer-designated location, rather than being picked up by the consumer 1500 at the retail location 1400, fuelling station 1300, dispenser 1450 or kiosk 1250.

FIG. 18C illustrates an example of how a used container 100a, 100b, 100c may be processed in the system 1000.

A used (e.g., empty) container 100a, 100b, 100c may be returned by a consumer 1500 (e.g., in exchange for a return on deposit) to the location where it was obtained (or any other designated pick-up location in the system 1000), such as returning to the retail location 1400 at 1510, returning to the fuelling station 1300 at 1525, returning to the kiosk 1250 at 1515, and/or returning to the container dispenser 1450 at 1520. At 1310, 1420, 1460 and 1260, used containers 100a, 100b, 100c may be transported to the container distributor 1200 and/or the refilling station 1210 for cleaning and refill, or appropriate disposal. At 1505, the consumer 1500 may also return the used container 100a, 100b, 100c directly to the refilling station 1210.

In some examples, the used container 100a, 100b, 100c may be cleaned and/or refilled, or appropriately disposed, at the location where it was returned.

In some examples, rather than the consumer 1500 returning the used container 100a, 100b, 100c to a return location, a pick up of used containers 100a, 100b, 100c may be requested by the consumer 1500 (e.g., via the online or telephone information system 2300). The used container 100a, 100b, 100c may then be picked up at a consumer-designated location (e.g., by the retailer 1400 or container distributor 1200) for appropriate processing (e.g., cleaning and/or refilling, or disposal).

In some examples, the consumer 1500 may dispose of a used container 100a, 100b, 100c, such as where the container 100a, 100b, 100c is intended for one-time use.

Refilling of the container 100a, 100b, 100c may be carried out using specialized equipment and by trained personnel. Refilling may be carried out using an automated or semi-automated process, for example at the container distributor 1200, at the refilling station 1210, at the retailer 1400 and/or at an automated container dispenser 1450b. The consumer 1500 may be prevented from refilling the container 100a, 100b, 100c, for example through various features of the container 100a, 100b, 100c as described above.

The refilling process may include pollution control, vapor recovery, inspection of containers 100a, 100b, 100c (e.g., for integrity, age or quality), tracking of the container 100a, 100b, 100c in the tracking system 2000 (e.g., including an update of the container database 2200) and/or may include labeling of the container 100a, 100b, 100c (e.g., with expiry date of contents, verification of inspection or identification of contents).

In some examples, the fluid may have an expiration date (e.g., where the fluid, such as fuel, may go bad after a period of time). The expiration date may be indicated on the container 100a, 100b, 100c (e.g., a label may be added when the container 100a, 100b, 100c is filled). The expiration date may be indicated by an indicator recognizable only by an authorized personnel or scanning system so as not to alarm consumers 1500. Containers 100a, 100b, 100c at or near the expiration date may be identified (e.g., visually by trained personnel and/or automatically via a bar code) and may be collected by authorized personnel to be emptied of the old fluid and refilled with fresh fluid (e.g., at a refilling station 1210). The container 100a, 100b, 100c may be inspected and/or cleaned as appropriate. The old fluid may be disposed of or remixed into the main fluid supply, as deemed appropriate.

Other aspects of the present disclosure are now discussed with reference to FIGS. 21-24.

FIG. 21 shows an example cover 600c configured to be suitable for use on a conventional fluid container 100d (e.g., a conventional gas can having a conventional handle 105c). The cover 600c may be similar in operation and features to the cover 600, 600b discussed above. The use of the cover 600c may allow various aspects of the present disclosure to be carried out on conventional fluid containers 100d. For example, a consumer with a conventional fluid container 100d may only need to purchase the cover 600c (which may be referred to as a “universal” cover) to use with his/her existing fluid container 100d in order to partake in the disclosed systems and methods. Use of the cover 600c may help to make use of conventional fluid containers 100d safer and/or more convenient. Conveying attachments in the form of dispensers 800, 800a, 800b, 800c, 800d, 800e, 800f and filling dispensers described below. Additionally and enclosure may be developed for these conventional fluid container 100d to improve the handling characteristics of these containers.

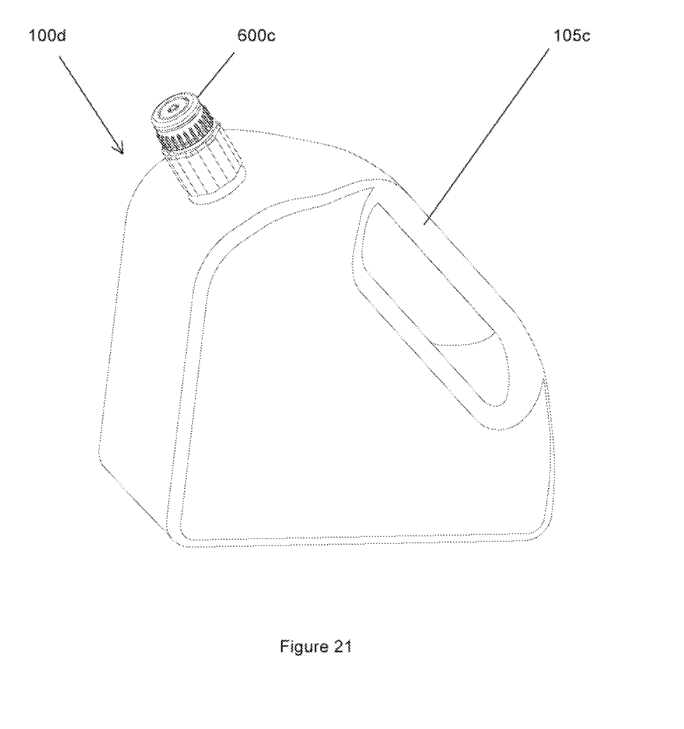

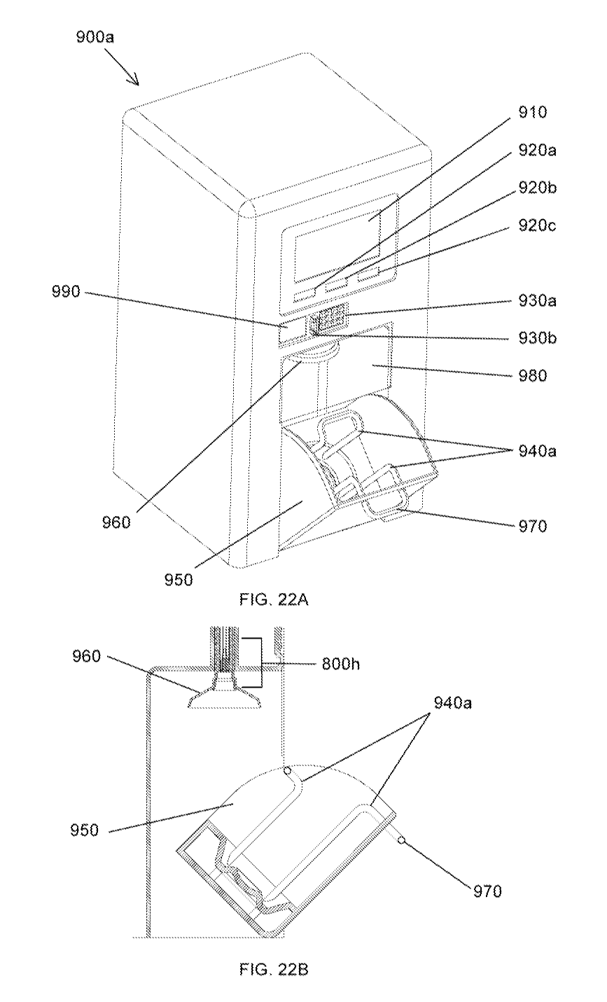

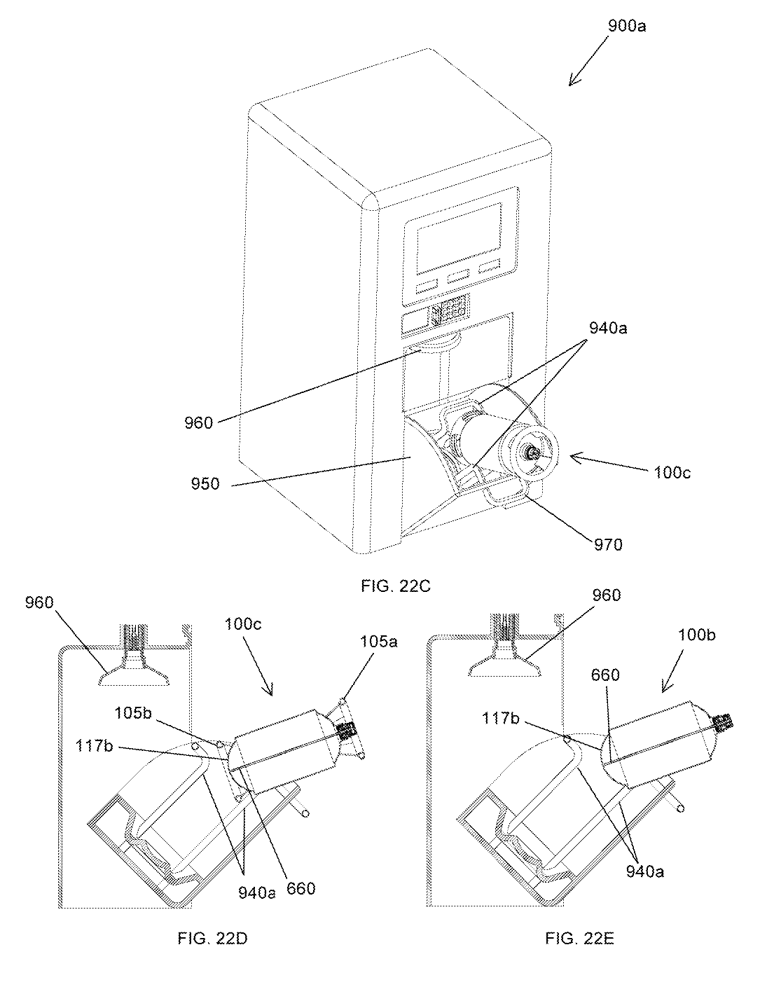

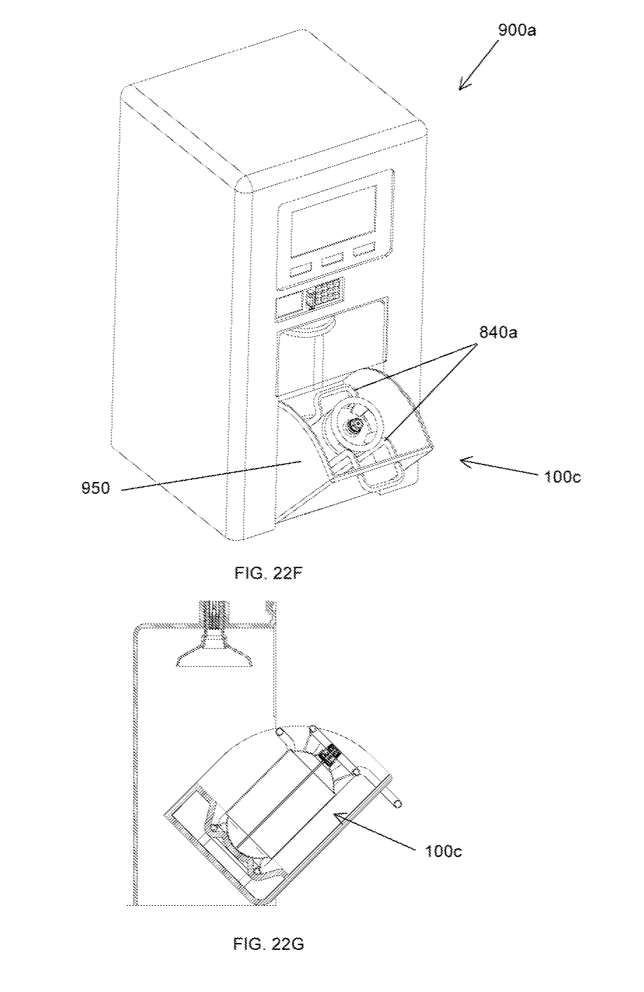

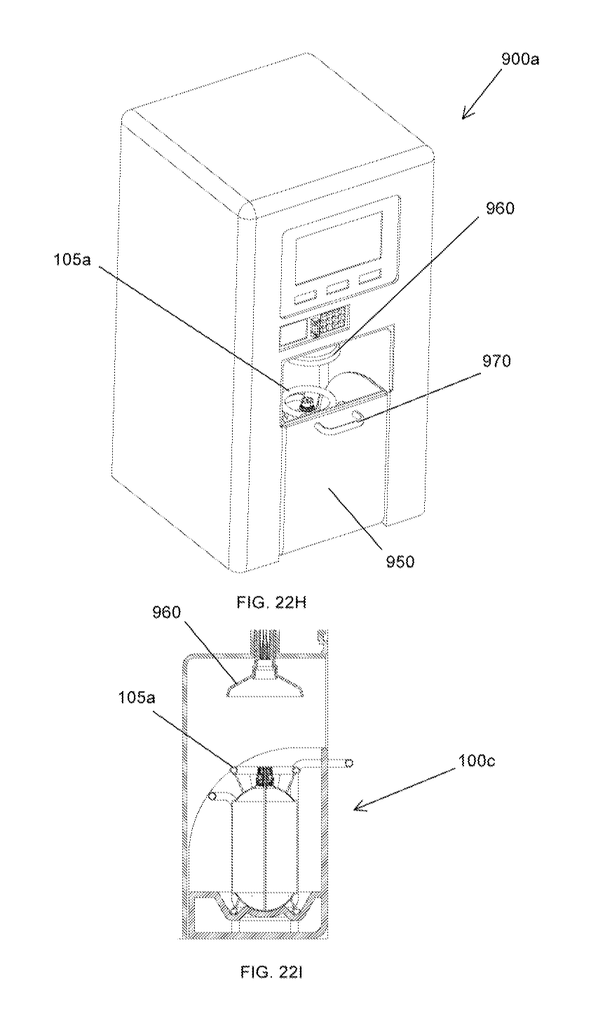

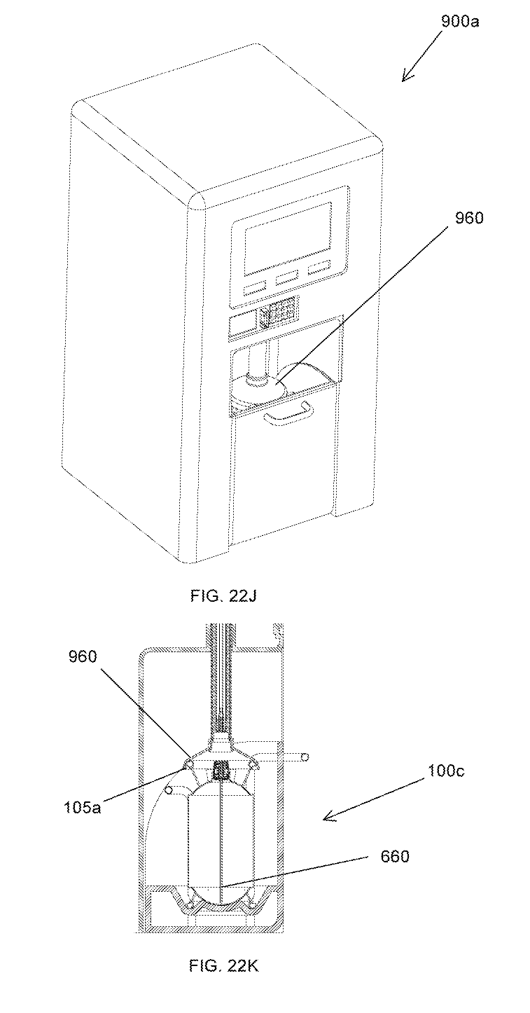

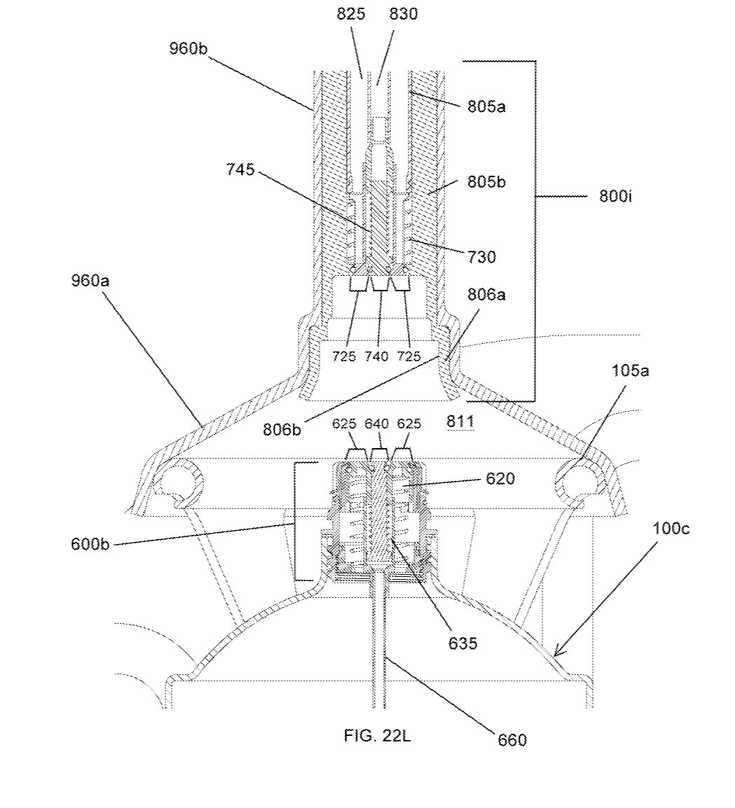

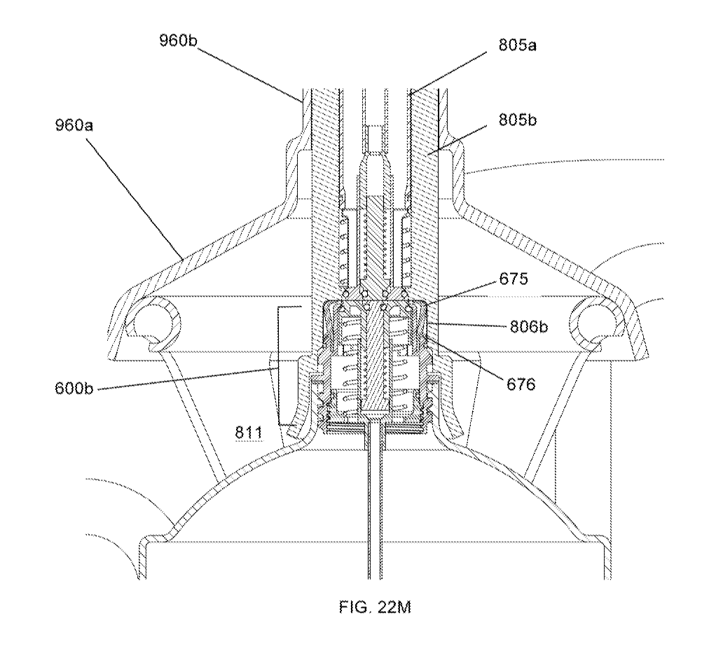

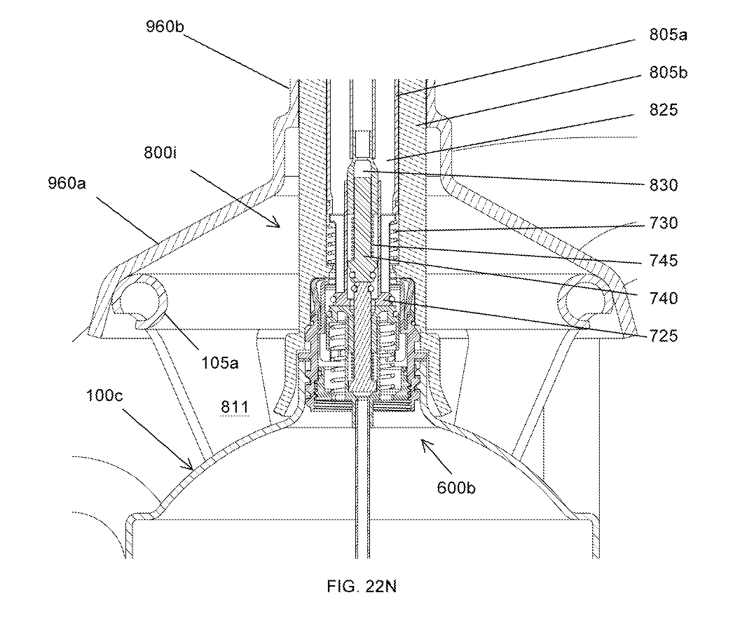

FIGS. 22A-22N show an example filling equipment 900a and details of its operation. The filling equipment 900a may be suitable for filling new and/or used containers 100a, 100b, 100c. The filling equipment 900a may be authorized equipment (e.g., exclusively designed to be compatible with the containers 100a, 100b, 100c) that may be operable by authorized personnel only (e.g., authorized dealers) or may be operable by the general consumer. The filling equipment 900a may be an automated vending machine, for example, and may be provided at a retail outlet, a gas station, a kiosk or any other suitable location. The filling equipment 900a may carry out automated inspection and or cleaning and/or filling of new and/or used containers 100a, 100b, 100c. The filling equipment 900a may be suitable for use as part of the fluid distribution system 1000.

FIGS. 22A-22B show the filling equipment 900a without any container 100a, 100b, 100c. The filling equipment 900a may include output device(s) (e.g., a display 910 or progress lights) and input device(s) (e.g., fuel selection buttons 920a, 920b, 920c, keypad 930a and/or card reader 930b, 990). In some examples, the output and input device(s) may be provided together in a touchscreen. The display 910 may provide information to a consumer, such as information indicating progress in the inspection, cleaning and/or filling process; other information, such as advertisements, safety instructions or fuel information, may also be displayed. Input device(s) may enable a user (e.g., an end consumer or authorized personnel) to choose the purchase quantity (e.g., dollar amount or volume), volume quantity, grade of fuel (e.g., regular, high grade or premium), formulation such as mix ratio of oil and gas for two-stoke engines, fuel stabilizer additives and other such options. A keypad 930a and card reader (which may be an insertion-style reader 930b or a swipe-style reader 990) may be provided to enable reading of a chip or magnetic card (e.g., a debit card, credit card or employee ID card) and entry of a PIN.

The filling equipment 900a may include a door or drawer 950 for receiving the container 100a, 100b, 100c. One or more guides 940a may be provided in the drawer 950 to help position the container 100a, 100b, 100c in the drawer 950 and help in aligning the container 100a, 100b, 100c to ensure proper filling. The drawer 950 may be manually opened (e.g., through use of a handle 970) or may open automatically (e.g., upon appropriate user input) and may lock closed once the inspecting, cleaning and/or filling process begins.

The filling equipment 900a may include a filling head 960 (which may be retractable such that it is retracted when not in use) for delivering fluid to the container 100a, 100b, 100c. The filling equipment 900a may also include a window to enable viewing of the container 100a, 100b, 100c as it is being inspected, cleaned and/or filled.

The filling equipment 900a may be authorized equipment that enables filling of the container 100a, 100b, 100c. While the filling equipment 900a may be usable by the general consumer, the filling equipment 900a may restrict or prevent access to the container 100a, 100b, 100c and the inspection, cleaning and/or filling process by the consumer during the inspection, cleaning and/or filling process. The filling equipment 900a may enable vapor recovery during the cleaning and/or filling process. The filling equipment 900a may include a filter (e.g., a carbon filter) (not shown) to collect vapors during the cleaning and/or filling process.

FIGS. 22C-22K illustrate an example of how the filling equipment 900a may cooperate with a container 100c to deliver fluid into the container 100c. Although the container 100c is shown, any of the containers 100a, 100b, 100c described herein (or other suitable container) may be used with the filling equipment 900a. FIG. 22E illustrates an example where the filling equipment 900a is used with the container 100b without handles.

The filling equipment 900a may be able to recognize if the container 100a, 100b, 100c that it has received contains any old fluid (e.g., by identifying the container 100a, 100b, 100c—such as via a barcode—and having stored information about the dry weight of the identified container 100a, 100b, 100c). Any old fluid may be automatically disposed of by the filling equipment 900a or the user may be provided with an option to dispose of or to retain the old fluid. Any old fluid to be disposed of may be drawn out via the filling head 960. An indicator (e.g., a barcode) on the container 100a, 100b, 100c may be automatically read by the filling equipment 900a to determine whether old fluid in the container 100a, 100b, 100c should be disposed (e.g., near, at or past the expiration date, or incompatible with the new fluid to be filled into the container 100a, 100b, 100c) and if so the filling dispenser 900a may warn the user that keeping the old fluid is inadvisable or not permitted and/or may automatically dispose of the old fluid.

The user may select the quantity of fluid to fill into the container 100a, 100b, 100c. The filling equipment 900a may automatically determine the maximum amount of new fluid that can be added to the container 100a, 100b, 100c (e.g., via a barcode on the container 100a, 100b, 100c and/or determination of the amount of old fluid in the container 100a, 100b, 100c) and may select this amount by default or display this amount for confirmation by the user. For example, the container 100a, 100b, 100c may be identified as having a capacity of five gallons via the filling head may sense how large the container is (discussed below), a visual scanner, scanning of a barcode, but the weight of the container 100a, 100b, 100c may indicate that there is already one gallon of fluid inside; hence the filling equipment 900a may automatically determine that the old fluid should be disposed of in order to add five gallons of fresh fluid or that if the old fluid is kept only four gallons of fresh fluid can be added. The filling equipment 900a may be able to override a user-selected quantity when it is determined that the user-selected quantity is too much. The filling equipment 900a may also include an auto-shutoff mechanism (e.g., a Venturi-triggered shutoff) to simply terminate the filling operation when the container 100a, 100b, 100c is full.

Where the filling head 960 enables vapour recovery, the filling equipment 900a may simply deliver fluid to the container 100a, 100b, 100c until liquid is detected at the vapour recovery conduit of the filling head 960.

The drawer 950 and guide 940a may be configured to accept one standard container 100a, 100b, 100c or may be configured to accommodate a number of different container configurations. For example, FIG. 22D illustrates how the container 100c with handles 105a, 105b fits into the drawer 950 and FIG. 22E illustrates how the container 100b fits into the drawer 950. The drawer 950 and guide 940a may accept different size variations of the container 100a, 100b, 100c (e.g., variations in the form of height and/or size). The retractable filling head may be able to determine the size and volume of the container once the filling head engages the container 100a, 100b, 100c (described below). The drawer 950 and guide 940a may be configured to restrict what the filling equipment 900a will accept.

FIGS. 22F and 22G show the container 100c dropping into position in the drawing 950 of the filling equipment 900a.

FIGS. 22H and 22I show the drawer 950 of the filling equipment 900a being closed with the container 100c inside. When the door is closed, the container 100c is placed into alignment (e.g., with help from guide 940a) with the filling head 960.

The filling equipment 900a may provide a relatively simple and automated process for adding fluid to a new or used container 100a, 100b, 100c. At the simplest, a user may simply swipe a card (e.g., employee ID or credit/debit card) and place a container 100a, 100b, 100c into the drawer 950.

The filling equipment 900a may then automatically close and lock the drawer 950. The filling equipment 900 may automatically determine the appropriate type and quantity of fluid to delivery to the container 100a, 100b, 100c (e.g., via scanning of a barcode or other indicator on the container 100a, 100b, 100c), and automatically inspect and/or clean and/or fill the container 100a, 100b, 100c accordingly. The drawer 950 may then automatically unlock and open, allowing the user to retrieve the container 100a, 100b, 100c now containing fresh fluid.

FIGS. 22J and 2K illustrate how the filling head 960 moves to engage the container 100c. The filling head 960 may move towards and engage with the cover 120, 600, 600b (or alternatively the top handle 105a in the case of the container 100c) of the container 100a, 100b, 100c. A height of the container 100a, 100b, 100c may be determined by the filling equipment 900a based on the distance the filling head 960 moves in order to engage the container 100a, 100b, 100c; this height may be used to determine the capacity of the container 100a, 100b, 100c.

The filling head 960 may cooperate with the cover 120, 600, 600b to deliver fluid to the container 100a, 100b, 100c. Fluid may be introduced into the container 100a, 100b, 100c via the conduit 660.

FIGS. 22L-22N are close-ups showing details of how the filling head 960 cooperates with the container 100a, 100b, 100c to deliver fluid to the container 100a, 100b, 100c. For simplicity, the following description refers to the container 100c with cover 600b, however other containers 100a, 100b and covers 120, 600 may be used with appropriate variation.

In FIG. 22L, the filling head 960 has moved to engage the container 100c. The filling head 960 (comprising the body 960b and engaging portion 960a) has moved towards and engaged with the handle 105a of the container 100c. The engaging portion 960a is configured to conform to the handle 105a to positively locate the container 100c and confirm its presence and position. In FIG. 22M a filling dispenser 800i moves telescopically relative to body 960b towards the cover 600b only after the engaging portion 960 is engaged with the handle 105a and may engage the cover 600b at a connection end 811. This may help to avoid the possibility that the user forgot to place the container 100c in the drawer 950, or avoid potential interference by unexpected objects or components (e.g., a dispenser, plastic bag) that may damage the filling dispenser 900a or compromise the filling operation.

The filling dispenser 800i may have components similar to the spout dispenser 800b (described above and shown in FIGS. 9A and 9B) and may cooperate with the cover 600b in a similar manner. The filling dispenser 800i may engage the cover 600b at the seal 606 (as shown in FIGS. 2D-2E) to create an air-tight, leak-proof seal, thus creating a closed-system between the filling head 960 and the container 100c. This may enable vapour recovery during delivery of fluid to the container 100c. In FIG. 22M, the valves 625, 640 of the cover 600b are still in the closed configuration. Negative or positive air pressure may be introduced between the filling dispenser 800i and the cover 600b in order to test the integrity of the valves 625, 640 and/or seal 606. If this test is failed, the filling process may be aborted, an appropriate error message may be displayed to the user and the container 100c may be returned to the user.

In FIG. 22N, the filling dispenser 800i cooperates with the cover 600b to open the valves 625, 640, in a manner similar to that described above for the spout dispenser 800b.

Filling dispenser 900a is configured to accept and fill containers in an upright orientation but it is conceivable that filling dispenser 900a could be configured to accept and fill containers in an inverted orientation.

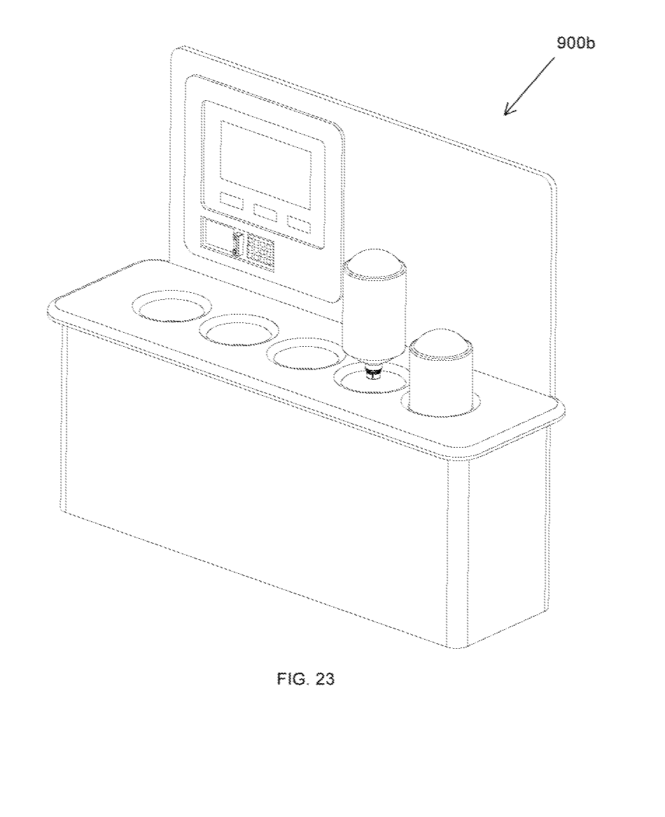

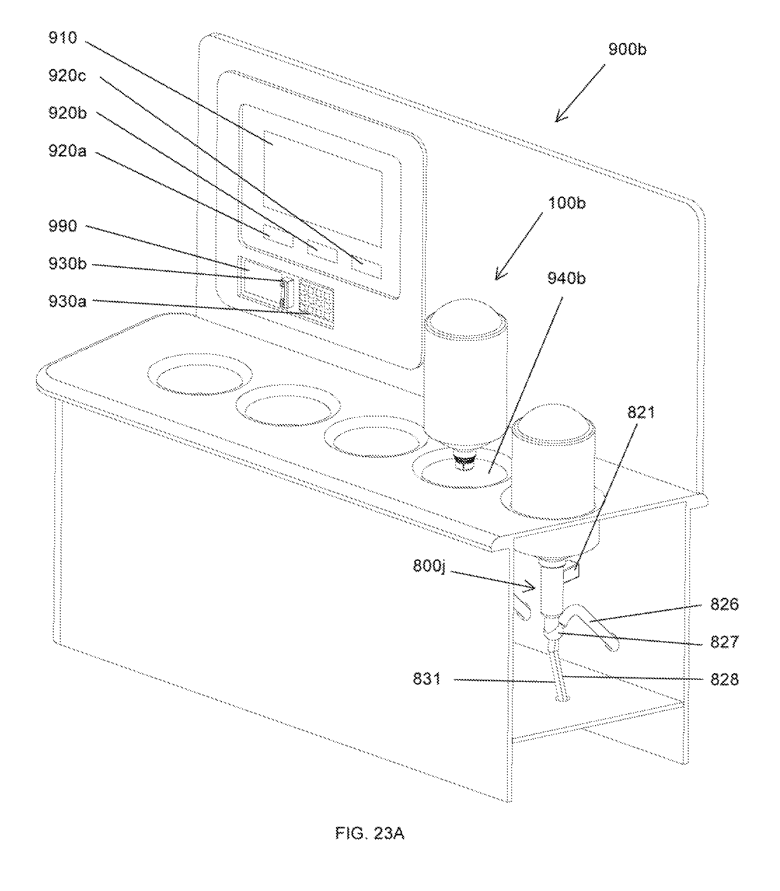

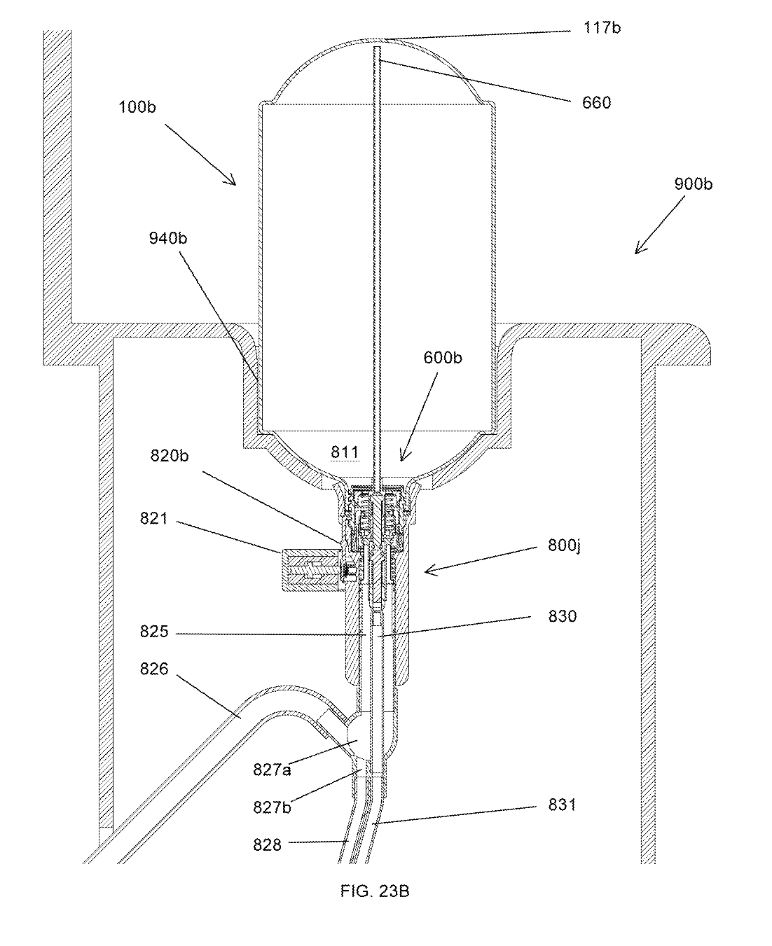

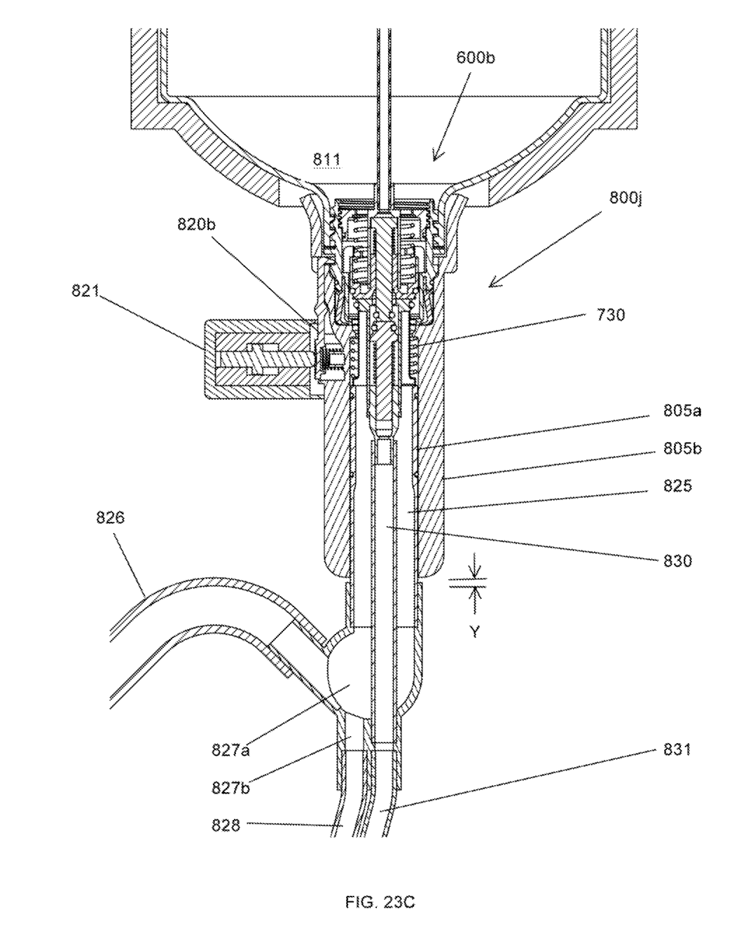

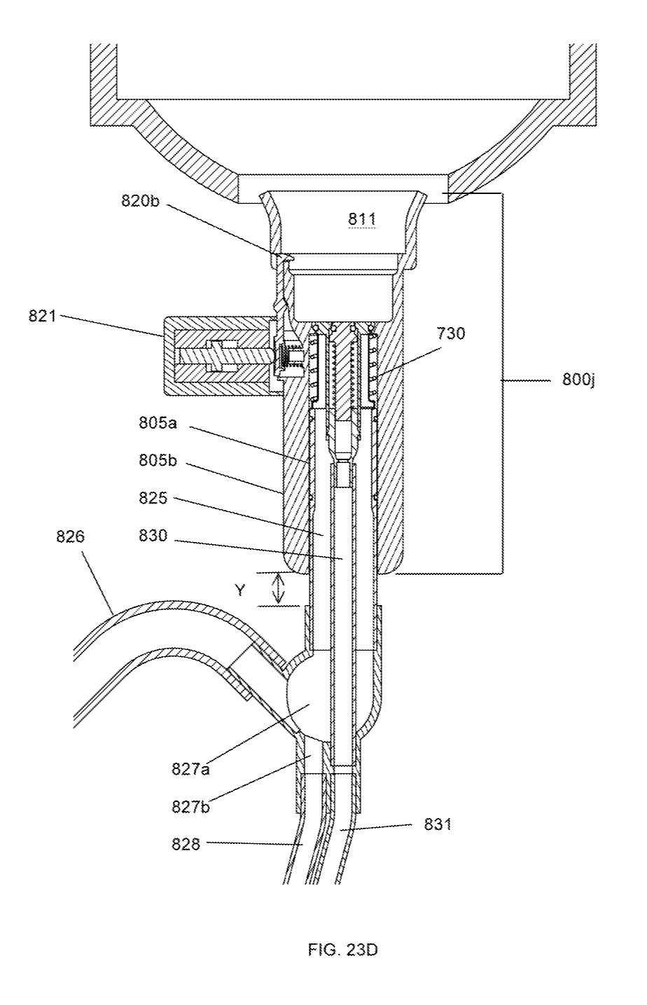

FIG. 23 shows another example filling equipment 900b suitable for use in the system 1000 and/or with the container 100a, 100b, 100c. The filling equipment 900b may have features and functions similar to the filling equipment 900a described above, but may be configured for automated filling of multiple containers 100a, 100b, 100c together in an inverted position. The filling equipment 900b may be authorized equipment (e.g., exclusively designed to be compatible with the containers 100a, 100b, 100c) that may be restricted to use by authorized personnel only and may have less restrictive safety features than the filling equipment 900a.

FIGS. 23A-23D show details of the filling equipment 900b and its operation. The filling equipment 900b may include output device(s) (e.g., a display 910 or progress lights) and input device(s) (e.g., fuel selection buttons 920a, 920b, 920c, keypad 930a and/or card reader 930b, 990), as described above for filling equipment 900a. In some examples, the output and input device(s) may be provided together in a touchscreen.

The filling equipment 900b may include a filling dispenser 800j, which operation is described below. The filling equipment 900b may also include a solenoid 821 to push on the connector 820b to release the container 100a, 100b, 100c once the process is complete. The filling equipment 900b may also include a fluid (e.g., fuel) supply line 826, a junction 827 (having a collection reservoir 827a and a hose connection 827b) for collecting rinsing fluid, a drain line 828 for draining rinsing fluid (and optionally directing rinsing fluid to a testing station for analysis), and a fluid return line 831 (e.g., for vapor recovery and/or to introduce a rinsing fluid into the container 100a, 100b, 100c).

The filling equipment 900b may serve as a manual or automated filling line where an operator would swipe an employee ID card (e.g., in the card reader 930b, 990) to activate the filling equipment 900b. The type of process (e.g., inspection, cleaning and/or filling) could be selected (e.g., manually using selectors 920a, 920b, 920c or automatically by the filling equipment 900b).

The operator may then insert a container 100a, 100b, 100c into guide 940b, push down until the container 100a, 100b, 100c clicks into place and is captured by the filling dispenser 800j (e.g., using a feature similar to the push button connector 820a in FIG. 7A). The quantity and type of fluid, as well as other additives and options may be manually selected, predetermined and/or automatically determined, as described above for the filling equipment 900a. The inspecting, cleaning and/or filling operation may then automatically take place and, once complete, the container 100a, 100b, 100c may be automatically released (e.g., the solenoid 821 may push the push button connector 820b to release the container 100a, 100b, 100c). The container 100a, 100b, 100c may then be urged out of the guide 940b a bit (e.g., upward movement Y) (e.g., by a biasing member 730) to indicate to the operator that the process is complete. An indicator (e.g., a light, not shown) may also go on to indicate the progress and/or completion of the process. The filled container 100a, 100b, 100c may be removed by the operator and replaced with another container 100a, 100b, 100c.

Inspection and cleaning of the container 100a, 100b, 100c may be carried out by introducing a small amount of rinsing fluid (e.g., a small amount of a liquid, such as fuel, intended to be filled into the container 100a, 100b, 100c) via the fluid return line 831. The rinsing fluid may be delivered into the container 100a, 100b, 100c via the conduit extension 660 to help ensure that the entire interior of the container 100a, 100b, 100c is rinsed. The rinsing fluid may then be drained into the junction 827 where the rinsing fluid may be collected and drained out via drain line 828 to be tested at a testing station. The testing station may be separate from the filling equipment 900b or may be integrated into the testing equipment 900b. Any number of appropriate tests (e.g., spectral analysis) may be performed manually or automatically on the drained rinsing fluid. The rinsing fluid may then be disposed of, or if found to be acceptably low in contaminates may be reintroduced into the container 100a, 100b, 100c and/or reused.

Although not described in detail with respect to the filling equipment 900a, a similar inspection and cleaning process may be carried out using the filling equipment 900a.

The filling dispenser 800j may operate similarly to the filling dispenser 800i described above for filling the container 100a, 100b, 100c, but in an inverted position.

The filling equipment 900b may perform all of inspecting, cleaning and filling the container 100a, 100b, 100c. Alternatively, one filling equipment 900b may be used for inspection and cleaning while a separate filling equipment 900b may be used for filling.

Filling equipment 900b may be considerably simplified when it comes to filling containers 100a, 100b, 100c making it less complicated and less expensive. Filling equipment 900b may not need the ability to meter known quantities of fluid. It may just dispense liquid until the system senses the container 100a, 100b, 100c is full and automatically terminates the filling process (e.g., via an auto shutoff mechanism such as a Venturi-based shutoff or vapor recovery activated shutoff). This filling equipment 900b could fill any size container to capacity (e.g., 2 to 5 gallon containers 100a, 100b, 100c) without having to change the settings on the system making the process quicker and more versatile.

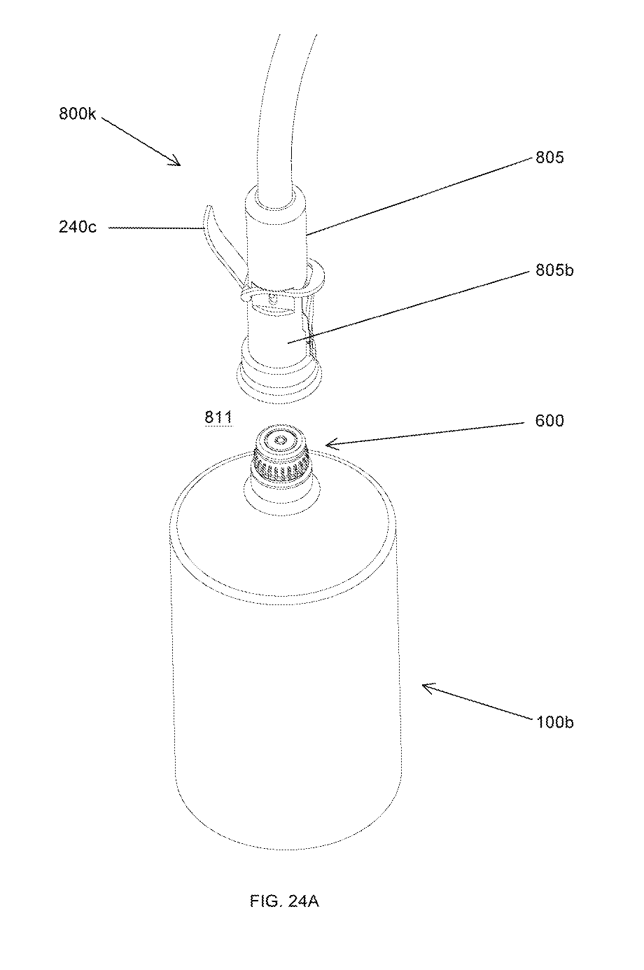

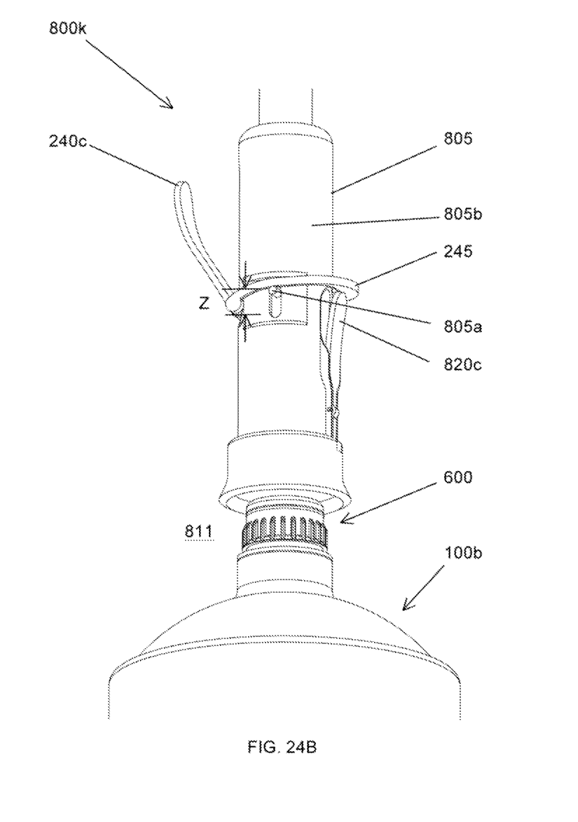

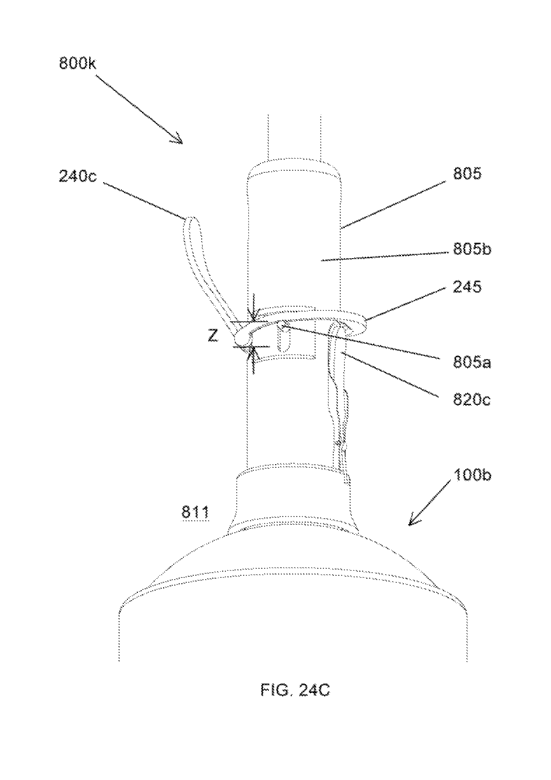

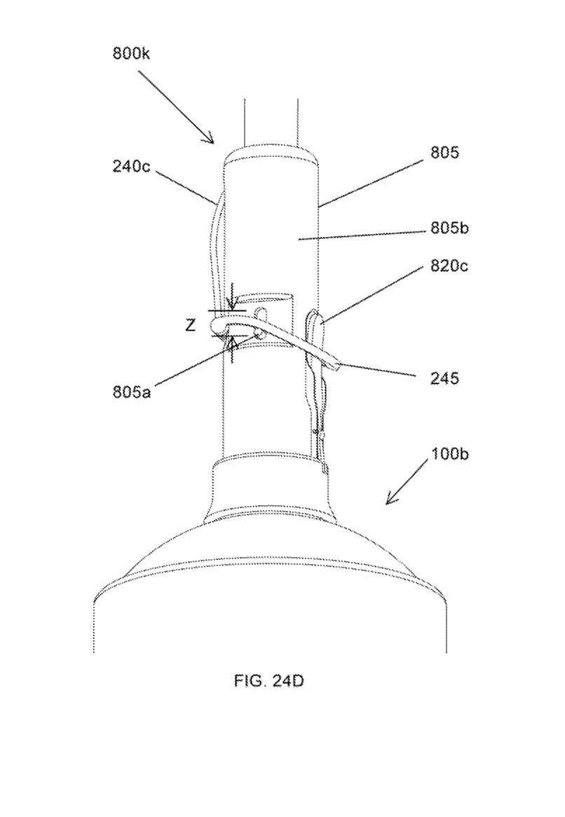

FIGS. 24A-24D show an example handheld filling dispenser 800k, which may be used with the disclosed system 1000 and containers 100a, 100b, 100c, 100d. The handheld filling dispenser 800k may replace one or all conventional fuel nozzles at a gas station or on a gas station pump, to adapt conventional gas pumps to the system 1000 and containers 100a, 100b, 100c, 100d of the present disclosure.

The dispenser 800k may be moved towards the cover 600, 600b, 600c of the container 100a, 100b, 100c, 100d until it engages the cover 600, 600b, 600c. For example, the dispenser 800k may click into place at which point the dispenser 800k may be clipped onto the cover 600, 600b, 600c via a push button connector 820c similar to connector 820a described above. This may help avoid the chance that the dispenser 800k is moved out of position or falls off during delivery of fluid to the container 100a, 100b, 100c, 100d.

The dispenser 800k may include an actuator 240c that may be manually actuated to being the filling process. Actuation of the actuator 240c may move a valve actuator 245 in order to open the valves 625, 640 of the cover 600, 600b, 600c of the container 100a, 100b, 100c, 100d. As a safety feature, a push button connector 820c may interfere with the valve actuator 245 and prevent the actuator 240 from being actuated until the dispenser 800k properly engages the cover 600, 600b, 600c of the container 100a, 100b, 100c, 100d.

Once installed properly on the cover 600, 600b, 600c the push button connector 820c will no longer interfere with the valve actuator 245, thus allowing the actuator 240c to be actuated so that the cover 600, 600b, 600c can be opened. Actuation of the actuator 240c causes telescoping motion Z of telescoping portions 805a, 805b, similar to the dispenser 800b described above, to open the cover 600, 600b, 600c.

The dispenser 800k may be provided at regular gas stations to enable consumers to fill the container 100a, 100b, 100c, 100d, or may be provided only at authorized stations for use by authorized personnel.

The dispenser 800k may be manually operated (e.g., through manual operation of the actuator 240c as described above) or may be automatically operated (e.g., fluid is automatically delivered once the dispenser 800k properly engages the cover 600, 600b, 600c). A pre-selected or automatically determined amount of fluid may be delivered to the container 100a, 100b, 100c, 100d. The dispenser 800k may include an auto-shutoff mechanism to terminate the filling process of the container 100a, 100b, 100c, 100d. The dispenser 800k may automatically disengage from the cover 600, 600b, 600c once fluid delivery is complete.

In some examples, where the fluid is a fuel, the fuel may be designated and/or provided for off-road use, which may allow the fuel to be exempt from requirements and regulations imposed on fuels used in automobiles or other automotives, such as the required inclusion of ethanol or other additives and ingredients, required formulations and/or certain taxes on the sale or cost of fuel. Additionally, fuel designated and/or provided for off-road use may be exempt from prohibition against inclusion of certain other additives (e.g., the fuel may be allowed to have additives and ingredients that are not allowed in fuels intended for use in automobiles or other automotives).

The present disclosure may enable the restriction of sale, distribution and use of fuel for off-road use only. For example, the container 100a, 100b, 100c, 100d may include labeling or indicators indicating that the fuel contained within is designated or recognized for off-road use only. Further, when it comes to filling the container, the container may be compatible and/or accessible only with authorized equipment designated to dispense off-road fuel such as conveying attachments (e.g., filling and dispensing attachments) that are exclusively compatible with the cover 600, 600b, 600c on a container 100a, 100b, 100c, 100d. Additionally, the conveying attachments may be designed to be incompatible and/or inaccessible with motor vehicle fuel tanks. The attachments may be incompatible and/or inaccessible for filling any and all motor vehicles (e.g., automobiles, ATVs, and lawn mowers) or may only be incompatible and/or inaccessible for filling automobile fuel tanks. In this way, the fuel designated for off-road use may be inhibited from being transferred into a motor vehicle fuel tank.

Due to the fact that fuel designated for off-road use may be exempt from certain tax and formulation regulations, it may be necessary to restrict the fuel from being dispensed into automobile fuel tanks. For example, the filling equipment 900a, 900b and filling dispenser 800k of the present disclosure may inhibit the transfer of fuel to automobiles by providing filling equipment 900a, 900b and filling dispenser 800k that are either inaccessible to or incompatible with an automobile fuel tank. In addition, the outlet of the dispenser 800, 800a, 800b, 800c, 800d, 800e, 800f (e.g., spout tip) that is used with the container 100a, 100b, 100c, 100d may be configured to inhibit the transfer of fuel to the motor vehicle fuel tank, for example the outlet may be too large (e.g., at least 1 inch in diameter or larger) to be used with the opening of typical automobile fuel tanks. Additionally, a dispenser 800, 800a, 800b, 800c, 800d, 800e, 800f which may otherwise be useable with a motor vehicle fuel tank may be configured to be a low-flow dispenser so as to inhibit, discourage and prevent the fuel in the container 100a, 100b, 100c, 100d from being easily transferred into an automobile fuel tank. Providing a nozzle at a gas station which is incompatible with and/or inaccessible to an automotive fuel tank may be unconventional and a counter-intuitive way of thinking. The fuel industry was designed around dispensing fuel into automobiles, so to design a nozzle, such as filling dispenser 800k, which is to be installed at a gas station and which excludes the transfer of fuel to automobiles, may be unconventional and counter-intuitive. Additionally, where the filling dispenser (e.g., filling dispenser 800k) is configured to be exclusively compatible with a filling process with containers (e.g., containers 100a, 100b, 100c) that do not currently exist on the market, designing such a filling dispenser may be counter-intuitive.

By helping to ensure that fuel contained within the container 100a, 100b, 100c, 100d cannot be used for automobiles, tax savings may be enjoyed through the implementation of the present disclosure. Such tax savings may be passed onto the end consumer and/or may be used to fund the development, production, deployment or other aspect of the fluid distribution system.

The present disclosure may provide one or more advantages over conventional methods and systems for fuel distribution.

For example, the present disclosure may enable sale of fuel at locations other than gas stations. The present disclosure may allow for bypass of on-road fuel tax when fuel is purchased for off-road use. The price of fuel may be standardized geographically to reduce or eliminate cost comparison by the consumer. The consumer may be billed at the time of purchase, at the time of pre-order, through monthly billing or other suitable means. The consumer may be able to refund fuel (e.g., unopened and full containers of fuel) because construction of the containers may ensure that there is no contamination of the contained fuel.

By enabling purchase of fuel (and other liquids, such as chemicals) at various locations, not limited to gas stations, fuel purchase may be made more convenient. For example, use of automated dispensers may enable 24 hour availability of fuel for purchase. The system may also remove the car-centric nature of conventional fuel distribution, which is typically through gas stations.

The use of the containers may allow fuel distribution to be simpler and cleaner for the consumer. There may be no need to wait for a container to be filled (e.g., pre-filled containers may be readily available). There may be a container exchange program, such that the burden of cleaning and refilling containers may not rest on the consumer.

The system may enable refilling of used containers only by authorized personnel and not by the consumer, which may help to avoid or reduce consumer error. Refilling of containers may also be made safer, better controlled and/or more efficient. The refilling station and/or refilling equipment may be configured to provide pollution control, spill-proofing, vapor recovery and/or emission control. The refilling equipment may be designed to reduce human error that may lead to pollution.

The system may avoid the need for the consumer to store unused containers or keep an inventory of different container sizes. As well, the number of containers on the market may be reduced.

The system may facilitate the use and distribution of specially-designed containers. Because fluid is dispensed in filled containers by the retailer and/or container distributor and/or containers are inspected and verified before being filled, unsuitable containers may be prevented from being used for fluid distribution. The containers may be lightweight containers of a higher durability, longevity, quality and/or safety than conventional containers. Quality control on the containers may reduce risk to the consumer, impact on the environment and/or liability to the container distributor and/or retailer. The containers may be made of materials such as metal as opposed to plastic, since identification may be provided by enclosure. The containers may be made of spun aluminum (e g, including a metal dry-break valve). The containers may be made of thin-walled and light-weight components, and may provide greater durability, safety, longevity and/or pollution prevention. Using a metal material may lead to better fuel preservation since because metal fuel tanks have little or no permeation of fuel.

Where the containers are made of a plastic material, the containers may be provided with more container-specific information (e.g., contents, expiry date and source of contents). The containers may be designed to provide greater pollution control, for example using thicker walled blow molded plastic with permeation barrier additives. The containers may be manufactured using advanced injection molding, with state of the art fuel-grade plastics.

The enclosure may provide better control during the dispensing process, which may help to eliminate or minimize spilling. Valve(s) in the enclosure may prevent or reduce inadvertent release of fuel. Use of the enclosure may avoid contamination of the container and/or cap. A remote trigger on the enclosure may allow for better control of fluid dispensing. The handle(s) may allow for easier manipulation by the consumer. The enclosure may be kept at point of use (e.g., in the consumer's garage) to avoid having to transport the enclosure.

The containers, enclosures and/or dispensing system may be customized (e.g., with customized handles, triggers and other features).

The containers described in the present disclosure may be reusable, portable containers. The containers may be pouring containers for containing and dispensing liquid. The containers may be used for fluid exchange (e.g., vapor recovery during liquid dispensing. As such, the containers may be referred to as reusable dispensing containers, portable reusable pouring containers, reusable fluid exchange containers and reusable liquid dispensing containers.

The fluid described in the present disclosure may be a fuel (e.g., gasoline, diesel or kerosene). The fluid may have a vapor transition temperature in the range of about −35 to 100° C. and a boiling point greater than about 20° C. (e.g., depending on the fuel formulation), which is different from the transition temperatures and boiling point of fuels such as propane, natural gas and acetylene.

The present disclosure may enable a retail model not found in conventional fuel distribution. For example, equipment and servicing may all be provided by container distributor, which may make it easy for an existing retailer to add fuel as another off-the-shelf product. Fuel may be pre-sold for working capital. Discounts may be possible for large purchasers (e.g., car dealers) or partners. Such features may make it easier for a franchisee to enter the fuel distribution market. There may be little or no capital requirement for selling through a retail store. There may be relatively small capital requirements for a kiosk or vending machine. There may be minimal ongoing expense.

In various example embodiments, the present disclosure may provide a fluid transfer device for dispensing fluid from a container said fluid transfer device comprising: a frame/enclosure; and at least a first fluid passage. There may be a second fluid passage. There may be at least one valve and there may be at least a second valve. The first fluid passage may be a fluid dispenser. The second fluid passage may be a fluid recovery conduit of a dispenser. The fluid dispenser may be a spout. In various example embodiments, the present disclosure may provide a portable container assembly comprising the fluid transfer device described above, and a container.

In various example embodiments, the present disclosure may provide a portable container assembly comprising: a container having at least one opening; a frame mountable to the container; an attachment having a body defining a receiving end for receiving fluid from the container and a distal end for dispensing fluid from the attachment; and a first fluid passage defined in the body for permitting fluid flow through the body at least to the distal end; wherein the attachment is mountable to the frame such that the first fluid passage of the attachment is connectible in fluid communication with the at least one opening of the container. The attachment may be mountable in removable and replaceable relation to the frame. The frame may comprise a plurality of modular elements, which may be similar to each other. The attachment may comprise a dispenser. The attachment may be valveless. The attachment may include a second fluid passage defined in the body for permitting fluid flow through the body at least to the receiving end, and the attachment may be mountable to the frame such that the second fluid passage of the attachment is in fluid communication with the at least one opening of the container. There may be a valve mounted on the container, the frame and/or the attachment such that the valve is in operative relation with respect to the first fluid passage when the portable container assembly is assembled. The frame may have an attachment receiving recess and the attachment may have a frame engaging portion that is received and retained in the attachment receiving recess when the portable container assembly is assembled. The attachment may include an annular flange and the frame may include a co-operating annular recess, and the attachment may be mountable to the frame by the annular flange being received and retained in the co-operating annular recess. There may be a quick disconnect connector mounted at the opening of the container. The quick disconnect connector may comprise a dry-break connector.

In various example embodiments, the present disclosure may provide a portable container assembly comprising: a container having at least one opening; a frame mountable to the container; an attachment having a body defining a receiving end for receiving fluid from the container and a distal end for dispensing fluid from the attachment; and a first fluid passage defined in the body for permitting fluid flow through the body at least to the distal end; wherein the attachment is capturable by the frame such that the first fluid passage of the attachment is connectible in fluid communication with the at least one opening of the container. The frame may have an attachment receiving recess and the attachment has a frame engaging portion that is received and retained in the attachment receiving recess, thereby permitting capture of the attachment by the frame, when the portable container assembly is assembled. The attachment may include an annular flange and said frame includes a co-operating annular recess, and wherein the attachment is mountable to the frame, as aforesaid, by the annular flange being received and retained in the co-operating annular recess.

In various example embodiments, the present disclosure may provide a method of storing and using at least one portable container assembly, the method comprising the steps of: storing a plurality of containers together in a storage area, wherein each container has at least one opening; selecting a container from the storage area; mounting a frame onto the container; and mounting an attachment having a first fluid passage to the frame such that the first fluid passage of the attachment is in fluid communication with the at least one opening of the container. The method may also include mounting a valve on at least one of the container, the frame and the attachment such that the valve is in operative relation with respect to the first fluid passage when the portable container assembly is assembled.

In various example embodiments, the present disclosure may provide a method of storing and using at least one portable container assembly, the method comprising the steps of: storing a plurality of containers together in a storage area, wherein each container has at least one opening; selecting a container from the storage area; mounting a frame onto the container; capturing an attachment having a first fluid passage by the frame such that the first fluid passage of the attachment is in fluid communication with the at least one opening of the container. The method may also include mounting a valve on at least one of the container, the frame and the attachment such that the valve is in operative relation with respect to the first fluid passage when the portable container assembly is assembled.

In various example embodiments, the present disclosure may provide a portable container system comprising: a plurality of containers, wherein each container has at least one opening; at least one frame, wherein each frame is mountable to the containers; at least one attachment, wherein each attachment has a body defining a receiving end for receiving fluid from the fluid source and a distal end for dispensing fluid from the attachment; and a first fluid passage defined in each body for permitting fluid flow through the body at least to the distal end; wherein each attachment is mountable to any one of the at least one frame such that the first fluid passage of the attachment is in fluid communication with the at least one opening of a selected container, to thereby form an assembled portable container.

In various example embodiments, the present disclosure may provide a portable container system comprising: a plurality of containers, wherein each container has at least one opening; at least one frame, wherein each frame is mountable to the containers; at least one attachment, wherein each attachment has a body defining a receiving end for receiving fluid from the fluid source and a distal end for dispensing fluid from the attachment; and a first fluid passage defined in each body for permitting fluid flow through the body at least to the distal end; wherein each attachment is capturable by any one of the at least one frame such that the first fluid passage of the attachment is in fluid communication with the at least one opening of a selected container, to thereby form an assembled portable container.

In various example embodiments, the present disclosure may provide a fluid transfer apparatus for dispensing fluid from a container having at least one opening, said fluid transfer apparatus comprising: a frame mountable to the container; an attachment having a body defining a receiving end for receiving fluid from the container and a distal end for dispensing fluid from the attachment; and a first fluid passage defined in the body for permitting fluid flow through the body at least to the distal end; wherein the attachment is mountable to the frame such that the first fluid passage of the attachment is connectible in fluid communication with the at least one opening of the container. There may be a first valve mounted on the frame such that the first valve is in operative relation with respect to the first fluid passage when the portable container assembly is assembled. There may be a second fluid passage defined in the body for permitting fluid flow through the body at least to the receiving end. There may be a second valve mounted on the frame such that the second valve is in operative relation with respect to the second fluid passage when the portable container assembly is assembled.

In various example embodiments, the present disclosure may provide a fluid transfer device for dispensing fluid from a container having at least one opening, the fluid transfer device comprising: a frame; and a first fluid passage portion of the frame having an outlet end and defining a first fluid passage for permitting fluid flow through the first fluid passage portion at least to the outlet; wherein, when the frame is mounted on the container, the first fluid passage is connectible in fluid communication with the at least one opening of the container. There may be a first valve mounted on the frame in operative relation with respect to the first fluid passage. There may be a second fluid passage portion of the frame having an outlet end and defining a second fluid passage for permitting fluid flow through the second fluid passage portion at least to the outlet. There may be a first valve mounted on the frame in operative relation with respect to the first fluid passage. The first fluid passage portion and/or the second fluid passage portion, individually or together, may comprise a fluid dispenser. The fluid dispenser may comprise a spout.

In various example embodiments, the present disclosure may provide a portable container assembly comprising: a container having at least one opening; a frame; and a first fluid passage portion of the frame having an outlet end and defining a first fluid passage for permitting fluid flow through the first fluid passage portion at least to the outlet; wherein, when the frame is mounted on the container, the first fluid passage is connectible in fluid communication with the at least one opening of the container.

The present disclosure may provide a method of filling reusable dispensing containers and bottling liquids (e.g., hazardous liquids) for storage and/or distribution, in a manner which may be more accessible, convenient, safer, environmentally friendly and/or ergonomic. The present disclosure may enable a standardized, modular, more consistent, versatile, repeatable and/or potentially regulate-able process for filling containers and for dispensing liquids from containers. The present disclosure may additionally enable tracking and recycling of container contents.

The embodiments of the present disclosure described above are intended to be examples only. Alterations, modifications and variations to the disclosure may be made without departing from the intended scope of the present disclosure. In particular, selected features from one or more of the above-described embodiments may be combined to create alternative embodiments not explicitly described. All values and sub-ranges within disclosed ranges are also disclosed. The subject matter described herein intends to cover and embrace all suitable changes in technology. All references mentioned are hereby incorporated by reference in their entirety.

1.-40. (canceled)

41. An assembly for dispensing a fluid, the assembly comprising:
a fluid container comprising:
at least one opening; and,
where in the at least one opening is closed by an openable cover; and
an enclosure attachable to the container, the enclosure comprising:
a body for at least partially enclosing at least a portion of the container; and
a dispenser on the body, the dispenser being configured to cooperate with the cover of the container to open the cover and permit fluid to be dispensed from the container.

42. The assembly of claim 41, wherein opening of the cover to dispense fluid is enabled only by cooperation with the dispenser.

43. The assembly of claim 41, wherein the cover comprises at least one valve for permitting or inhibiting delivery of fluid from the container, and the dispenser is configured to cooperate with the cover to open the at least one valve, to permit fluid to be dispensed.

44. The assembly of claim 43, wherein the cover comprises a first half of a dry-break connection.

45. The assembly of claim 41, wherein the container comprises a first set of at least two fluid conduits and the enclosure comprises a second set of at least two fluid conduits, and wherein, when the enclosure is attached to the container, the first and the second sets of fluid conduits align with each other to enable vapor recovery when fluid is dispensed from the container.

46. A fluid flow control mechanism for controlling the flow of fluid through an opening, the fluid flow control mechanism comprising:
at least a first valve comprising a closed configuration for inhibiting the flow of fluid through the opening and an open configuration for permitting the flow of fluid through the opening, the first valve being biased to the closed configuration; and
a locking mechanism with an engaged configuration wherein the valve is disabled from being moved to the open configuration and a disengaged configuration wherein the valve is enabled to be moved to the open configuration;
wherein the locking mechanism is biased to the engaged configuration.

47. The fluid flow control mechanism of claim 46, wherein the locking mechanism is enabled to move to the disengaged configuration only by a fluid conveying attachment configured to cooperate with the fluid flow control mechanism.

48. The fluid flow control mechanism of claim 47, wherein cooperation of the fluid conveying attachment with the fluid flow control mechanism enables movement of the valve to the open configuration.

49. The fluid flow control mechanism of claim 46, wherein the opening is defined in a fluid container.

50. The fluid flow control mechanism of claim 46, wherein further comprising a second valve comprising a closed configuration for inhibiting the flow of fluid through the opening and an open configuration for permitting the flow of fluid through the opening, the second valve being biased to the closed configuration.

51. The fluid flow control mechanism of claim 50, wherein the second valve is moved to the open configuration only upon movement of the first valve towards the open configuration.

52. The fluid flow control mechanism of claim 50, wherein the first valve controls flow of liquid and the second valve controls flow of vapor.

53. The fluid flow control mechanism of claim 46, wherein the locking mechanism is manually moveable to the disengaged configuration.

54. The fluid flow control mechanism of claim 46, wherein further comprising a container with at least one opening defined in a body of the container wherein the fluid flow control mechanism controls the flow of fluid there through.

55. The fluid flow control mechanism of claim 54, wherein the container has a capacity in the range of 1 to 5 gallons.

56. A fluid conveying attachment connectible to a container having an opening closed by an openable seal, the conveying attachment enabling communication of fluid through the opening, the conveying attachment comprising
a connection end connectible to the container and a conveying end;
a liquid conduit providing fluid communication between the connection end and the conveying end;
a vapor conduit providing fluid communication between the connection end and the conveying end;
at least one seal engaging member for opening the seal, the seal engaging member being provided by at least one of the liquid conduit and the vapor conduit, the seal engaging member being movable between a disengaged configuration wherein the seal is not opened and an engaged configuration wherein the seal is opened;
wherein when the conveying attachment is connected to the container and the seal engaging member is in the disengaged configuration, the seal remains closed such that communication of fluid through the opening is inhibited; and
wherein when the conveying attachment is connected to the container and the seal engaging member is in the engaged configuration, the seal is opened such that communication of fluid through the opening is enabled.

57. The fluid conveying attachment of claim 56, wherein when the fluid conveying attachment is connected to the container and the seal is opened, a closed system is created between the fluid conveying attachment and the interior of the container.

58. The fluid conveying attachment of claim 56, further comprising an unlocking mechanism configured to disable a locking mechanism of the container, wherein the locking mechanism, when locked, inhibits the seal on the container from being opened, the unlocking mechanism engaging the locking mechanism when the conveying attachment is connected to the container.

59. The fluid conveying attachment of claim 58, wherein when the unlocking mechanism engages the locking mechanism, the locking mechanism is unlocked.

60. The fluid conveying attachment of claim 56, wherein the fluid conveying attachment is configured to deliver fluid to the container.
